(19) United States
(12) Patent Application Publication
(10) Pub. No.: US 2006/0065992 A1
(43) Pub. Date: Mar. 30, 2006

(54) Mono and multi-layer articles and compression methods of making the same

(76) Inventors: Gerald A. Hutchinson, Coto De Caza, CA (US); Robert A. Lee, Bowdon Cheshire (GB); Said K. Farha, Pleasantville, NY (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/108,342

(22) Filed: Apr. 18, 2005

Related U.S. Application Data
(60) Provisional application No. 60/563,021, filed on Apr. 16, 2004.
(60) Provisional application No. 60/575,231, filed on May 28, 2004.
(60) Provisional application No. 60/586,399, filed on Jul. 7, 2004.
(60) Provisional application No. 60/620,160, filed on Oct. 18, 2004.
(60) Provisional application No. 60/621,511, filed on Oct. 22, 2004.
(60) Provisional application No. 60/643,008, filed on Jan. 11, 2005.

(51) Int. Cl. B29C 44/12; B29C 43/02; B29C 43/18

(52) U.S. Cl. 264/45.1; 264/320; 264/323; 264/328.1; 264/321; 264/45.4; 264/255; 425/129.1

(57) ABSTRACT

In preferred embodiments methods and apparatuses can produce articles that have formable material. The articles may be mono and multilayer. The articles can be formed by various methods.

### RELATED APPLICATIONS

This application claims the priority benefit under 35 U.S.C. § 119(e) of the provisional applications 60/563,021, filed Apr. 16, 2004, 60/575,231, filed May 28, 2004, 60/586,399, filed Jul. 7, 2004, 60/620,160, filed Oct. 18, 2004, 60/621,511, filed Oct. 22, 2004, and 60/643,008, filed Jan. 11, 2005, which are hereby incorporated by reference in their entireties.

### BACKGROUND OF THE INVENTIONS

1. Field of the Inventions

This invention relates to articles having formable material, more specifically for mono and multi-layer articles having formable materials and methods of making such articles.

2. Description of the Related Art

Articles have been commonly used for holding beverages and foodstuffs. The use of articles, such as plastic containers, as a replacement for entirely glass or metal containers in the packaging of beverages has become increasingly popular. The advantages of plastic packaging include lighter weight, decreased breakage as compared to glass, and potentially lower costs. The most common plastic used in making beverage containers today is polyethylene terephthalate (“PET”). Virgin PET has been approved by the FDA for use in contact with foodstuffs. Containers made of PET are generally transparent, thin-walled, lightweight, and have the ability to maintain their shape by withstanding the force exerted on the walls of the container by pressurized contents, such as carbonated beverages. PET resins are also fairly inexpensive and easy to process.

Most PET bottles are made by a process that includes the blow-molding of plastic preforms, which have been made by processes including injection molding or * extrusion process. The PET bottle may not provide a suitable thermal barrier for limiting thermal communication through the walls of the PET bottles. It may be desirable to reduce the heat transfer between the liquid within the bottle and the environment surrounding the bottle to maintain the temperature of the liquid within the bottles. Similarly, most inexpensive containers for holding foodstuffs do not provide an effective thermal barrier to reduce heat transfer through the container. It may be desirable to reduce the heat transfer through containers or packaging.

Additionally, articles in the form of conduits, food packaging, and the like may have unsuitable structural, barrier, or other characteristics. Many times fluids, foods, or beverages, such as carbonated soda, are stored in a container that may undesirably affect its contents. Unfortunately, when the food contacts the surface of some materials of the known articles, the taste of the food may be adversely altered. It may be desirable to maintain the taste of the foodstuffs in contact with the article.

### SUMMARY OF THE INVENTIONS

In a preferred embodiment, there is provided a method for forming at least a portion of a preform. The method comprises producing lamellar material. The lamellar material is deposited in a mold cavity section. A core is moved relative to the mold cavity section to compress the lamellar material between a core and the mold cavity section. The core and the mold cavity section have an open and a closed position. The core and mold cavity section cooperate to define a cavity in the shape of at least a portion of a preform when in the closed position.

In some embodiments, a compression molding system for producing multilayer preforms comprises a mandrel that is movable between an open position and a closed position. The compression molding system comprises a mold cavity configured to receive the mandrel. The mold cavity and mandrel cooperate to define a cavity in a shape of a preform. A material source is configured to drop lamellar material suitable for molding to the cavity when the mandrel is in the open position.

In some embodiments, a method of forming at least a portion of a preform comprises producing foam material. The foam material is deposited in a mold cavity section. The foam material is expanded in the mold cavity section. The core and the mold cavity section have an open and closed position. The core and mold cavity section cooperate to define a cavity in the shape of at least a portion of a preform when in the closed position. The core is moved into the mold cavity section and compresses the foam material therebetween to form at least a portion of a preform.

In some embodiments, a method of forming a preform comprises providing a first core and a first mold cavity section that cooperate to define a first cavity in the shape of at least a portion of a preform when in a closed position. A first melt is produced and deposited in a first mold cavity section. The first core is moved relative to the first mold cavity section to compress the first melt to form at least a portion of a preform. The first core is moved out of the first mold cavity section. A second melt is produced. The second melt is compressed between the at least a portion of the preform and one of a second core and a second mold cavity section.

In some embodiments, a system for molding multilayer articles comprises a plurality of cores, a plurality of cavity sections, and a source of lamellar material. The source of lamellar material comprises an output positioned to deliver lamellar to at least one of the cavity sections. The cores are movable between an open position and a closed position. The cores are positioned within corresponding cavity sections when the cores are in a closed position after the lamellar material is positioned in the corresponding cavity sections.

In some embodiments, a system for molding a preform or container comprises a mold having a cavity shaped to form at least a portion of a preform or container. A source of moldable material is in communication with the cavity. The source comprises a die at one end and a plunger at the other end. A housing of the source contains an extruder screw that is interposed between the die and the plunger. The extruder screw is axially and rotationally movable within the housing.

In a preferred embodiment, there is provided a method for forming a preform. At least a portion of the preform comprises expandable material that can expand to form a thermal barrier. The preform is heated to a temperature suitable for blow molding and at least a portion of the expandable material expands. The preform is blow molded into a container. In one arrangement, the preform is a monolayer preform. In another arrangement, the preform is a multi-layer preform.

In another embodiment, there is provided a process for making a foam coated polymer article comprising the acts of providing a foam coated polymer preform and blow molding the preform to a desired container shape. In one arrangement, the process comprises preheating the foam coated polymer preform before blow molding, causing the foam coating, which comprises microspheres, to initiate expansion of the microspheres. The microspheres can expand before blow molding, during blow molding, and/or after blow molding.

In one embodiment, a foam coated polymer article comprises at least one layer of foam surrounding at least a portion of another layer substantially comprising polyester. The foam comprises a polymer carrier material and a foaming agent.

In another embodiment, there is provided a process for making an article comprising foam. The foam can have a first component and a second component. The first component can expand when thermally activated. Optionally, the first component comprises microspheres that are generally in a first state of expansion. In one arrangement, the second component is a carrier material mixed with the first component. When the mixture is heated, the mixture is expanded to form a generally closed cell foam.

In one embodiment, the mixture is formed into a preform having microspheres that are expanded from the first state of expansion to a second state of expansion. The preform is molded into a container having the microspheres which are expanded from the second state of expansion to a third state of expansion. In one arrangement, a substantial portion of the microspheres are generally unexpanded in the first position. Optionally, a substantial portion of the microspheres are generally partially expanded in the second position. Optionally, a substantial portion of the microspheres are generally expanded in the third position.

In one embodiment, a method of producing a bottle comprises providing a preform comprising an inner layer of low temperature processing material (e.g., PET, recycled PET) and an outer layer comprising a high temperature material (e.g., PP). The outer layer of the preform can be at a temperature not typically suitable for processing the inner layer. The preform is blow molded into a bottle after heating the preform. In one arrangement, the outer layer comprises foam material. In one arrangement, the outer layer contains mostly or entirely PP. A substantial portion of the inner layer can be at a lower temperature than a substantial portion of the outer layer. Thus, layers comprising materials with different properties can be processed together.

In one embodiment, the expandable material comprises a carrier material and a foaming agent. The carrier material is preferably a material that can be mixed with the microspheres to form an expandable material. The carrier material can be a thermoplastic or polymeric material, including, but not limited to, ethylene acrylic acid (“EAA”), ethylene vinyl acetate (“EVA”), linear low density polyethylene (“LLDPE”), polyethylene terephtalate glycol (PETG), poly(hydroxyamino ethers) (“PHAE”), polyethylene terephtalate (“PET”), polyethylene (“PE”), polypropylene (“PP”), polystyrene (“PS”), cellulose material, pulp, mixtures thereof, and the like. In one embodiment, the foaming agent comprises microspheres that expand when heated and cooperate with the carrier material to produce foam. In one arrangement, the foaming agent comprises EXPANCEL® micropheres.

In preferred embodiments, the expandable material has insulating properties to inhibit heat transfer through the walls of the container comprising the expandable material. The expandable material can therefore be used to maintain the temperature of food, fluids, or the like. In one embodiment, when liquid is in the container, the expandable material of the container reduces heat transfer between liquid within the container and the environment surrounding the container. In one arrangement, the container can hold a chilled liquid and the expandable material of the container is a thermal barrier that inhibits heat transfer from the environment to the chilled fluid. Alternatively, a heated liquid can be within the container and the expandable material of the container is a thermal barrier that reduces heat transfer from the liquid to the environment surrounding the container. Thus, the expandable material inhibits heat transfer out of the container to reduce cooling of the heated fluid. Although use in connection with food and beverages is one preferred use, these containers may also be used with non-food items.

In one embodiment, the foam material is extruded to produce sheets that are formed into containers for holding food, trays, bottles, and the like. The sheets can be formed by a compression molding process. Optionally, the sheets are formed into clamshells that are adapted to hold food. The foam sheets can be pre-cut and configured to form a container for holding foodstuff. The sheets may be formed into a container by one or more processes, e.g., a thermomolding process.

In another embodiment, an article is provided comprising foam material that forms a coating on a paper or wood pulp based material or container. In one arrangement, the foam material is mixed with pulp. Optionally, the foam material and pulp can be mixed to form a generally homogeneous mixture which can be formed into a desired shape. The mixture may be heated before, during, and/or after the mixture is shaped to cause expansion of at least a portion of the foam material component of the mixture.

In another embodiment, a preform comprises at least a first layer comprising material suitable for contacting foodstuff and a second layer comprising polypropylene. Optionally, the first layer comprises PET and the second layer comprises foam material having polypropylene and microspheres. Optionally, the first layer comprises PET and the second layer contains mostly or entirely polypropylene. Optionally, the first layer comprises phenoxy type thermoplastic and the second layer contains another material, such as polypropylene. The preform may be formed into a container by one or more processes, e.g., a blow molding process.

In one embodiment, a method of producing a bottle comprises providing a preform comprising an inner layer of PET (e.g., virgin PET, recycled PET) and an outer layer comprising PP. The outer surface of the preform is heated to a temperature not typically suitable for processing PET. The outer layer of PP can be at a higher temperature than the inner layer comprising PET. The preform is blow molded into a bottle after heating the preform. In one arrangement, the outer layer comprises foam material. In one arrangement, the outer layer contains mostly or entirely PP.

In another embodiment, a preform comprises an inner layer that has a flange that defines at least a portion of an opening of the preform. An outer layer surrounds the inner layer and defines a substantial portion of a neck finish of a preform and forms an outer surface of a body portion of the preform.

In another embodiment, there is a tube comprising a first layer and a second layer. In one embodiment, the first layer comprises PET and the second layer comprises PP and a foaming agent. Optionally, the first layer comprises substantially PET and the second layer comprises foam material having PP. In another arrangement, the tube is formed by a co-extrusion process. Optionally, the tube can be blow molded into a container. Optionally, the tube can be used as a fluid line to deliver ingestible liquids.

In another embodiment, a preform comprises an inner layer and an outer layer. The outer layer surrounds the inner layer and defines a substantial portion of a neck finish of a preform. The outer layer also forms an outer surface of a body portion of the preform.

In some embodiments, a preform comprises a neck portion and a body portion. The body portion has a wall portion and an end cap and comprises a first layer and a second layer, the first layer comprising an expandable material. In some arrangements, the expandable material is adapted to expand by heat treatment.

In some embodiments, a preform comprises a threaded neck portion and a body portion. The body portion includes a wall portion and an end cap. The body portion comprises expandable material forming less than about 40% by weight of the preform. In some embodiments, the expandable material comprises less than 20% by weight of the preform. The expandable material can optionally comprise microspheres and a carrier material selected from the group consisting of polypropylene, PET, and combinations thereof.

In some embodiments, a method of producing a preform comprises forming a first layer of the preform. A second layer of the preform is formed and comprises a controllable, expandable material. In some arrangements, the first layer is formed by injecting a first material comprising polyester through a gate into a space defined by a cavity mold half and a core mold half to form a polyester article. The polyester article comprises an inner surface and an outer surface. The second layer is formed by injecting expandable material into a second space defined by the outer surface of the polyester article and a second cavity mold half to form the second layer of the preform.

In some embodiments, a method of producing a bottle comprises providing a preform having a neck portion and a body portion. The preform is heated so that a portion of the preform at least partially expands to form foam. The preform is blow molded into a bottle comprising foam material.

In some embodiments, an article comprises a neck portion having threads and a body portion. The body portion comprises a first layer and a second layer. The first layer has an upper end that terminates below the threads of the neck portion and comprises foam material. The second layer is positioned interior to the first layer. In some embodiments, the article is a preform, bottle, container, or the like. The second layer can optionally comprise a material suitable for contacting foodstuffs. For example, the second layer can comprise a material including at least one material selected from a group consisting of polyester, polypropylene, phenoxy-type thermoplastic, and combinations thereof.

In some embodiments, a bottle comprises a neck portion and a body portion. The body portion comprises an inner layer comprising polyester and an outer layer comprising foam material. The foam material comprises polypropylene. The inner layer and the outer layer define at least a portion of a wall of the body portion.

In preferred embodiments laminates, preforms, containers, and articles comprising PETG and polypropylene, and methods of making the same, are disclosed. In one embodiment polypropylene may be grafted or modified with maleic anhydride, glycidyl methacrylate, acryl methacrylate and/or similar compounds to improve adhesion. In another embodiment polypropylene further comprises “nanoparticles” or “nanoparticular material.” In another embodiment polypropylene comprises nanoparticles and is grafted or modified with maleic anhydride, glycidyl methacrylate, acryl methacrylate and/or similar compounds.

Preferred articles, preforms, containers, and articles can be made using various techniques. For example, laminates, preforms, containers, and articles can be formed through injection molding, overmolding, blow molding, injection blow molding, extrusion, co-extrusion, and injection stretch blow molding, and other methods disclosed herein and/or known to those of skill in the art.

In some embodiments, a system for molding multilayer articles a first molding system comprising a plurality of first cores, a plurality of first cavity sections, and a first source of first material. The first source of material comprises a first output positioned to deliver the first material to at least one of the first cavity sections. The first cores are movable between an open position and a closed position. The first cores are positioned within corresponding first cavity sections when the first cores are in a closed position after the first material is positioned in the corresponding first cavity sections. A second molding system comprises a plurality of second cores, a plurality of second cavity sections, and a second source of second material. The second source comprises a second output positioned to deliver the second material to at least one of the second cavity sections. The second cores are movable between an open position and a closed position. The second cores are positioned within corresponding second cavity sections. A transport system is configured to transport preforms from the first molding system to the second transport system.

In some non-limiting exemplary embodiments, the articles may material comprise one or more layers or portions having one or more of the following advantageous characteristics: an insulating layer, a gas barrier layer, UV protection layers, protective layer (e.g., a vitamin protective layer, scuff resistance layer, etc.), a foodstuff contacting layer, a non-flavor scalping layer, non-color scalping layer a high strength layer, a compliant layer, a tie layer, a gas scavenging layer (e.g., oxygen, carbon dioxide, etc), a layer or portion suitable for hot fill applications, a layer having a melt strength suitable for extrusion, strength, recyclable (post consumer and/or post-industrial), clarity, etc. In one embodiment, the monolayer or multi-layer material comprises one or more of the following materials: PET (including recycled and/or virgin PET), PETG, foam, polypropylene, phenoxy type thermoplastics, polyolefins, phenoxy-polyolefin thermoplastic blends, and/or combinations thereof.

### BRIEF DESCRIPTION OF THE DRAWINGS

FIG. 1 is a preform used as a starting material for forming containers.

FIG. 2 is a cross-section of the preform of FIG. 1.

FIG. 3 is a cross-section of a blow-molding apparatus of a type that may be used to make a preferred container.

FIG. 4 is a side view of a container formed from a preform.

FIG. 5 is a cross-section of a multilayer preform.

FIG. 6 is a cross-section of a multilayer container formed from the multilayer preform of FIG. 5.

FIG. 7 is an enlarged view of the container of FIG. 6 taken along 7.

FIG. 8 is a cross-section of a multilayer preform.

FIG. 8A is an enlarged view of the preform of FIG. 8 taken along 8A.

FIG. 9 is a cross-section of a multilayer preform having a multilayer neck portion.

FIG. 10 is a cross-section of a multilayer preform in accordance with another embodiment.

FIG. 11 is a cross-section of a multi-layer preform having an inner layer defining an interior of the preform.

FIG. 12 is a cross-section of a multi-layer preform having an inner layer and an outer layer that define a neck portion.

FIG. 12A is a cross-section of a multi-layer preform having an inner layer and an outer layer that define a neck portion.

FIG. 12B is a cross-section of a multi-layer preform having an inner layer and an outer layer that define a neck portion.

FIG. 13 is a cross-section of a multi-layer preform having an inner layer with a flange.

FIGS. 13A and 13B are enlarged cross-sections of portions of multi-layer preforms in accordance with some embodiments.

FIG. 14 is a cross-section of a multi-layer preform having an outer layer with a coupling structure.

FIG. 14A is a cross-section of a container made from the preform of FIG. 14, a closure is attached to the container.

FIG. 14B is an enlarged view of a portion of the container and closure of FIG. 14A taken along 14B.

FIG. 14C is an enlarged view of a portion of the container and closure in accordance with another embodiment.

FIG. 15A is a cross-section of a portion of a preform having a neck portion without threads.

FIG. 15B is a cross-section of the preform of FIG. 15A.

FIG. 15C is a cross-section of a portion a multi-piece preform.

FIG. 16 is a cross-section of a preform in accordance with another embodiment.

FIG. 17 is a cross-section of a preform in accordance with another embodiment.

FIG. 18 is a perspective view of a closure suitable for closing a container.

FIG. 19 is a cross-section of a multilayer closure having an inner layer.

FIG. 20 is a cross-section of a multilayer closure having an inner layer extending along the sides of the closure.

FIGS. 21A-21E are cross-sections of multilayer closures.

FIGS. 22A-22B are cross-sections of sheets.

FIG. 23 is a perspective view of one preferred embodiment of a profile.

FIG. 24 is a side view of one preferred embodiment of packaging including a container having a label and a closure.

FIG. 25 is side view of a container and a closure in accordance with another embodiment.

FIG. 26A is perspective view of a container.

FIG. 26B is a perspective view of a tray.

FIG. 27 is a schematic view of an embodiment of a lamellar meltstream generation system.

FIG. 27A is a cross-section of lamellar material made from the lamellar meltstream generation system of FIG. 27.

FIG. 28 is a top plan view of a compression molding system for producing preforms.

FIG. 28A is a top plan view of a compression molding system for producing multilayer articles.

FIG. 29 is a cross-sectional view of the compression molding system taken along lines 29-29 of FIG. 28.

FIG. 30 is a cross-section of a cavity section of FIG. 29 containing a plug of lamellar material. An output of a material source is positioned above a mold cavity of the cavity section.

FIG. 31 is a cross-sectional view of a core section and cavity section in an open position.

FIG. 32 is a cross-sectional view of the core section and cavity section of FIG. 31 in a closed position.

FIG. 32A is a cross-sectional view the core section and cavity section of FIG. 31 in a closed position. Moldable material is disposed within a cavity defined by the core section and cavity section.

FIG. 33 is a cross-sectional view of a core section and a cavity section in a partially open position in accordance with another embodiment.

FIG. 34 is a cross-sectional view of a core section and a cavity section in a closed position in accordance with another embodiment.

FIG. 35 is a top plan view of a compression molding system for producing preforms in accordance with another embodiment.

FIG. 36 is a cross-sectional view of a core section and a cavity section of the system of FIG. 35 in a closed position. The core section and the cavity section define a cavity for forming an outer layer of a preform.

FIG. 37 is a cross-sectional view of another core section and the cavity section of the system of FIG. 35 in a closed position. The core section and the cavity section define a cavity for forming an inner layer of a preform.

FIG. 38 is a cross-sectional view of a compression molding system configured to make a closure.

FIG. 39 is a sectional view of another cavity section and the core section of FIG. 38. The core section and the cavity section define a cavity for forming an outer layer of a closure.

FIG. 40 illustrates a molding system configured to produce preforms.

FIG. 41 is a cross sectional view of the molding system of FIG. 40 taken along the lines 41-41.

FIG. 42 illustrates a molding system configured to produce preforms in accordance with another embodiment.

FIG. 43 illustrates a molding system configured to produce preforms in accordance with another embodiment.

FIG. 44 illustrates a molding system configured to produce preforms in accordance with another embodiment.

FIG. 45 is a cross sectional view of a core section and cavity section in a partially open position. Moldable material is positioned within the cavity section.

FIG. 46 is a cross sectional view of the core section and the cavity section of FIG. 45 in a closed position. Moldable material partially fills a space define by the core section and cavity section.

FIG. 47 is a cross sectional view of the core section and the cavity section of FIG. 46, wherein moldable material completely fills the space.

### DETAILED DESCRIPTION OF THE PREFERRED EMBODIMENTS

All patents and publications mentioned herein are hereby incorporated by reference in their entireties. Except as further described herein, certain embodiments, features, systems, devices, materials, methods and techniques described herein may, in some embodiments, be similar to any one or more of the embodiments, features, systems, devices, materials, methods and techniques described in U.S. Pat. Nos. 6,109,006; 6,808,820; 6,528,546; 6,312,641; 6,391,408; 6,352,426; 6,676,883; U.S. patent application Ser. No. 09/745,013 (Publication No. 2002-0100566); Ser. No. 10/168,496 (Publication No. 2003-0220036); Ser. No. 09/844,820 (2003-0031814); Ser. No. 10/090,471 (Publication No. 2003-0012904); Ser. No. 10/614731 (Publication No. 2004-0071885), provisional application 60/563,021, filed Apr. 16, 2004, provisional application 60/575,231, filed May 28, 2004, provisional application 60/586,399, filed Jul. 7, 2004, and provisional application 60/620,160, filed Oct. 18, 2004, 60/621,511, filed Oct. 22, 2004, and 60/643,008, filed Jan. 11, 2005, U.S. patent application Attorney Docket No. APTPEP1.091A entitled MONO AND MULTI-LAYER ARTICLES AND INJECTION MOLDING METHODS OF MAKING THE SAME, filed on the same day as the present application, Patent Application Attorney Docket No. APTPEP1.089A entitled MONO AND MULTI-LAYER ARTICLES AND EXTRUSION METHODS OF MAKING THE SAME, filed on the same day as the present application, which are hereby incorporated by reference in their entireties. In addition, the embodiments, features, systems, devices, materials, methods and techniques described herein may, in certain embodiments, be applied to or used in connection with any one or more of the embodiments, features, systems, devices, materials, methods and techniques disclosed in the above-mentioned patents and applications.

A. Articles

In preferred embodiments articles may comprise one or more formable materials. Articles described herein may be mono-layer or multi-layer (i.e., two or more layers). In some embodiments, the articles can be packaging, such as drinkware (including preforms, containers, bottles, closures, etc.), boxes, cartons, and the like.

The multi-layer articles may comprise an inner layer (e.g., the layer that is in contact with the contents of the container) of a material approved by a regulatory agency (e.g., the U.S. Food and Drug Association) or material having regulatory approval to be in contact with food (including beverages), drugs, cosmetics, etc. In other embodiments, an inner layer comprises material(s) that are not approved by a regulatory scheme to be in contact with food. A second layer may comprise a second material, which can be similar to or different than the material forming the inner layer. The articles can have as many layers as desired. It is contemplated that the articles may comprise one or more materials that form various portions that are not “layers.”

1. Detailed Description of Drawings

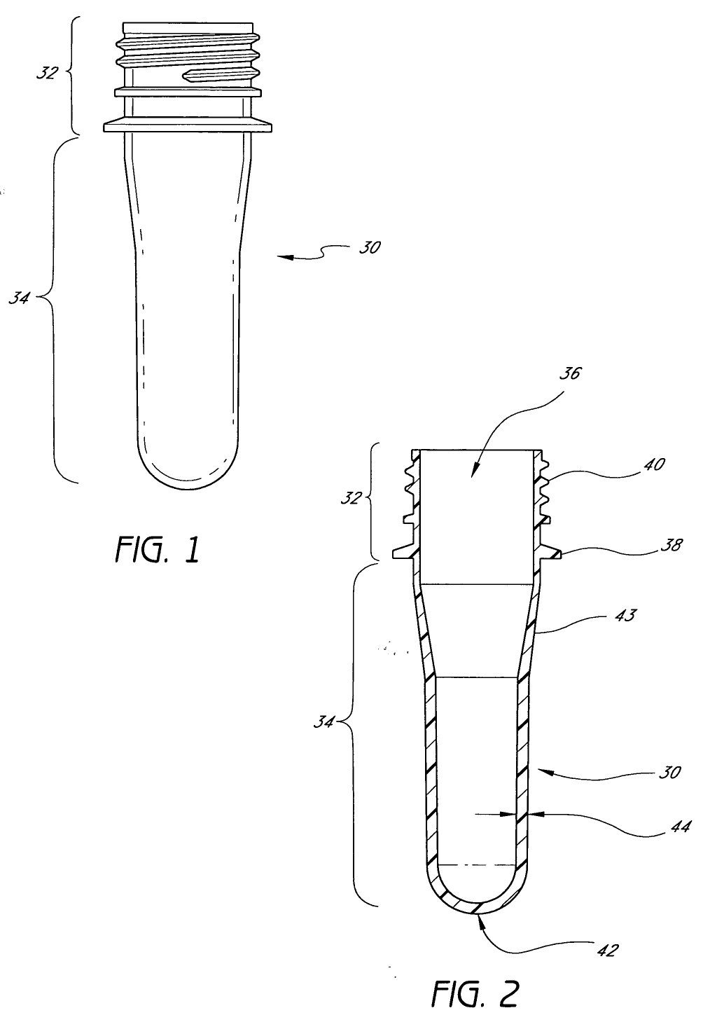

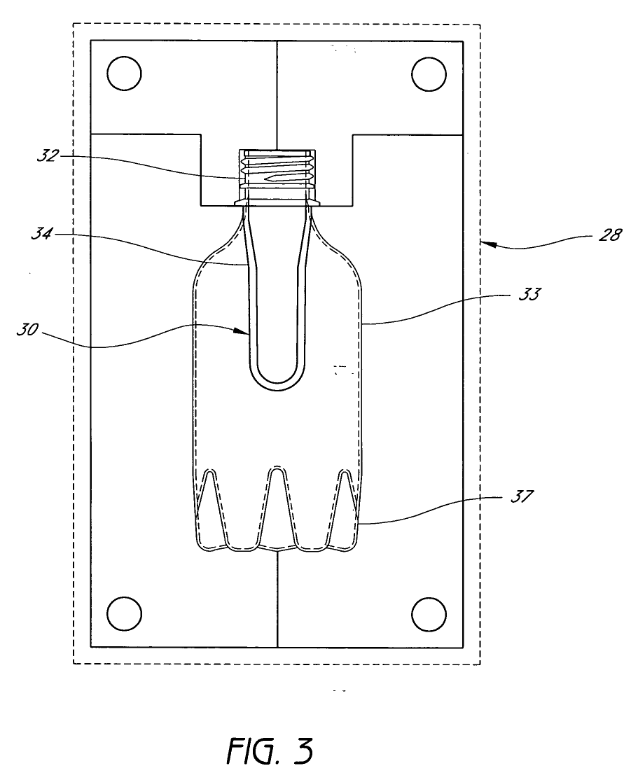

With reference to FIGS. 1 and 2, a preferred monolayer preform 30 is illustrated. Generally, the preform 30 has a neck portion 32 and a body portion 34. The illustrated preform 30 can have a single layer formed of a material that can be blow-molded. The preform 30 is preferably blow molded into a container for holding liquids, such as non-carbonated liquids such as fruit juice, water, and the like. Optionally, the preform 30 can be formed into a container to hold other liquids, such as carbonated liquids. The illustrated preform 30 can be suitable for forming a 16 oz. beverage bottle that is especially well suited for holding carbonated beverage. As used herein, the term “bottle” is a broad term and is used in accordance with its ordinary meaning and may include, without limitation a container (typically of glass and/or plastic having a comparatively narrow neck or mouth), a bottle-shaped container for storing fluid (preferably a liquid), etc. The bottle may or may not have a handle.

The illustrated preform 30 has a neck portion 32 which begins at an opening 36 (FIG. 2) to the interior of the preform 30 and extends to and includes the support ring 38. As used herein, the term “neck portion” is a broad term and is used in accordance with its ordinary meaning and may include, without limitation a portion of a preform attached to a body portion. The neck portion may include a neck finish. The neck finish together with the neck cylinder may form what is referred to herein as the “neck portion.” The neck portion 32 in the illustrated embodiment is further characterized by the presence of the threads 40, which provide a way to fasten a cap or closure member to the bottle produced from the preform 30. Alternatively, the neck portion 32 may not be configured to engage a closure or may have means other than threads to engage a closure. The body portion 34 is an elongated and generally cylindrically shaped structure extending down from the neck portion 32 and culminating in an end cap 42. The illustrated end cap 42 is rounded; however, the end cap can have other suitable shapes. The preform thickness 44 will depend upon the overall length of the preform 30 and the desired wall thickness and overall size of the resulting container.

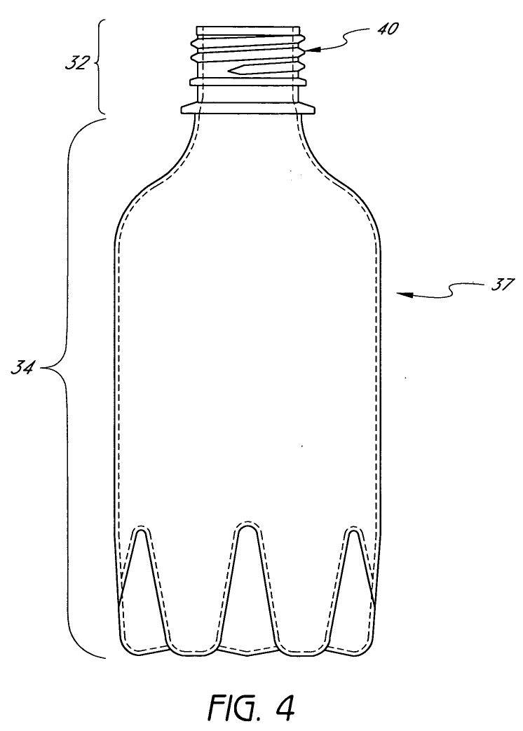

Referring to FIG. 3, in this blow molding process the preform 30 is placed in a mold having a cavity corresponding to the desired container shape. The preform 30 is then heated and expanded by forcing air or other suitable fluid into the interior of the preform to stretch the preform so that it fills the cavity, thus creating a container 37 (FIG. 4). This blow-molding process is described in detail below. A stretched rod or similar means may also be used to aid in the blow molding process, as is known in the art.

In some embodiments, a blow molding machine can receive warm articles (e.g., profiles such as sleeves, preforms, etc.) to aid in the blow molding process, as is known in the art. The mold 28 can receive warm preforms from an injection molding machine, such as the injection molding machines described herein. The preforms manufactured by the injection molding machine can be quickly transported to the mold 28 via a delivery system. The inherent heat of the preforms may provide one or more of the following: reduced blow molding time, reduced energy required to heat preforms to a temperature suitable for blow molding, and/or the like.

Optionally, one or more delivery systems can be employed to transport preforms to and/or bottles away from a mold. For example, a delivery system may comprise a shuttle system (e.g., a linear or rotary shuttle system) for transporting preforms to and/or away from the mold 28. The shuttle system can batch feed preforms to or remove blow molded bottles from the mold 28. Alternatively, the delivery system can comprise a reciprocating and/or wheel delivery system. In some embodiments, a wheel delivery system is used to rapidly deliver preforms to or remove bottles from the mold 28. Advantageously, wheel delivery systems can continuously transport articles to and from the mold 28 thereby increasing output.

It is contemplated that a delivery system can be used in combination with molding machine suitable for blow molding preforms, extrusion blow molding, extruding profiles and the like. Additionally, a delivery system may comprise a plurality of systems, such a wheel delivery system and a shuttle system that cooperate to transport articles.

Referring to FIG. 4, there is disclosed an embodiment of a container 37 that can be formed from the preform 30. The container 37 has a neck portion 32 and a body portion 34 corresponding to the neck and body portions of the preform 30. As described above with respect to preforms, the neck portion 32 can be adapted to engage with closures. The illustrated neck portion 32 is characterized by the presence of the threads 40 which provide a way to fasten a cap onto the container. Optionally, the wall of the container 37 may inhibit, preferably substantially prevent, migration of gas (e.g. CO₂) through the wall of the container 37. In some embodiments, the container 37 comprises substantially closed cell foam that may inhibit the migration of fluid through the foam.

The blow molding operation normally is restricted to the body portion 34 of the preform with the neck portion 32 including any threads, pilfer ring, and/or support ring retaining the original configuration as in the preform. However, any portion(s) of the preform 30 can be stretch blow-molded. The container 37 can also be formed by other processes, such as through an extrusion process or combinations of process (e.g., injection over an extruded portion). For example, the container 37 can be formed through an extrusion blow molding process. Thus, the containers described herein may be formed from preforms, extruded profiles, etc.

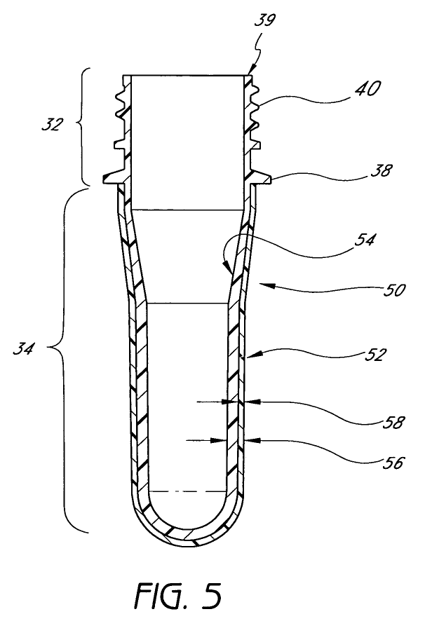

Referring to FIG. 5, a cross-section of one type of multilayer preform 50 having features in accordance with a preferred embodiment is disclosed. The preform 50 preferably comprises an uncoated (monolayer) preform 39 coated with an outer layer 52. Preferably, the uncoated preform 39 comprises a polymer material, such as polypropylene, polyester, and/or other thermoplastic materials, preferably suitable for contacting food. In one embodiment, for example, the uncoated preform 39 comprises substantially polypropylene. In another embodiment, the uncoated preform 39 comprises substantially polyester, such as PET.

The multilayer preform 50 has a neck portion 32 and a body portion 34 similar to the preform 30 of FIGS. 1 and 2. In the illustrated embodiment, the outer layer 52 is disposed about at least a portion of the body portion 34. In one embodiment, the outer layer 52 is disposed about a substantial portion, preferably the entire portion, of the surface of the body portion 34 of the inner layer (illustrated as the preform 39 of FIG. 1), terminating at the bottom of the support ring 38. The outer layer 52 in the illustrated embodiment does not extend to the neck portion 32, nor is it present on the interior surface of the inner layer 39 which is preferably made of a material suitable for contact with the contents of the resulting container. The outer layer 52 may comprise either a single material or several layers (e.g., microlayers) of one or more materials. Further, the outer layer 52 can be generally homogenous, generally heterogeneous, or somewhere inbetween. Although not illustrated, the outer layer 52 can form other portions of the preform 50. For example, the outer layer 52 can form at least a portion of the inner surface of the preform 50 (such as when the outer layer is injected over a tube or profile that is open on both ends), or a portion of the neck portion 32. The outer layer 52 may or may not be suitable for contacting foodstuffs.

The overall thickness 56 of the preform is equal to the thickness of the initial uncoated preform 39 (i.e., the inner layer 54) plus the thickness 58 of the outer layer 52, and is dependent upon the overall size and desired coating thickness of the resulting container. However, the preform 50 may have any thickness depending on the desired thermal, optical, barrier, and/or structural properties of the container formed from the preform 50. If a tie layer is included, the overall thickness will include any thickness of the tie layer. The preforms and containers can have layers which have a wide variety of relative thicknesses. In view of the present disclosure, the thicknesses of a given layer and of the overall preform or container, whether at a given point or over the entire container, can be chosen to fit a manufacturing process or a particular end use for the container. In the illustrated embodiment, the outer layer 52 has a generally uniform thickness. However, the outer layer 52 and/or inner layer 54 need not to be uniform and they may have, for example, a thickness that varies along the longitudinal axis of the preform 50.

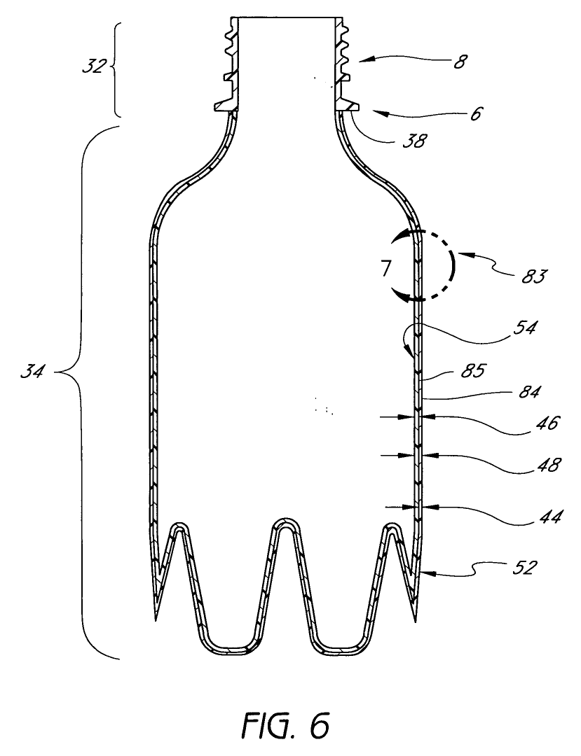

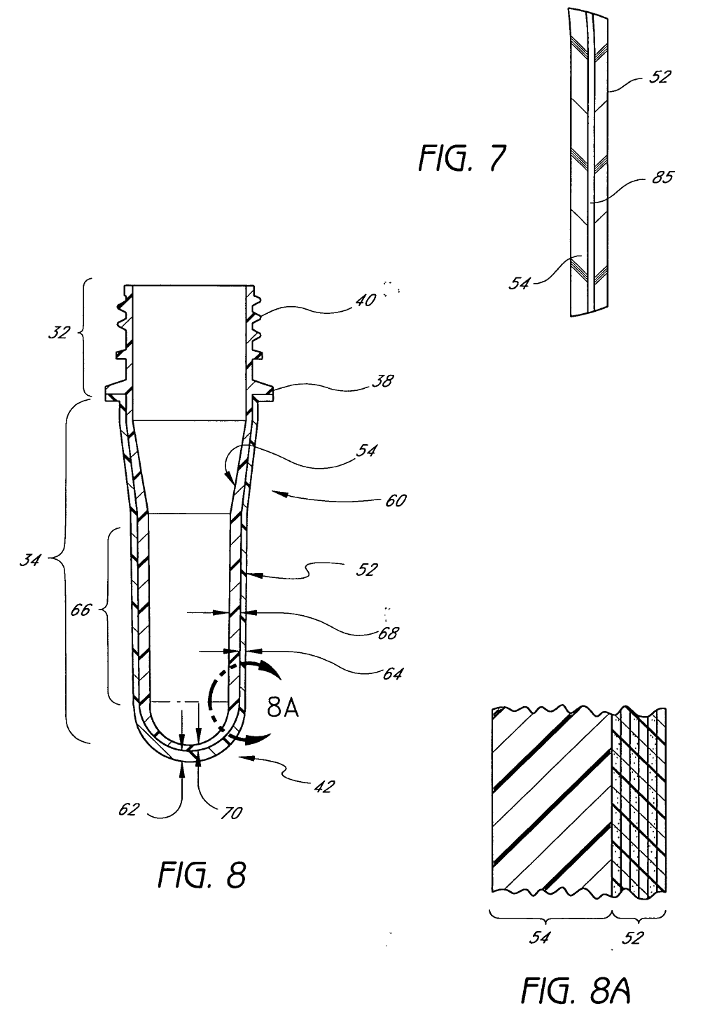

The multilayer preforms can be used to produce the containers. For example, the preform 50 can be used to form a container 180 (FIG. 6). In one embodiment, the outer layer 52 cooperates with the inner layer 54 so as to provide a layer or space 85 therebetween, as shown in FIGS. 6 and 7. The layer 85 can permit the passage of air between the layers 52, 54 and can advantageously further insulate the container 83. The passages can be formed between the layer 52 which loosely surrounds the inner layer 54. Alternatively, the outer layer 52 can be sized and configured to snuggly hold the inner layer 54 and so that inner surface of the layer 52 contacts the outer surface of the layer 54. In some embodiments, the layer 85 can be a foam layer that is similar, or dissimilar, to one or more of the layers 52, 54. In yet another embodiment, the layer 85 can be a layer that couples the layer 52 to the inner layer 54. For example, the layer 85 can be crafting or a tie layer that inhibits, preferably that substantially prevents, relative movement between the layers 52, 54. For example, the layer 85 can be an adhesive layer that limits relative movement between the layers 52, 54. It is contemplated that some or none of the layers of the embodiments disclosed herein can be coupled together with a tie layer or the like.

In one embodiment, at least one of the layers 52, 54 can be treated to promote or reduce adhesion between the layers 52, 54. For example, the outer surface of the inner layer 54 can be chemically treated so that the outer layer 52 adheres to the inner layer 54. For example, a tie material can be applied to react and chemically treat one or more of the layers 52, 54. However, it is contemplated that any of the layer(s) can be modified to achieve the desired interaction between the layers of the preform. Optionally, the layers 52, 54 can be directly adhered together.

In some embodiments, a container comprises foam material that preferably has insulating properties to inhibit thermal transfer through the walls of the container. When liquid is in the container, such as container 83 of FIG. 6, for example, the foam material forming a wall 84 of the container 83 can reduce heat transfer between the liquid contents and the environment surrounding the container 83. For example, the container 83 can hold chilled contents, such as a carbonated beverage, and the foam insulates the container 83 to inhibit temperature changes of the chilled fluid. Thus, the contents can remain chilled for a desired duration of time despite an exterior ambient temperature that is greater than the temperature of the liquid. Alternatively, a heated material, such as a hot beverage, can be within the container 83 and the wall 84 can insulate the container 83 to inhibit heat transfer from the liquid to the environment surrounding the container 83. Further, the foam material of the container 83 can result in a surface temperature of the container 83 that is within a desired temperature range so that a person can comfortably grip the container 83 holding a heated or chilled liquid. The thickness of the foam layer and the size and configuration of the foam portion of the container can be varied in order to obtain the desired thermal properties of the container.

Referring to FIG. 8, a preferred embodiment of a multilayer preform 60 is shown in cross-section. One difference between the coated preform 60 and the preform 50 in FIG. 5 is the relative thickness of the two layers in the area of the end cap. In the preform 50, the outer layer 52 is generally thinner than the thickness of the initial preform throughout the entire body portion of the preform. In the preform 60, however, the outer layer 52 is thicker at 62 near the end cap 42 than it is at 64 in the wall portion 66, and conversely, the thickness of the inner layer 54 is greater at 68 in the wall portion 66 than it is at 70, in the region of the end cap 42. This preform design is especially useful when an outer coating is applied to the initial preform in an overmolding process to make a multilayer preform, as described below, where it presents certain advantages including that relating to reducing molding cycle time. Either layer may be homogeneous or may be comprised of a plurality of microlayers. In other embodiments of the preform 60 which are not illustrate, the outer layer 52 is thinner at 62 near the end cap 42 than it is at 64 in the wall portion 66, and conversely, the thickness of the inner layer 54 is less at 68 in the wall portion 66 than it is at 70, in the region of the end cap 42. At least one of the layers 52, 54 can optionally compromise a barrier material.

FIG. 8A is an enlargement of a wall section of the preform showing the makeup of the layers in a LIM-over-inject embodiment. The layer 54 is the inner layer of the preform and layer 52 is the outer layer of the preform. The outer layer 52 comprises a plurality of microlayers (i.e., lamellar material) of material as will be made when a LIM system is used. Of course, not all preforms of FIG. 8 will be of this type.

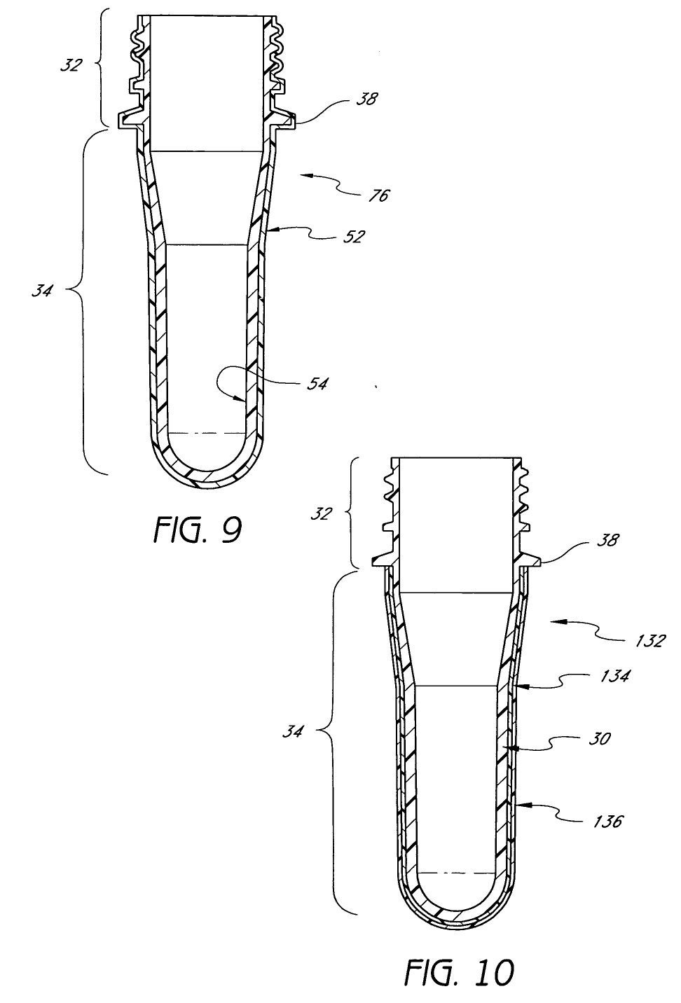

Referring to FIG. 9, another embodiment of a multilayer preform is shown in cross-section. The primary difference between the coated preform 76 and the preforms 50 and 60 in FIGS. 5 and 8, respectively, is that the outer layer 52 is disposed on the neck portion 32 as well as the body portion 34.

The preforms and containers can have layers which have a wide variety of relative thicknesses. In view of the present disclosure, the thickness of a given layer and of the overall preform or container, whether at a given point or over the entire container, can be chosen to fit a coating process or a particular end use for the container. Furthermore, as discussed above in regard to the layer(s) in FIG. 8, the layers in the preform and container embodiments disclosed herein may comprise a single material, more than one materials, or several materials.

The apparatuses and methods disclosed herein can be also used to create preforms with three or more layers. In FIG. 10, there is shown a three-layer embodiment of a preform 132. The preform shown therein has two coating layers, a middle layer 134 and an outer layer 136. The relative thickness of the layers shown in FIG. 10 may be varied to suit a particular combination of materials or to allow for the making of different sized bottles. As will be understood by one skilled in the art, a procedure analogous to that disclosed herein would be followed, except that the initial preform would be one which had already been coated, as by one of the methods for making coated preforms described herein, including overmolding.

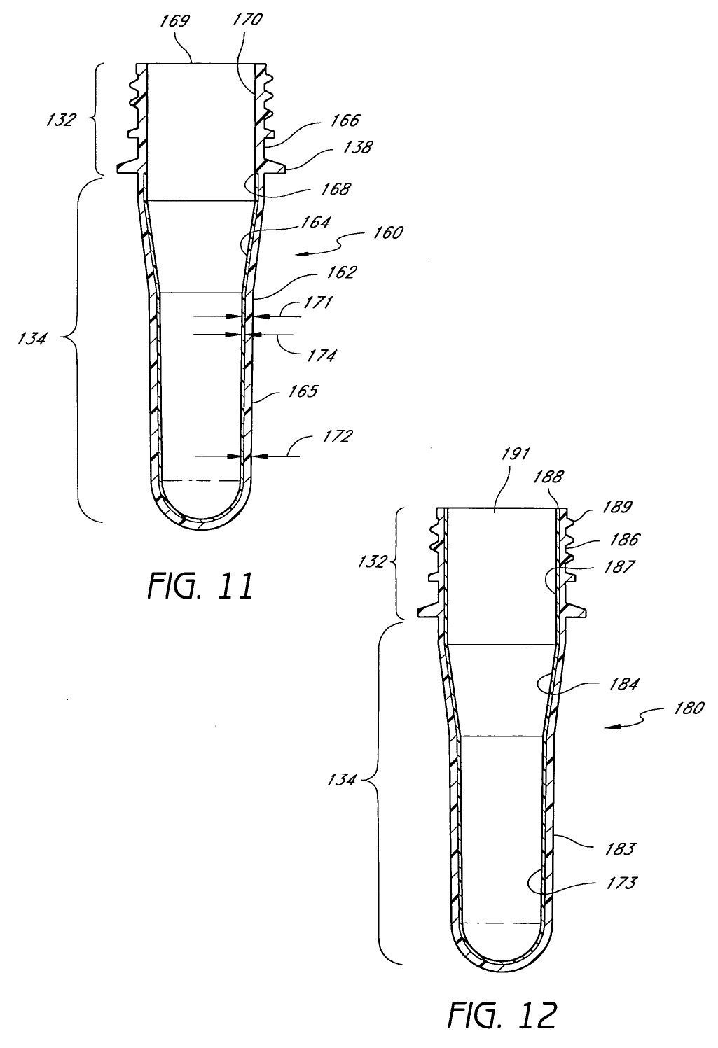

FIG. 11 illustrates a cross-section of one type of multi-layer preform 160 having features in accordance with a preferred embodiment. The preform 160 preferably comprises an outer layer 162 and an inner layer 164.

The multi-layer preform 160 has a neck portion 132 and a body portion 134 similar to the preforms described above. Preferably, the outer layer 162 forms the outer surface 165 of the body portion 134 and the outer surface 166 of the neck portion 132. The outer surface 166 can be configured to engage a closure. The outer layer 162 is disposed about a substantial portion, preferably the entire portion, of the inner layer 164.

The illustrated outer layer 162 extends from the upper end 168 of the inner layer 164 to an opening 169 of the preform 160. The inner layer 164 in the illustrated embodiment does not extend along the neck portion 132. Thus, the outer layer 162 can form substantially the entire neck portion 132, as shown in FIG. 11. In other embodiments, the upper end 168 of the inner layer 164 can be disposed at some point along the neck portion 132. Thus, the inner layer 164 and outer layer 162 may both define the neck portion. In one non-limiting embodiment, the outer layer 162 comprises at least about 70% of neck portion (or neck finish) of the neck portion 132 by weight. In another non-limiting embodiment, the outer layer 62 comprises at least about 50% of the neck portion 132 by weight. In yet another non-limiting embodiment, the outer layer 162 comprises more than about 30% of the neck portion 132 by weight.

The overall thickness 171 of the preform 160 is equal to the thickness 172 of the outer layer 162 plus the thickness 174 of the inner layer 164, and is dependent upon the overall size of the resulting container. In one embodiment, the thickness 172 of the outer layer 162 is substantially greater than the thickness 174 of the inner layer 164. The outer layer 162 and inner layer 164, as illustrated, have generally uniform thicknesses. However, the outer layer 162 and inner layer 164 may not have uniform thicknesses. For example, one or both of the layers 162, 164 may have a thickness that varies along the length of the preform 160.

The outer layer 162 comprises a first material and the inner layer 164 preferably comprises another material. For example, the outer layer 162 can comprise foam material and the inner layer 164 can comprise an unfoamed polymer material, such as PET (e.g., virgin or post-consumer/recycled PET), phenoxy, etc. Preferably, a substantial portion of the outer layer 162 comprises a first material and a substantial portion of the inner layer 164 comprises a second material. The first and the second materials can be different or similar to each other.

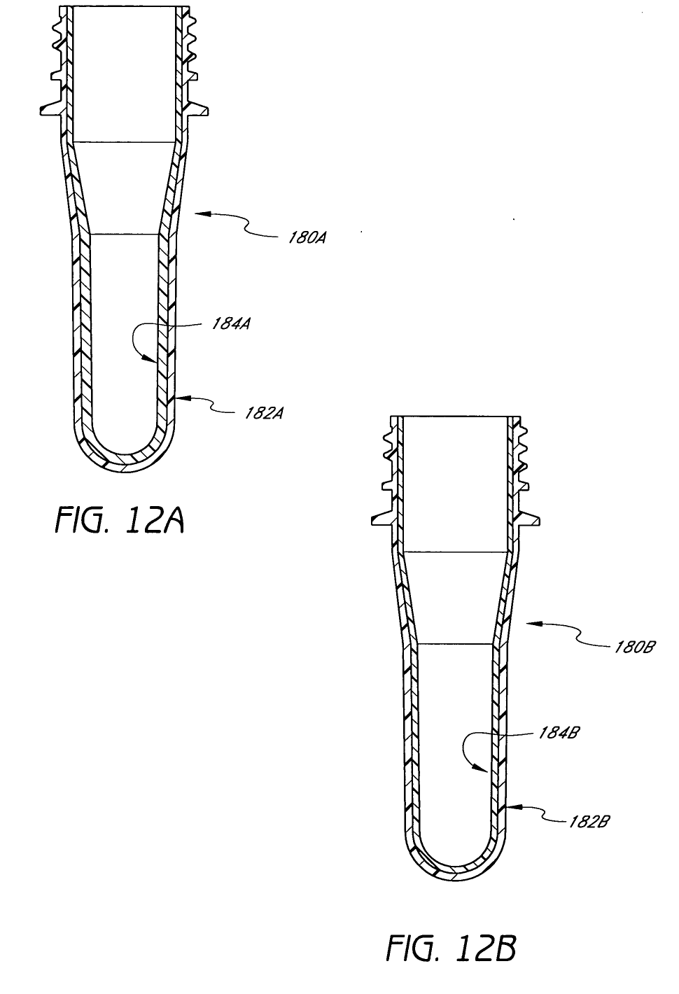

FIG. 12 is a cross-section view of a multi-layer preform 180. The preform 180 is generally similar to the preform 160, and thus, many aspects of preform 180 will not be described in detail. The preform 180 comprises an inner layer 184 and an outer layer 183. The inner layer 184 defines a substantial portion of the interior surface 173 of the preform 180. The inner layer 184 has an end 188 that is proximate to an opening 191 of the preform 180. In the illustrated embodiment, the outer layer 183 defines an outer surface 186 of the neck portion 132, and the inner layer 184 defines the inner surface 187 of the neck portion 132. Of course, the outer layer 183 can be configured to engage a closure. In the illustrated embodiment, the outer surface 86 defines threads 189 adapted to receive a threaded cap (e.g., a screw cap).

Although not illustrated, preforms 160 and 180 can include more than two layers. For example, the outer layer 162 of the preform 160 can comprise a plurality of layers comprising one or more of the following: lamellar material, foam material, PP, PET, and/or the like. Similarly, the inner layer 164 can comprise a plurality of layers. One of ordinary skill in the art can determine the dimensions and number of layers that form the preform described herein. The layers 183, 184 can be made of similar or different materials as the layers 162, 164 described above.

Optionally, a layer can be coated over at least a portion of the preform to prevent abrasion or wearing, especially if at least a portion of the preform is made of foam material. For example, a coating layer can surround the threads of a neck portion made of foam and can comprise PET, PP, combinations thereof, or other thermoplastic materials.

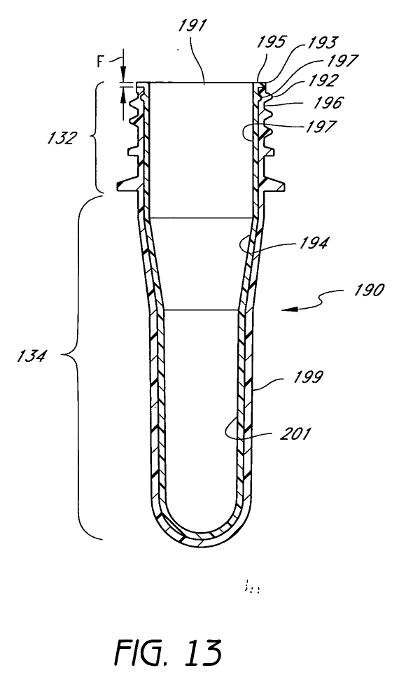

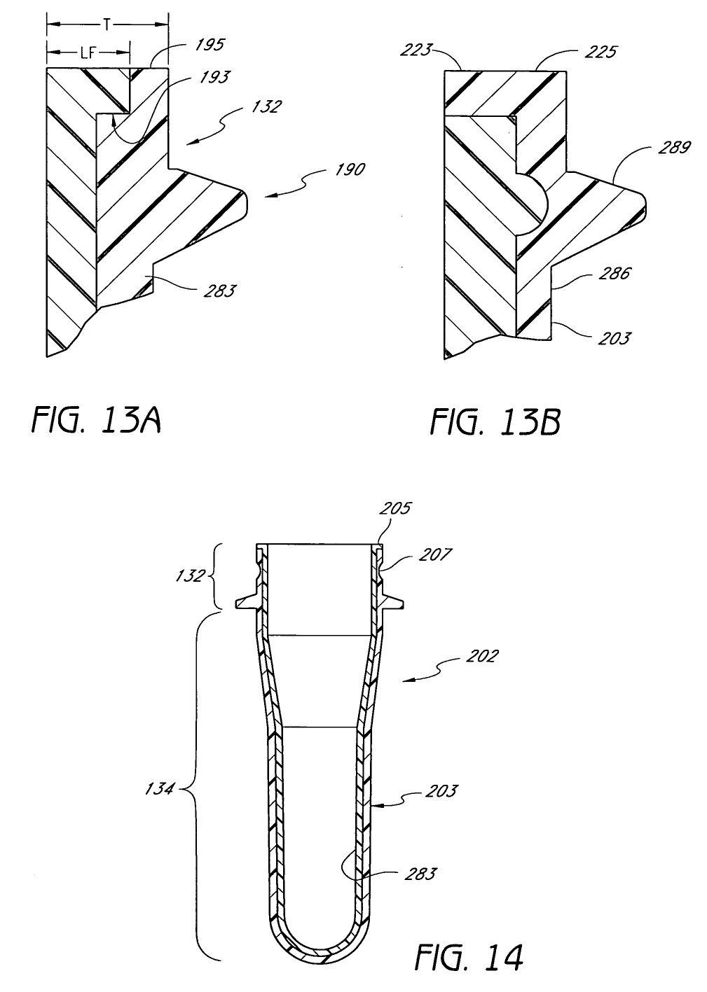

FIG. 13 is a cross-sectional view of a preform 190. The preform 190 is similar to the preform 180 illustrated in FIG. 12, except as further detailed below.

The preform 190 comprises an inner layer 194 that extends downwardly from the opening 191 and defines the interior of the preform. The inner layer 194 comprises a flange 193. As used herein, the term “flange” is a broad term and is used in accordance with its ordinary meaning and may include, without limitation, one or more of the following: a lip, an elongated portion, rim, projection edge, a protrusion, and combinations thereof. The flange can function as a locking structure. Additionally, the preform may optionally include a plurality of flanges.

The flange 193 defines a portion of an inner surface 201 and at least a portion of an upper surface 195 of the preform. The flange 193 can have a constant or varying thickness F depending on the desired properties of the neck portion 132. In some embodiments, including the illustrated embodiment, the flange 193 is positioned above structure(s) (e.g., threads 192) for receiving a closure. In some embodiments, the flange 193 defines a portion of one or more threads, protrusions, recesses, and/or other structures for engaging a closure.

With continued reference to FIG. 13, the flange 193 extends about at least a portion of the periphery of the opening 191 and defines a layer of material. The flange 193 preferably extends about the entire periphery of the opening 191. Thus, the flange 193 can be a generally annular flange. When a closure is attached to the neck portion 132 of a container made from the preform 190, the upper surface 195 of the flange 193 can form a seal with the closure to inhibit or prevent foodstuffs from escaping from the container. The flange 193 can inhibit or prevent separation between the inner layer 194 and the outer layer 199.

One or more locking structures 197 of FIG. 13 can inhibit relative movement between the inner layer 194 and an outer layer 199. As used herein, the term “locking structure” is a broad term and is used in accordance with its ordinary meaning and may include, without limitation, one or more of the following: protrusions, surface treatments (e.g., roughened surface), prongs, protuberances, barbs, flanges, recesses, projections, textured pattern, or the like, preferably for inhibiting or reducing movement between the layers 194 and 199. The locking structure 197 can be formed by the inner layer 194 and/or the outer layer 199. In the illustrated embodiment, the locking structure 197 is a protrusion extending from and about the outer surface of the inner layer 194. In some embodiments, the locking structure 197 is an annular protrusion extending circumferentially about the outer surface of the inner layer 194. The locking structure 197 can be continuous or discontinuous structure. The inner layer 194 can have one or more locking structures, such as a textured pattern (e.g., a series of grooves, protuberances, and the like).

Additionally, the locking structure 197 can be configured to provide positive or negative draft. For example, the inner layer 194 can comprise a somewhat flexible material (e.g., PET) and a locking structure 197 that can provide positive draft during mold removal. In some embodiments, the outer layer 199 comprises a somewhat rigid material (e.g., olefins) that can provide positive or negative draft during mold removal.

The outer layer 199 is configured to receive the locking structure 197. The locking structure 197 effectively locks the outer layer 199 to the inner layer 194. Although not illustrated, a plurality of locking structures 197 can be defined by the layers 194, 199 and may be disposed within the neck portion 132 and/or the body portion 134 of preform 190. In some embodiments, a tie layer can be used to couple the inner layer 194 to the outer layer 199. In one embodiment, the inner layer 194 and the outer layer 199 are formed of materials that bond or adhere to each other directly. In other embodiments, the inner layer 194 is tied to the outer layer 199, so that the layers 194 and 199 can be easily separated during, e.g., a recycling process. However, an article comprising a tie layer can be recycled in some embodiments.

The upper end of the outer layer 199 is spaced from the upper surface 195 of the preform. A skilled artisan can select the thicknesses of the layers 194, 199 to achieve the desired structural properties, thermal properties, durability, and/or other properties of the preform.

FIGS. 13A and 13B illustrate modified embodiments of a portion of the preform 190 of FIG. 13. The preform 190 of FIG. 13A has a flange 193 that extends along a portion of the upper surface 195 of the preform. In some non-limiting embodiments, the length LF of the flange 193 is less than about 95% of the wall thickness T of the neck portion 132. In one non-limiting embodiment, the length LF of the flange 193 is about 50% to 90% of the wall thickness T of the neck portion. In certain non-limiting embodiments, the length LF of the flange 193 is about 60%, 70%, 75%, or 80%, or ranges encompassing such percentages of the wall thickness T of the neck portion. In another non-limiting embodiment, the length LF of the flange 193 is about 40% to 60% of the wall thickness T of the neck portion. In yet another embodiment, the length LF of the flange 193 is less than about 40% of the wall thickness T of the neck portion.

FIG. 13B illustrates a portion of a preform having an outer layer 203 that defines a flange 223. The flange 223 extends inwardly and defines an upper surface 225. The flange 223 can define the interior surface of the preform, or be spaced therefrom. The flange 223 can have a length similar to or different than the length of the flange 193. The neck portion 132 has threads for receiving a closure. However, the neck portion can have other structures (e.g., recesses, ridges, grooves, etc.) for engaging a closure. The preforms described above can be modified by adding one or more layers to achieve desired properties. For example, a barrier layer can be formed on the body portions of the preforms.

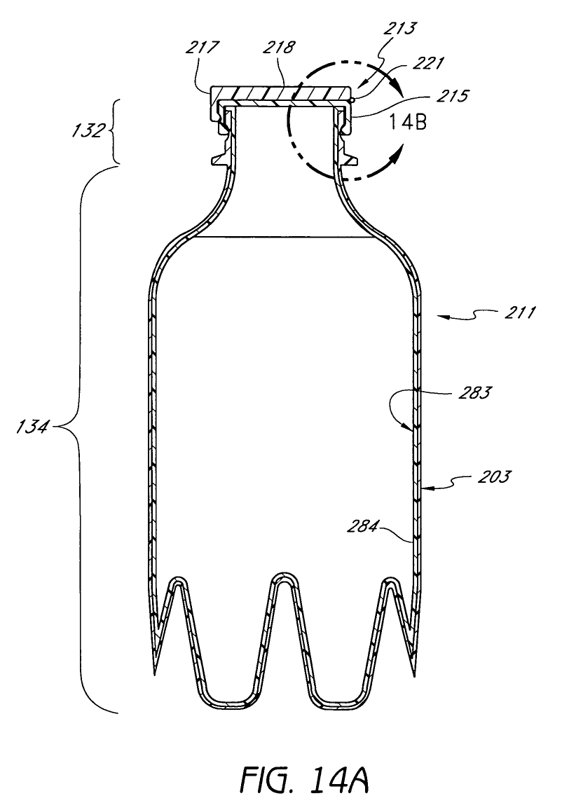

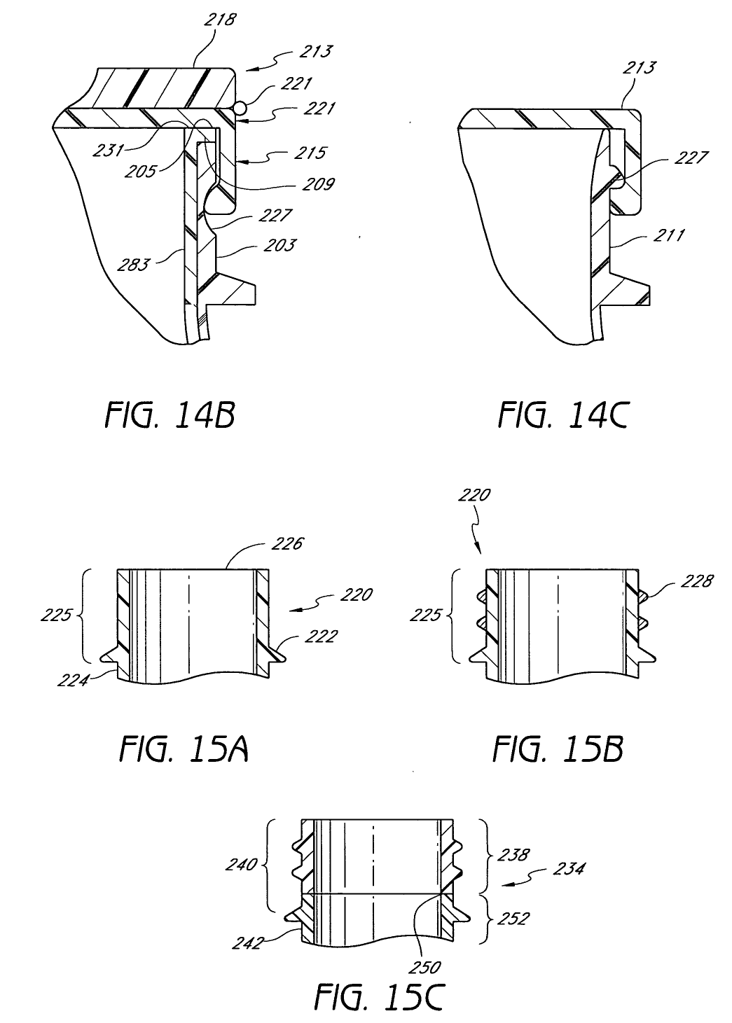

FIG. 14 illustrates a modified embodiment of a preform 202. The preform 202 has a neck portion 132 that defines a coupling structure 207 configured to receive a closure. As used herein, the term “coupling structure” is a broad term and is used in accordance with its ordinary meaning and may include, without limitation a feature, such as a positive (e.g., a projection, protuberance, and the like) or negative feature (e.g., an indentation, recess, and the like). A coupling structure may be configured to engage a closure to hold the closure in a desired position.

The illustrated coupling structure 207 is in the form of a recess adapted to receive a portion of a closure device. The coupling structure 207 can extend about one or more portions of the preform 202. In other embodiments, the coupling structure 207 extends about the entire periphery or circumference of the preform 202. The coupling structure 207 can have a curved (e.g., semi-circular), v-shaped, u-shaped, or any other suitable cross-sectional profile. Although not illustrated, the structure 207 can be a protrusion, such as an annular protrusion, defined by an outer layer 203. Optionally, the preform 202 can have a plurality of coupling structures 207 so that the closures of various configurations can be attached to a container made from the preform. The distance between an upper surface 205 and the structures 207 and the shape of the structure 207 is determined by the geometry of closure used to seal and close the container made from the preform 202.

FIG. 14A illustrates a container 211 produced from a preform 202 of FIG. 14. A closure 213 is attached to the neck portion 132 of the container 111. The closure 213 can be a one-piece or multi-piece closure. The closure 213 can be temporarily or permanently attached to the container 211. The entire closure 213 can be removed from the container 211 when the liquid is consumed. In other embodiments, a portion of the closure 213 can be removed while another portion of the closure 213 remains attached to the container 211 during consumption. The closure 213 can be semi-permanently or permanently attached to the container. If the closure 213 is semi-permanently attached to the container 211, the closure 213 can be pulled off the container 211. In one embodiment, if the closure 213 is permanently attached to the container 211, the closure 213 and container 211 can form a generally unitary body.

As shown in FIG. 14B, the upper surface 205 of the preform and the closure 213 can form a seal 231, preferably forming either a hermetic seal or other seal that inhibits or prevents liquid from escaping between the container 211 and the closure 213. Optionally, the container 211 can have a gasket or removable seal. For example, the container 211 can have a removable seal, such as a membrane adhered to the upper lip of the container, or a portion of the closure 213 that can be removed. The removable seal can have a tab or ring for convenient gripping and removal of the seal. Alternatively, the seal 231 can be formed by a membrane or sheet that can be broken or pieced in order open the container 211. In some embodiments, an outer layer 203 of the container 211 is formed of a generally high strength material or rigid material (e.g., PP), so that the flange 209 can be compressed between the closure 213 and the outer layer 203 to ensure that the integrity of the seal 231 is maintained.

As shown in FIGS. 14A and 14B, the closure 213 has a body 215 and a cover 218. The body 215 can be connected to the cover 218 by a hinge 221 (e.g., a molded material acting as a living hinge or other structure to permit movement). A latch or tang 217 (FIG. 14A) can fasten the cover 218 to the body 215. The latch 217 can be moved to release the cover 218 in order to open the closure 213. Alternatively, the cover 218 and body 215 can be separate pieces so that the cover 218 can be removed from the body 215. When the closure 213 is in the opened position, contents can be delivered out of the container 211, preferably delivered while the body 215 remains attached to the neck finish. After the desired amount of foodstuff has been removed from the container 211, the cover 218 can be returned to the closed position to reseal the container.

The body 215 of the closure 213 can be releasably coupled to the neck portion. For example, the body 215 can be snapped onto the neck portion 132. Alternatively, the body 215 can be permanently coupled to the neck portion 132. The neck portion 132 comprises one or more closure attaching structures 227, so that the closure 213 can be snapped onto and off of the container. The neck portion 132 in the illustrated embodiment has a closure attaching structure 227 in the form of a negative feature, such as a recess or indentation. The body 215 can be permanently coupled to outer layer 203 by a welding or fusing process (e.g., induction welding), an adhesive, frictional interaction, and/or the like. The container 211 can be configured to receive various types of closures, such as BAP® closures produced by Bapco Closures Limited (England) (or similar closures), screw caps, snap closures, and/or the like. A skilled artisan can design the neck finish of the container 211 to receive closures of different configurations.

With continued reference to FIG. 14A, the container 211 is particularly well suited for hot-fill applications. The container 211 can generally maintain its shape during hot-fill processes. After blow molding or hot-filling, final dimensions of the neck portion of the container 211 are preferably substantially identical to the initial dimensions of the preform. Additionally, this results in reduced dimensions variations of the threads on the neck finish. For example, the inner layer 284 can be formed of a material for contacting foodstuffs, such as PET. The outer layer 203 can comprise moldable materials (e.g., PP, foam material, crystalline or semi-crystalline material, lamellar material, homopolymers, copolymers, combinations thereof, and other heat resistant materials materials described herein) suitable for hot-filling. The outer layer 203 provides dimensional stability to the neck portion 132 even during and/or after hot-filling. The width of the outer layer 203 can be increased or decreased to increase or decrease, respectively, the dimensional stability of the neck portion 132. Preferably, one of the layers forming the neck portion 132 comprises a material having high thermal stability; however, the neck portion 132 can also be made of materials having low temperature stability, especially for non hot-fill applications.

Additionally, the dimensional stability of the outer layer 203 ensures that the closure 213 remains attached to the container 211. For example, the outer layer 203 may comprise a high strength material (e.g., PP) and can maintain its shape thereby preventing the closure 213 from unintentionally decoupling from the container 211.

With reference to FIG. 14C, the container has a neck portion that comprises closure attaching structures for a snap fit. The neck portion in the illustrated embodiment has a closure attaching structure 227 in the form of a positive feature, such as a protrusion, flange, or the like suitable for engaging the closure 213. The closure attaching structure 227 can form an annular protrusion that extends circumferentially about the neck portion. The closure 213 can have a one-piece or multi-piece construction. The illustrated container 211 has an upwardly tapered wall forming the neck finish. The tapered portion of the neck finish can bear against the closure 213 to form a seal.

FIG. 15A illustrates a portion of a preform 220 in accordance with another embodiment. The preform 220 has a support ring 222 and a body portion 224 extending downwardly therefrom. The preform 220 has an opening 226 at its upper end. The neck finish of the preform may or may not have threads. In some embodiments, threads are attached to the neck region 225 of the preform. It is contemplated that the preform 220 can be formed without a support ring. A support ring and/or threads may optionally be formed on the preform 220 in subsequent processes.

FIG. 15B illustrates the preform 220 after closure attaching structures 228 have been attached to the neck region 225. It is contemplated that the threads, structures engaging a snap cap, or other type of mounting or attaching structure can be attached to the neck region 225 before or after the preform 220 has been made into a container. For example, the closure mounting structures 228 can be attached to the preform 220 (e.g., a preform without a neck finish) after the preform has been molded, preferably blow molded into a container.

Preforms can have other portions that are attached or coupled to each other. FIG. 15C illustrates a preform 234 that has at least a portion of the neck finish 240 that is coupled to a body 242 of the preform. The illustrated preform 234 has a portion 238 that is coupled to the upper end 250 of the lower portion 252 of the preform 234. The portion 238 may comprise different materials and/or microstructures than the lower portion 252. In some embodiments, the portion 238 comprises crystalline material. Thus, the preform 230 may be suitable for hot fill applications. The lower portion 252 may be amorphous to facilitate the blow molding process. In some embodiments, the upper portion 238 comprises a different material than the lower portion 252. A skilled artisan can select the material that forms the preform. In some embodiments, the upper end 250 is positioned below or at the support ring. The preforms illustrated in FIGS. 15A to 15C can have monolayer or multilayer walls.

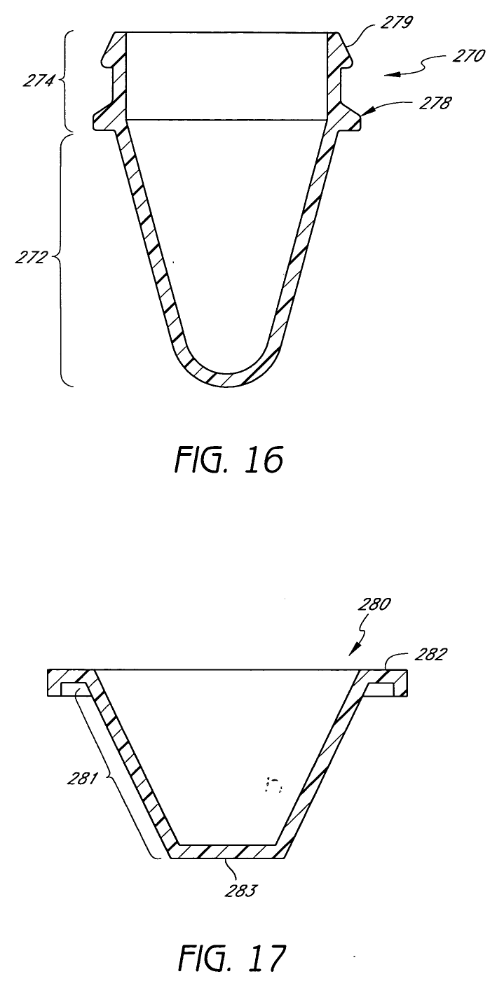

The preforms, including the monolayer and multiplayer preforms, described above can have other shapes and configurations. FIG. 16 illustrates a preform 270 having a tapered body portion 272 and a neck finish 274. The preform 270 can be blow molded to form a container in the form of a jar, for example. A jar or other similar container can have a mouth or opening that is larger than the opening of a bottle. The preform 270 has a support ring 278 and one or more closure attaching structures 279, preferably configured to interact with a snap closure or other type of closure. FIG. 17 illustrates an embodiment of a preform with a neck finish without threads. The preform 280 comprises a body portion 281, which has an end cap 283, and a neck finish 282. The preform 280 may be suitable for blow molding into a container. The preforms illustrated in FIGS. 16 and 17 can be monolayer or multilayer preforms (e.g., having layers described above). The preforms described above can be formed without a neck finish.

The preforms, such as those depicted in FIGS. 1-18, can be subjected to a stretch blow-molding process. The blow molding process is described primarily for the monolayer preform 30, although the multi-layer preforms (e.g., preforms 50, 60, 76, 80, 132, 160, 180, 290, and 216) can be processed in a similar manner. The containers described above can be formed by various molding process (including extrusion blow molding), for example.

2. Detailed Description of Closures

As described above, closures can be employed to seal containers. As used herein, the term “closure” is a broad term and is used in accordance with its ordinary meaning and may include, without limitation, a cap (including snap cap, flip cap, bottle cap, threaded bottle cap, pilfer-proof cap), a crown closure, cork (natural or artificial), punctured seal, a lid (e.g., a lid for a cup), multi-piece closure (e.g., BAP® closures produced by Bapco Closures Limited (England) or similar closure), snap closures, and/or the like.

Generally, the closures can have one or more features that provide further advantages. Some closures can have one or more of the following: tamper evident feature, tamper resistant feature, sealing enhancer, compartment for storage, gripping structures to facilitate removal/placement of the closure, non-spill feature, and combinations thereof.

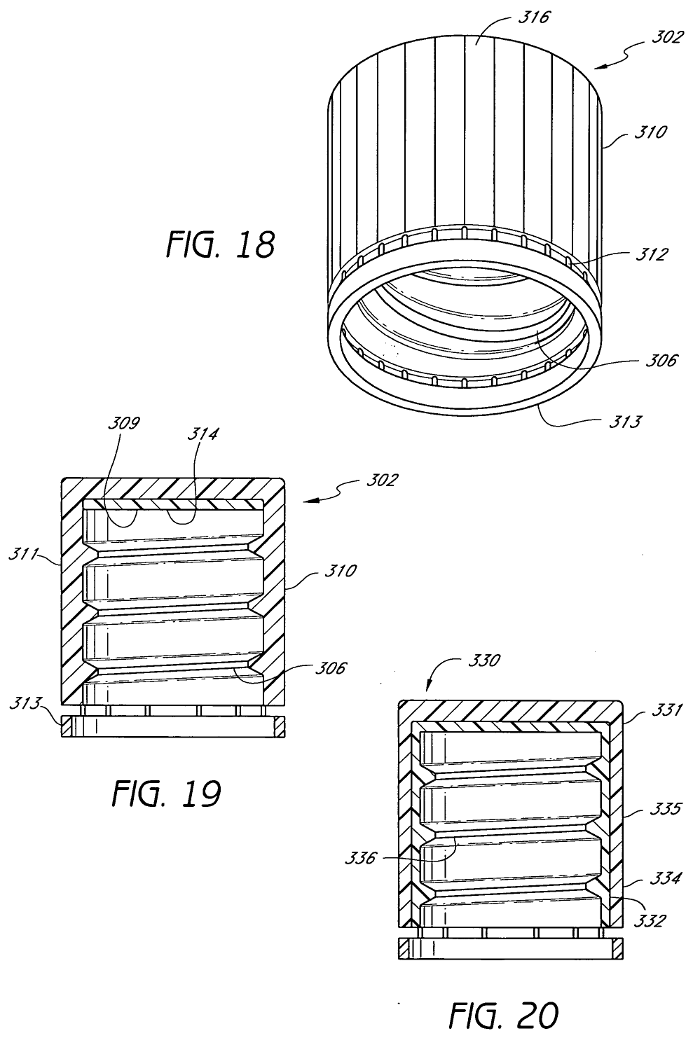

Closures can have a one-piece or multi-piece construction and may be configured for permanently or temporarily coupling to a container. For example, the closure illustrated in FIG. 14A has a multi-piece construction. The closure illustrated in FIG. 18 has a one-piece construction. The terms “closure” and “cap” may be used interchangeably herein. It is contemplated that closures can be used with bottles, boxes (especially boxes used to hold foodstuff, such as juices, for example), cartons, and other packaging or articles. As used herein, the term “bottle cap” is a broad term and is used in accordance with its ordinary meaning and may include, without limitation, a cap suitable for being attached to a bottle, such as a glass or plastic bottle (e.g., bottle typically configured to hold alcoholic beverages or juices) and may or may not have threads. Bottle caps are typically removed by using a bottle opener, as in known in the art. The term “threaded bottle cap” is a broad term and is used in accordance with its ordinary meaning and may include, without limitation, a cap (e.g., a screw cap) suitable for being attached to bottle having threads. In view of the present disclosure, embodiments of closures having threads may be modified to form bottle caps, or other types of closures for containers of different configurations. In some embodiments, closures can threadably engage a container or be attached to a container by various methods, such as sonic welding, induction welding, a multi-step molding process, adhesives, thermoforming, and the like.

FIG. 18 illustrates one embodiment of a closure 302 that can be coupled to an article, such as the neck portion of a container. In the illustrated embodiment, the closure 302 has internal threads 306 (FIG. 19) that are configured to mate with the threads of a neck portion so that the closure 302 can be removably coupled to a container. The closure 302 can be fastened to the container (e.g., a bottle) to close the opening or mouth of the bottle. The closure 302 includes a main body 310, and an optional tamper evidence structure or anti-tamper structure, such as a band 313 (or skirt) coupled to the body 310 by one or more connectors 312. The connectors 312 can be sized and adapted so that when the closure 302 is removed from a container, the connectors 312 will break, thus separating the body 310 and the band 313 indicating that the closure 302 has been removed from the associated container. Although not illustrated, other types of temper evidence structures can be employed. A surface 316 of the body 310 can have a surface treatment, such as grooves, ridges, texture treatment, and/or the like to facilitate frictional interaction with the closure 302.

With respect to FIG. 19, the closure 302 comprises the body 310 and may or may not have a liner. The illustrated closure 302 comprises an optional inner closure layer 314. The illustrated closure inner layer 314 is in the form of a liner contained within an outer portion 311 of the body 310. The liner 314 can be adapted to be in contact with foodstuff or liquid and may form a seal with the lip that forms the opening of the bottle. Thus, the liner 314 forms a substantial portion, or the entire portion, of a contact area of the closure 304.

The liner 314 can be a barrier liner, such as an active or passive barrier liner. The liner 314 can function as a fluid barrier (e.g., a liquid or gas), flavor barrier, and combinations thereof. For example, the liner 314 can be a gas barrier that inhibits or prevents the passage of oxygen, carbon dioxide, and the like therethrough. In some embodiments, the liner 314 can have scalping capabilities, such as gas scalping (e.g., oxygen scalping).

The liner 314 can be pressed against a lip of a bottle to prevent liquid from escaping from the container that is sealed by the closure 302. In one embodiment, the liner 314 is a gas barrier that prevents or inhibits gas from escaping from the container. In another embodiment, the liner 314 is a flavor barrier that can prevent or limit the change of the taste of the fluid within the container. For example, the liner 314 can be formed of a polymer (e.g., a thermoplastic material) that can act as a flavor barrier to ensure that foodstuff in the container maintains a desirable flavor. Thus, the liner 314 can help to ensure that the body 310 does not impart flavor and/or odor to foodstuff in the container.

Many times, a somewhat flavor imparting material and/or flavor reducing or scalping material (e.g., polyolefins such as polypropylene or polyethylene) is used to form a container or closure, such as a cap of a bottle, due to its physical properties (e.g., durability, toughness, impact resistance, and/or strength). In certain embodiments polypropylene may exhibit one or more physical properties which are preferred to the physical properties of polymers such as PET. Unfortunately, in certain circumstances polypropylene has a tendency to reduce or scalp the flavor of the contents of the bottle or to remove desired flavors or aromatic components from the contents. Thus, a person consuming the food previously in contact with the PP may be able to recognize a change in flavor. Advantageously, the liner 314 can comprise a flavor preserving material so that the food stuff in the container is not generally affected when the foodstuff contacts the liner 314. Preferably, the flavor preserving material is a material approved by the FDA for contacting foodstuff.

In some non-limiting embodiments, the flavor preserving material comprises PET (such as virgin PET), phenoxy type-thermoplastic, and/or the like. The body 310 can therefore be made of a flavor scalping material, such as polypropylene, to provide desired physical properties and the liner 314 comprises PET for an effective flavor barrier to ensure that the contents of container maintain a desirable taste. It is contemplated that the liner 314 can be formed of any material suitable for contacting the food stuff in the container. In some embodiments, the liners 314 can be formed of foam material described herein that may or may not substantially alter the taste of the contents of the container. Additionally, the thickness of the liner 314 can be increased to inhibit gas or other fluids from passing through the liner. Optionally, the liner 314 can be a monolayer or multilayer structure. For example, the liner 314 can comprise an inner layer of PET (i.e., the layer in contact with the container contents) and an outer layer of foam material.

The liner 314 can have a layer suitable for contacting foodstuffs and one or more layers acting as a barrier, similar to the preforms described herein. In some embodiments, for example, the liner 314 can comprise a first layer and a second layer wherein the first layer comprises a foam material and the second layer comprises a barrier material. Thus, a second layer can reduce or inhibit the migration of fluid through the liner 314 and the first layer insulates the closure 302. In some embodiments, the liner 314 comprises a layer of PET and a layer comprising a second material. The PET layer preferably is the lowermost layer so that it forms a seal with the lip of a container. The second material can be EVA or other suitable material for forming a portion of a liner.

In some embodiments, the liner 314 of FIG. 19 can be pre-formed and inserted into the body 310. For example, the body 310 can be shaped like a typical screw cap used to seal a bottle. The liner 314 is formed by cutting out a portion of the sheet, which is described below. The pre-cut liner 314 can then be inserted into the body 310 and positioned as shown in FIG. 19. Alternatively, the liner 314 can be formed within the body 310. For example, the liner 314 can be formed through a molding process, such as over-molding. At least a portion of the liner 314 can be formed by a spray coating process. For example, a monolayer liner can be sprayed and coated with a polymer (e.g., PET, phenoxy type thermoplastic, or other materials described herein) resulting in a multilayer liner.

A further advantage is optionally provided where the liner 314 can be retained in the body 310 or can be attached to the container. The liner 314 can be attached to the body 310 such that the liner 314 remains coupled to the body 310 after the body has been separated from the container. Alternatively, the liner 314 can be coupled to the container so that the body 310 and liner are separable. For example, the liner 314 can be transferred to the body 310 to the opening of a container by a welding process, such as an induction welding process.

A further advantage is optionally provided where at least a portion of the closure 302 is formed of material to provide a comfortable gripping surface so that a user can comfortably grip the closure 302. The body 310 may comprise a material for sufficient rigidity, (e.g., PP), compressibility for a comfortable grip (e.g., foam material), and/or the like. In some embodiments, the outer portion 311 of the body 310 can comprise foam to increase the space occupied by the outer portion 311 and can provide the user with greater leverage for easy opening and closing of the closure 302. For example, the closure 302 can have an internally threaded surface that is configured to threadably mate with an externally threaded surface of the container. The enlarged outer portion 311 can provide increased leverage such that the user can easily rotate the closure 302 onto and off of a container. Advantageously, a similar, or same, amount of material that forms a conventional cap can be used to form the enlarged diameter closure.

In some embodiments, at least a portion of one of the portions 311 and liner 314 can be formed of foam material to achieve a very lightweight closure due to the low density of the foam material. The reduced weight of the closure 302 can desirably reduce the transportation cost of the closure 302. Additionally, a foam material of the closure 302 can reduce the amount of material that is used to form the closure, since the foam material may have a substantial number of voids.

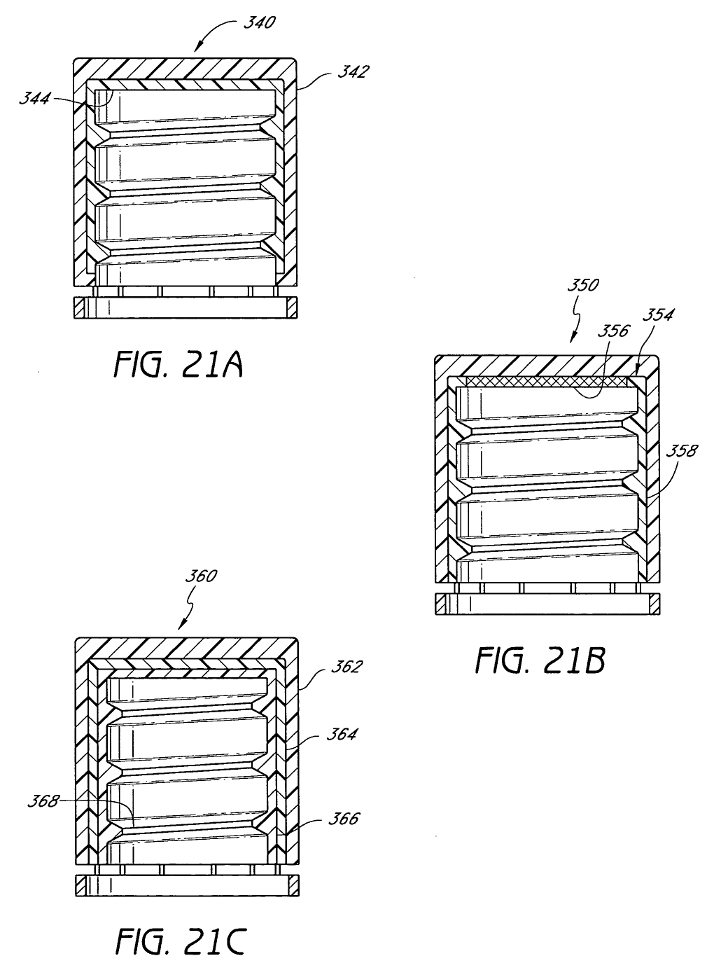

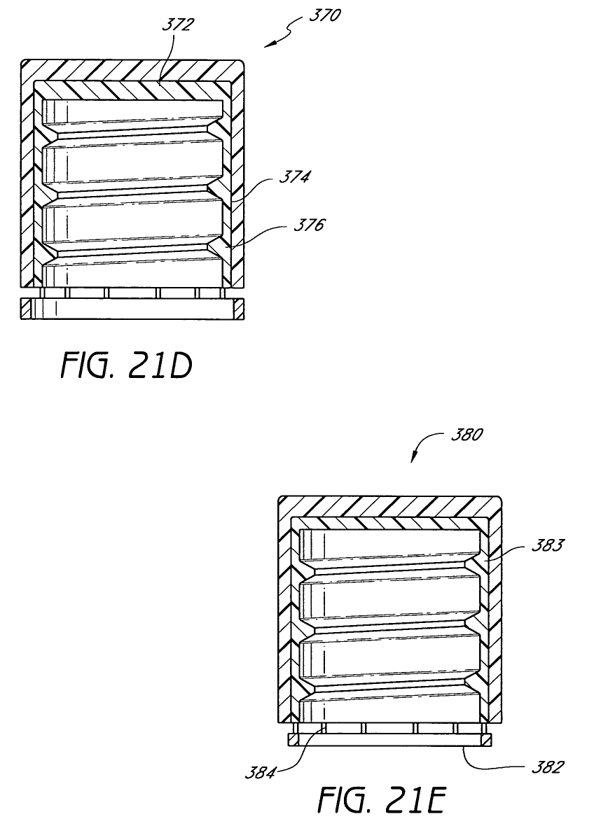

The closures described below can be similar to or different than the closure illustrated in FIG. 19. With respect to FIG. 20, the closure 330 has a body 331 that comprises an inner portion 332 and an outer portion 334. The illustrated wall 335 comprises the portions 332, 334. The inner portion 332 may define at least a portion of the interior of the closure 330 and can optionally define one or more of the threads 336. The inner portion 332 can be formed by an injection molding process, spray coating process, or other process described herein for forming a portion of an article. In some non-limiting embodiments, the inner portion 332 comprises polyolefin (e.g., PET), phenoxy type thermoplastics, and/or other materials described herein. FIGS. 21A to 21E illustrate non-limiting embodiments of closures. FIG. 21A illustrates a closure 340 that has an outer portion 342 and an inner portion 344 that forms at least a portion of the interior of the closure 340. That is, the outer portion 342 and the inner portion 344 each can define a portion (e.g., the threads) of the interior surface of the closure 340. The inner portion 344 is set into the outer portion 342; however, in other embodiments the inner portion 344 is not set into the outer 342. FIG. 21B illustrates a closure 350 that comprises an inner portion 354 comprising a plurality of layers 356, 358. FIG. 21C illustrates a closure 360 comprising a plurality of layers. An outer layer 362 forms the outer surface (including the top and wall) of the closure 360. An intermediate layer 364 can comprise one or more layers. An inner layer 366 defines a threaded contact surface 368.

The closures can have portions or layers of varying thicknesses. As shown in FIG. 21D, at least one of the portions or layers of a closure 370 comprises a thickened portion. The illustrated closure 370 has an inner portion 374 with an upper thickened portion 372 that has a thickness greater than the thickness of the wall portion 376.

FIG. 21E illustrates a multilayer closure 380 that comprises a band 382 connected to an inner portion 383 of the closure 380 by one or more connectors 384. The closures illustrated in FIGS. 18 to 21E may have any suitable structure(s) or design for coupling to containers. For example, the closures of FIGS. 18 to 21E may have a similar configuration as the closure 213 (FIG. 14A). It is contemplated that the closures of FIGS. 18-21E described herein can be attached to containers by threadable engagement, welding or fusing process (e.g., induction welding), an adhesive, by frictional interaction, or the like. The closures of FIGS. 18-21E are illustrated with bands. However, the closures may not have bands, or they may have other anti-tamper indicators or structures. Although the closures of FIGS. 18-21E are illustrated as screw closures, other types of closures (e.g., closures of a multi-piece construction, such as closures with a lid that opens and closes, a closure with a nipple, and or the like) have similar constructions.

The closures can have one or more compartments configured for storage. The compartments can contain additives that can be added to the contents of the associated container. The additives can affect the characteristics of the container's contents and can be in a solid, gas, and/or liquid state. In some embodiments, the additives can affect one or more of the following: aroma (e.g., additives can comprise scented gases/liquids), flavor, color (e.g., additives can comprise dies, pigments, etc.), nutrient content (e.g., additives can comprise vitamins, protein, carbohydrates, etc.), and combinations thereof. The additives can be delivered from the closure into the contents within the container for subsequent ingestion and preferably enhance the desirability of the contents and the consumption experience. The compartment can release the additives during removal of the closure so that the mixture is fresh. However, the compartment can be opened before or after the closure is removed from the container. In some embodiments, the closure has a compartment that can be broken (e.g., punctured) after the closure has been separated from a container. The compartment can be broken by a puncturing process, tearing, and the like. The compartment can have a structure for releasing its contents. The structure can be a pull plug, snap cap or other suitable structure for releasing the compartment's contents.

The containers can also be closed with a seal that is separate from the closure. The seal can be applied to the container before the closure is attached. A sealing process can be employed to attach the seal to the neck finish of a container after the container has been filled. The seal can be similar to or different than the liners that are attached to the closures. The seals can be hermetic seals (preferably spill proof) that ensure the integrity of the containers' contents. In some embodiments, the seal can comprise foil (preferably comprising metal, such as aluminum foil) and is applied to a container by a welding process, such as induction welding. However, the seal can be attached to a container using other suitable attachment processes, for example an adhesive may be used.

The closures can have an inner surface suitable for engaging closuring mounting structures (e.g., threads, snap cap fittings, and the like). The inner surface can provide a somewhat lubricious surface to facilitate removal of the closure from a container. For example, the closures can have a lubricious or low friction material (e.g. olefin polymers) to engage the material forming the container. If a closure is formed of PET, for example, the closure may stick or lock with a PET container. Thus, the closure (including snap caps, twist caps, and the like) may require a relatively high removal torque. Advantageously, a closure with a lubricious or low friction material can reduce the removal torque in order to facilitate removal of the closure. The lubricious or low friction material preferably provides enough friction such that closure can remain coupled to an associated container while also permitting convenient closure removal. Thus, the lubricious or low friction material can be selected to achieve the desired removal torque.

With reference to FIG. 20, the closure 330 can include an inner portion 332 comprising a lubricious or low friction material (e.g., an olefin or other material having a low coefficient of friction) and an outer portion 334 comprising a polymer, such as an olefin polymer, foam material, PET, and other materials described herein. The closures described herein can comprise lubricious or low friction material that can interface with a container and achieve a desired removal torque. The lubricious or low friction material forming the closure can be selected based on the material forming the container in order to produce the desired frictional interaction. It is contemplated that the molds described herein can be modified with an edge gate to form the inner most layer of the closure for engaging a container.

3. Detailed Description of Mono and Multilayer Profiles and Sheets

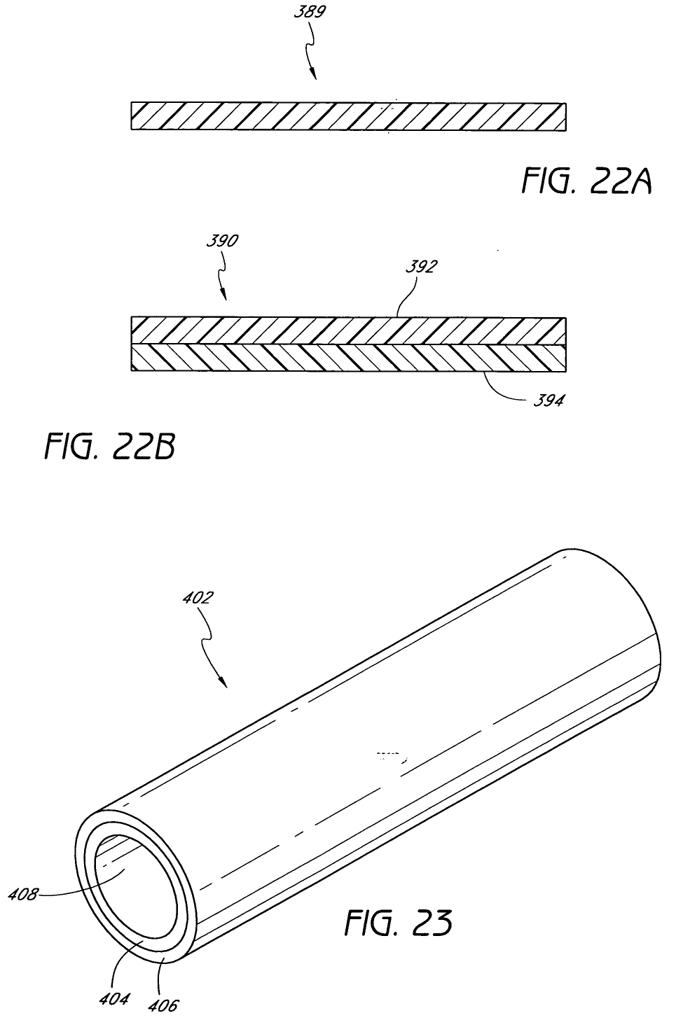

FIGS. 22A and 22B are cross-sectional views of sheets. The sheets can have a somewhat uniform thickness or varying thickness. The sheet of FIG. 22A is a monolayer sheet 389. The sheet of FIG. 22B is a multilayer sheet 390 comprising two layers. The sheets can have any number of layers of any desired thickness based, for example, on the use of the sheets. For example, the sheets 389, 390 can be used to form packaging, such as a label. At least a portion of the sheets 389, 390 may comprise foam material. For example, the sheets 389, 390 may comprise foam material to provide insulation to the packaging to which the label is attached. Optionally, the sheet 390 can comprise one or more tie layers. For example, the sheet 390 may comprise a tie layer between the layers 392, 394.

The sheets can be used in various applications and may be formed into various shapes. For example, the sheets can be cut, molded (e.g., by thermoforming or casting), and/or the like into a desired shape. A skilled artisan can select the desired shape, size, and/or configuration of the sheets based on a desired application.

FIG. 23 illustrates a multilayer profile 402. The profile 402 is in the form of a conduit having a substantially tubular shape. The shape of the profile 402 can be generally circular, elliptical, polygonal (including rounded polygonal), combinations thereof, and the like. The illustrated profile 402 has a generally circular cross sectional profile.

In some embodiments, the profile 402 can be a conduit adapted for delivering fluids, preferably adapted for drinking liquids. The profile 402 can have an inner layer 404 and an outer layer 406. In some embodiments, at least one of the layers 404, 406 can comprise a plurality of layers (e.g., lamellar material).

The profile 402 can be a conduit that comprises a material suitable for contacting foodstuff and one or more additional materials having desirable physical properties (e.g., structural and thermal properties). Advantageously, the inner layer 404 that is in direct contact with the fluid preferably does not substantially change the flavor of the foodstuff in which it contacts. For example, many times fluid transfer lines of beverage dispensing systems have flavor scalping polyolefins. Advantageously, the inner layer 404 preferably does not substantially change the flavor of the fluid passing through a lumen 408 of the profile 402. In some embodiments, the outer layer 406 can provide improved physical characteristics of the profile 402. In another embodiment, the outer layer 406 can provide increased insulation and/or structural properties of the profile 402. For example, in one embodiment the outer layer 406 can provide increased impact resistance. In some embodiments, the outer layer 406 can reduce heat transfer through the walls of the profile 402. In some embodiments, the outer layer 406 can have a high tensile strength so that highly pressurized fluid can be passed through the profile 402. Thus, the inner layer serves as a substantially inert food contact surface while the outer layer(s) serve as an insulator and/or withstand external influences.

Of course, the profile 402 can be employed in various other applications. For example, the profile 402 can be used in hospitals (e.g., as a delivery line for medicinal fluids, manufacturing processes, equipment, fluid systems (e.g., ingestible fluid dispensing systems), and/or the like.

4. Detailed Description of Packaging

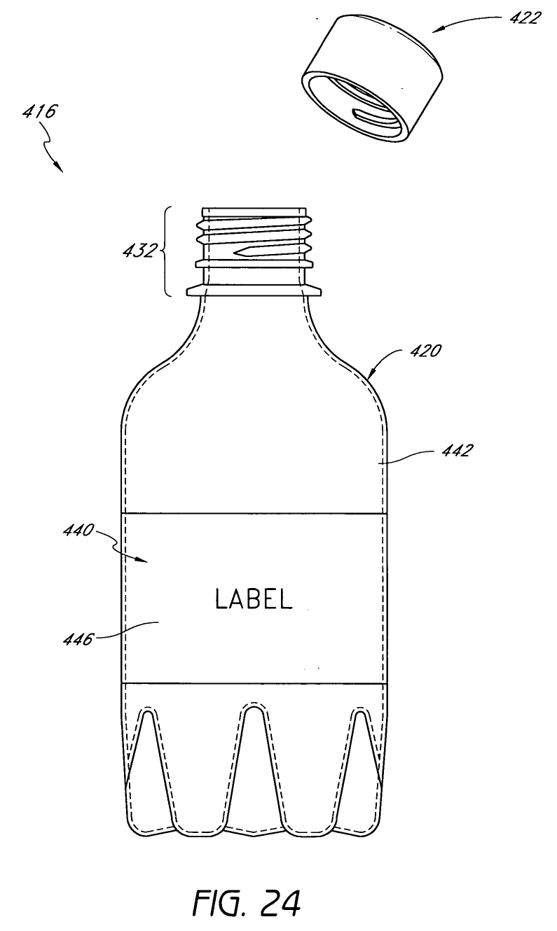

One or more of the articles described herein can be employed alone or in combination in various applications, such as packaging. FIG. 24 illustrates a packaging system 416 comprising a container 420 that can be made from the preforms described herein. A closure 422 can be attached to a neck finish 432 of the container 420 to close the container.

FIG. 24 also illustrates a label 440 attached to the container 420 in the form of a bottle. The label 440 can engage the bottle 420 and can be a monolayer or multilayer. The label 440 can optionally comprise foam material.

The label 440 is preferably coupled to the outer surface 442 of the container 420. The label 440 can be removably attached the outer surface 442. The label 440 can be attached during and/or after the formation of the container 420. In the illustrated embodiment, the label 440 is a generally tubular sleeve that surrounds at least a portion of the bottle 420. The label 440 can have any shape or configuration suitable for being attached to the bottle and displaying information. Although not illustrated, the label 440 can be attached to glass bottles, metal cans, or the like. Further, the label 440 can be attached to other structures or packages. For example, the label 440 can be attached to a box, carton, bottle (plastic bottle, glass bottle, and the like), can, and other items discussed herein. Additionally, the label 440 can be printed upon. Optionally, an outer surface 446 of the label 440 can be treated to achieve a suitable printing surface.

An adhesive can be used to attach the label 440 to an article. In one embodiment, after the label is attached to the article, foam material of the label 440 may be expanded to achieve a thermal barrier, a fluid barrier, a protective layer, and/or desired structural properties. The foam material is preferably expanded by heating the label 440. The material of the label 440 can be foamed before and/or after the label 440 is placed on the container 420. Of course, the foam material of the label 440 can be directly adhered to an article without the use of adhesives.

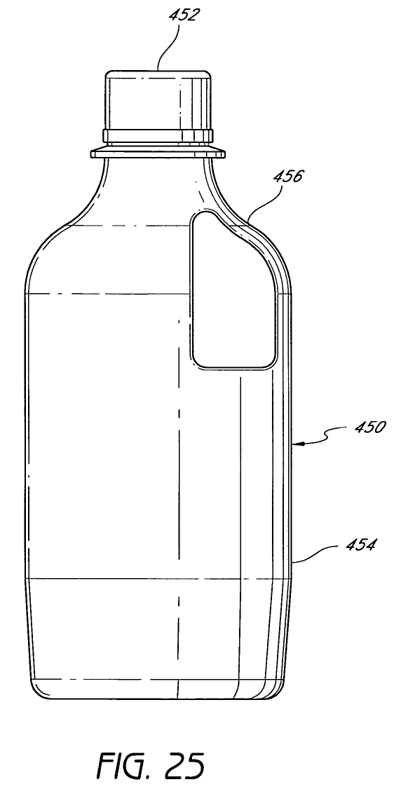

FIG. 25 illustrates another embodiment of a container comprising a formable material. The container 450 can be similar or different than the containers described above. In the illustrated embodiment, the container 450 comprises a closure 452, a body 454, and a handle 456 attached to the body 454. The body 454 can be substantially rigid or flexible. The handle 456 is preferably configured and sized to be comfortably gripped by a user. The wall of the body 454 can be a mono-layer or multi-layer wall. The container 450 can have any shape, including a shape similar to typical containers used for holding ingestible liquids. The container 450 can be formed by an extrusion blow-molding process, for example.

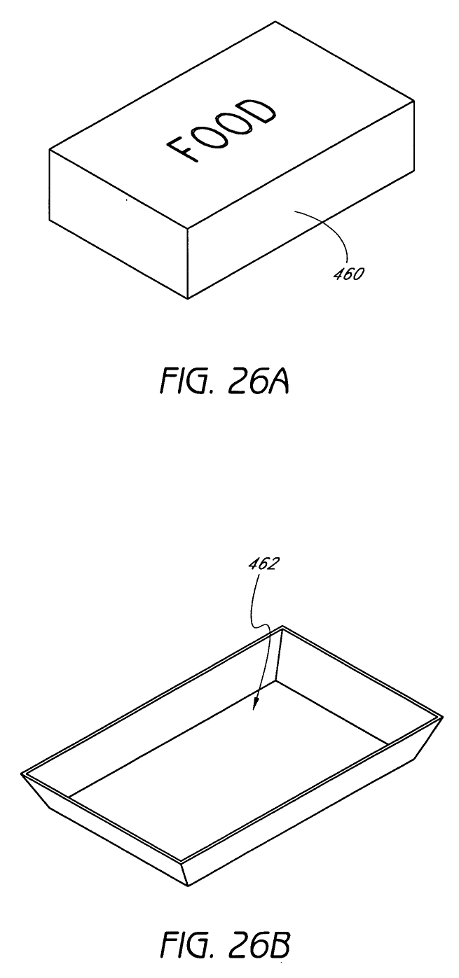

With respect to FIG. 26A, container 460 is packaging (e.g., food packaging) that preferably comprises foam material. In one embodiment, a sheet (e.g., the sheets 389 or 390) is used to form at least a portion of the container 460 by, e.g., a thermoforming process. The container 460 can be in the form of a flexible pouch, food container, or any other suitable structure.

For example, in one arrangement the sheets are formed into clamshell packages that are adapted to hold food, such as hamburgers. In another arrangement, the sheets are configured to form boxes (e.g., pizza boxes). In another embodiment, the material and the dimensions of the container 460 can be determined based on the desired structural properties, thermal properties, and/or other characteristics. For example, the container 460 may comprise foam material for effective thermal insulation of the container 460. In another example, the container 460 can have thick walls so that the container 460 is generally rigid.

FIG. 26B illustrates another article comprising formable material. In one embodiment, the article 462 is in the form of a tray that is configured to receive foodstuff. The tray 462 can be formed from a sheet through thermoforming. Optionally, the tray 462 can be adapted to fit within a container or box.

The tray 462 (or other articles described herein) can be configured for thermal processing. In some embodiments, the tray 462 can be used for heating and reheating. The tray 462 can hold foodstuffs so that the foodstuffs can be heated by, for example, a heat lamp, microwave oven, oven, toaster, heated water, and the like. The microstructure of the tray 462 can be adapted based on the type and method of thermal processing. For example, the tray 462 may comprise crystalline material (e.g., crystalline PET) to enhance thermal stability. During the thermoforming process one or more layers of the tray can be heated above a predetermined temperature to cause crystallization of at least a portion of one of the layers. Thus, at least a portion of the tray 462 can be crystallized during the manufacturing process. In some embodiments, the tray 462 can comprise a mono or multilayer sheet. The tray 462 can have a first layer of thermoplastic material and a second layer (e.g., a foam layer). The first layer can comprise crystalline material (e.g., amorphous, partially crystallized, or fully crystallized). The tray 462 can be used to hold food for use in a microwave oven. Of course, other articles, such as containers like pizza boxes, can have a similar configuration.

Articles can also be in the form of a can. The can may comprise polymer materials as disclosed herein. The can may comprise a metal layer and one or more layers of another material. In some embodiments, a metal can (e.g., aluminum can) can be coated with foam material such as a thermoplastic material. At least a portion of the exterior and/or the interior of the can may be coated with foam material.

B. Crystalline Neck Finishes

Plastic bottles and containers, in some embodiments, preferably comprise one or more materials in the neck, neck finish and/or neck cylinder that are at least partially in the crystalline state. Such bottles and preforms can also comprise one or more layers of materials.

In some embodiments, bottles are made by a process which includes the blow-molding of plastic preforms. In some circumstances, it is preferred that the material in the plastic preforms is in an amorphous or semi-crystalline state because materials in this state can be readily blow-molded where fully crystalline materials generally cannot. However, bottles made entirely of amorphous or semi-crystalline material may not have enough dimensional stability during a standard hot-fill process. In these circumstances, a bottle comprising crystalline material would be preferred, as it would hold its shape during hot-fill processes.

In some embodiments, a plastic bottle has the advantages of both a crystalline bottle and an amorphous or semi-crystalline bottle. By making at least part of the uppermost portion of the preform crystalline while keeping the body of the preform amorphous or semi-crystalline (sometimes referred to herein as “non-crystalline”), one can make a preform that will blow-mold easily yet retain necessary dimensions in the crucial neck area during a hot-fill process. Some embodiments have both crystalline and amorphous or semi-crystalline regions. This results in a preform which has sufficient strength to be used in widespread commercial applications.

One or more embodiments described herein generally produce preforms with a crystalline neck, which are typically then blow-molded into beverage containers. The preforms may be monolayer; that is, comprised of a single layer of a base material, or they may be multilayer. The material in such layers may be a single material or it may be a blend of one or more materials. In one embodiment, an article is provided which comprises a neck portion and a body portion. The neck portion and the body portion are a monolithic first layer of material. The body portion is primarily amorphous or semi-crystalline, and the neck portion is primarily crystalline.

Referring to FIG. 1, the preferred preform 30 is depicted. The preform 30 may be made by injection molding as is known in the art or by methods disclosed herein. The preform 30 has the neck portion 32 and a body portion 34, formed monolithically (i.e., as a single, or unitary, structure). Advantageously, in some embodiments, the monolithic arrangement of the preform, when blow-molded into a bottle, provides greater dimensional stability and improved physical properties in comparison to a preform constructed of separate neck and body portions, which are bonded together.

By achieving a crystallized state in the neck portion of the preform during the molding step, the final dimensions are substantially identical to the initial dimensions, unlike when additional heating steps are used. Therefore, dimensional variations are minimized and dimensional stability is achieved. This results in more consistent performance with regard to closures, such as the threads on the neck finish and reduces the scrap rate of the molding process.

While a non-crystalline preform is preferred for blow-molding, a bottle having greater crystalline character is preferred for its dimensional stability during a hot-fill process. Accordingly, a preform constructed according to some embodiments has a generally non-crystalline body portion and a generally crystalline neck portion. To create generally crystalline and generally non-crystalline portions in the same preform, one needs to achieve different levels of heating and/or cooling in the mold in the regions from which crystalline portions will be formed as compared to those in which generally non-crystalline portions will be formed. The different levels of heating and/or cooling may be maintained by thermal isolation of the regions having different temperatures. This thermal isolation between the thread split, core and/or cavity interface can be accomplished utilizing a combination of low and high thermal conduct materials as inserts or separate components at the mating surfaces of these portions.

Some preferred processes accomplish the making of a preform within the preferred cycle times for uncoated preforms of similar size by standard methods currently used in preform production. Further, the preferred processes are enabled by tooling design and process techniques to allow for the simultaneous production of crystalline and amorphous regions in particular locations on the same preform.

In one embodiment, there is provided a mold for making a preform comprising a neck portion having a first mold temperature control system (e.g., cooling/heating channels), a body portion having a second temperature control system, and a core having a third temperature control system, wherein the first temperature control system is independent of the second and third temperature control systems and the neck portion is thermally isolated from the body portion and core.

The cooling of the mold in regions which form preform surfaces for which it is preferred that the material be generally amorphous or semi-crystalline, can be accomplished by chilled fluid circulating through the mold cavity and core. In some embodiments, a mold set-up similar to conventional injection molding applications is used, except that there is an independent fluid circuit or electric heating system for the portions of the mold from which crystalline portions of the preform will be formed. Thermal isolation of the body mold, neck finish mold and core section can be achieved by use of inserts having low thermal conductivity. The neck, neck finish, and/or neck cylinder portions of the mold preferably are maintained at a higher temperature to achieve slower cooling, which promotes crystallinity of the material during cooling.

The above embodiments as well as further embodiments and techniques regarding preforms that have both crystalline and amorphous or semi-crystalline regions are described in U.S. Pat. No. 6,217,818 to Collette et al; U.S. Pat. No. 6,428,737 to Collette et al.; U.S. patent Publication No. 2003/0031814 A1 to Hutchinson et al.; and PCT Publication No. WO 98/46410 to Koch et al.

C. Detailed Description of Some Preferred Materials

1. General Description of Preferred Materials

Furthermore, the articles described herein may be described specifically in relation to a particular material, such as polyethylene terephthalate (PET) or polypropylene (PP), but preferred methods are applicable to many other thermoplastics, including those of the of the polyester and polyolefin types. Other suitable materials include, but are not limited to, foam materials, various polymers and thermosets, thermoplastic materials such as polyesters, polyolefins, including polypropylene and polyethylene, polycarbonate, polyamides, including nylons (e.g. Nylon 6, Nylon 66, MXD 6), polystyrenes, epoxies, acrylics, copolymers, blends, grafted polymers, and/or modified polymers (monomers or portion thereof having another group as a side group, e.g. olefin-modified polyesters). These materials may be used alone or in conjunction with each other. More specific material examples include, but are not limited to, ethylene vinyl alcohol copolymer (“EVOH”), ethylene vinyl acetate (“EVA”), ethylene acrylic acid (“EAA”), linear low density polyethylene (“LLDPE”), polyethylene 2,6- and 1,5-naphthalate (PEN), polyethylene terephthalate glycol (PETG), poly(cyclohexylenedimethylene terephthalate), polystryrene, cycloolefin, copolymer, poly-4-methylpentene-1, poly(methyl methacrylate), acrylonitrile, polyvinyl chloride, polyvinylidine chloride, styrene acrylonitrile, acrylonitrile-butadiene-styrene, polyacetal, polybutylene terephthalate, ionomer, polysulfone, polytetra-fluoroethylene, polytetramethylene 1,2-dioxybenzoate and copolymers of ethylene terephthalate and ethylene isophthalate.

As used herein, the term “polyethylene terephthalate glycol” (PETG) refers to a copolymer of PET wherein an additional comonomer, cyclohexane di-methanol (CHDM), is added in significant amounts (e.g. approximately 40% or more by weight) to the PET mixture. In one embodiment, preferred PETG material is essentially amorphous. Suitable PETG materials may be purchased from various sources. One suitable source is Voridian, a division of Eastman Chemical Company. Other PET copolymers include CHDM at lower levels such that the resulting material remains crystallizable or semi-crystalline. One example of PET copolymer containing low levels of CHDM is Voridian 9921 resin.

In some embodiments polymers that have been grafted or modified may be used. In one embodiment polypropylene or other polymers may be grafted or modified with polar groups including, but not limited to, maleic anhydride, glycidyl methacrylate, acryl methacrylate and/or similar compounds to improve adhesion. In other embodiments polypropylene also refers to clarified polypropylene. As used herein, the term “clarified polypropylene” is a broad term and is used in accordance with its ordinary meaning and may include, without limitation, a polypropylene that includes nucleation inhibitors and/or clarifying additives. Clarified polypropylene is a generally transparent material as compared to the homopolymer or block copolymer of polypropylene. The inclusion of nucleation inhibitors helps prevent and/or reduce crystallinity, which contributes to the haziness of polypropylene, within the polypropylene. Clarified polypropylene may be purchased from various sources such as Dow Chemical Co. Alternatively, nucleation inhibitors may be added to polypropylene. One suitable source of nucleation inhibitor additives is Schulman.

Optionally, the materials may comprise microstructures such as microlayers, microspheres, and combinations thereof. In certain embodiments preferred materials may be virgin, pre-consumer, post-consumer, regrind, recycled, and/or combinations thereof.

As used herein, “PET” includes, but is not limited to, modified PET as well as PET blended with other materials. One example of a modified PET is “high IPA PET” or IPA-modified PET, which refer to PET in which the IPA content is preferably more than about 2% by weight, including about 2-10% IPA by weight, also including about 5-10% IPA by weight. PET can be virgin, pre or post-consumer, recycled, or regrind PET, PET copolymers and combinations thereof.

In embodiments of preferred methods and processes one or more layers may comprise barrier layers, UV protection layers, oxygen scavenging layers, oxygen barrier layers, carbon dioxide scavenging layers, carbon dioxide barrier layers, and other layers as needed for the particular application. As used herein, the terms “barrier material,” “barrier resin,” and the like are broad terms and are used in their ordinary sense and refer, without limitation, to materials which, when used in preferred methods and processes, have a lower permeability to oxygen and carbon dioxide than the one or more of the layers. As used herein, the terms “UV protection” and the like are broad terms and are used in their ordinary sense and refer, without limitation, to materials which have a higher UV absorption rate than one or more layers of the article. As used herein, the terms “oxygen scavenging” and the like are broad terms and are used in their ordinary sense and refer, without limitation, to materials which have a higher oxygen absorption rate than one or more layers of the article. As used herein, the terms “oxygen barrier” and the like are broad terms and are used in their ordinary sense and refer, without limitation, to materials which are passive or active in nature and slow the transmission of oxygen into and/or out of an article. As used herein, the terms “carbon dioxide scavenging” and the like are broad terms and are used in their ordinary sense and refer, without limitation, to materials which have a higher carbon dioxide absorption rate than one or more layers of the article. As used herein, the terms “carbon dioxide barrier” and the like are broad terms and are used in their ordinary sense and refer, without limitation, to materials which are passive or active in nature and slow the transmission of carbon dioxide into and/or out of an article. Without wishing to be bound to any theory, applicants believe that in applications wherein a carbonated product, e.g. a soft-drink beverage, contained in an article is over-carbonated, the inclusion of a carbon dioxide scavenger in one or more layers of the article allows the excess carbonation to saturate the layer which contains the carbon dioxide scavenger. Therefore, as carbon dioxide escapes to the atmosphere from the article it first leaves the article layer rather than the product contained therein. As used herein, the terms “crosslink,” “crosslinked,” and the like are broad terms and are used in their ordinary sense and refer, without limitation, to materials and coatings which vary in degree from a very small degree of crosslinking up to and including fully cross linked materials such as a thermoset epoxy. The degree of crosslinking can be adjusted to provide the appropriate degree of chemical or mechanical abuse resistance for the particular circumstances. As used herein, the term “tie material” is a broad term and is used in its ordinary sense and refers, without limitation, to a gas, liquid, or suspension comprising a material that aids in binding two materials together physically and/or chemically, including but not limited to adhesives, surface modification agents, reactive materials, and the like.

2. Preferred Materials

In a preferred embodiment materials comprise thermoplastic materials. A further preferred embodiment includes “Phenoxy-Type Thermoplastics.” Phenoxy-Type Thermoplastics, as that term is used herein, include a wide variety of materials including those discussed in WO 99/20462. In one embodiment, materials comprise thermoplastic epoxy resins (TPEs), a subset of Phenoxy-Type Thermoplastics. A further subset of Phenoxy-Type Thermoplastics, and thermoplastic materials, are preferred hydroxy-phenoxyether polymers, of which polyhydroxyaminoether copolymers (PHAE) is a further preferred material. See for example, U.S. Pat. Nos. 6,455,116; 6,180,715; 6,011,111; 5,834,078; 5,814,373; 5,464,924; and 5,275,853; see also PCT Application Nos. WO 99/48962; WO 99/12995; WO 98/29491; and WO 98/14498. In some embodiments, PHAEs are TPEs.

Preferably, the Phenoxy-Type Thermoplastics used in preferred embodiments comprise one of the following types:
(1) hydroxy-functional poly(amide ethers) having repeating units represented by any one of the Formulae Ia, Ib or Ic: 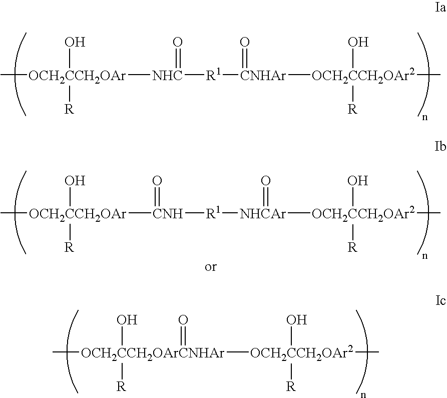
(2) poly(hydroxy amide ethers) having repeating units represented independently by any one of the Formulae IIa, IIb or IIc: 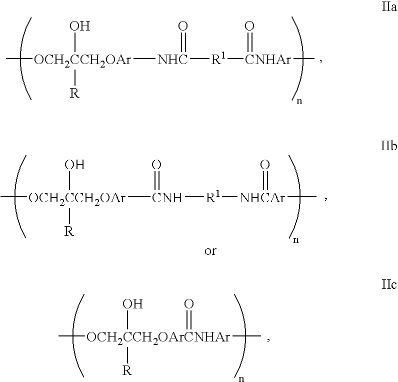
(3) amide- and hydroxymethyl-functionalized polyethers having repeating units represented by Formula III: 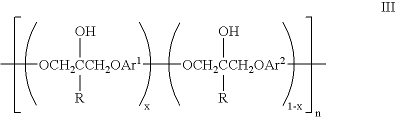
(4) hydroxy-functional polyethers having repeating units represented by Formula IV: 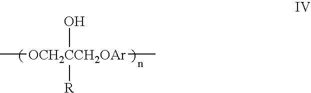
(5) hydroxy-functional poly(ether sulfonamides) having repeating units represented by Formulae Va or Vb: 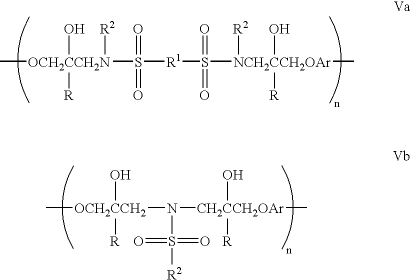
(6) poly(hydroxy ester ethers) having repeating units represented by Formula VI: 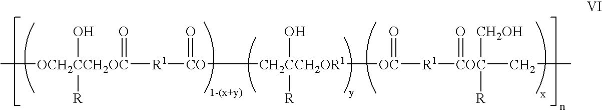
(7) hydroxy-phenoxyether polymers having repeating units represented by Formula VII: 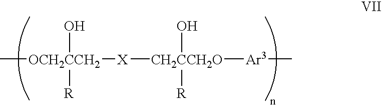
and
(8) poly(hydroxyamino ethers) having repeating units represented by Formula VIII: 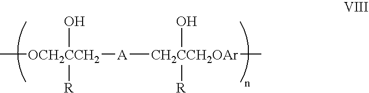
wherein each Ar individually represents a divalent aromatic moiety, substituted divalent aromatic moiety or heteroaromatic moiety, or a combination of different divalent aromatic moieties, substituted aromatic moieties or heteroaromatic moieties; R is individually hydrogen or a monovalent hydrocarbyl moiety; each Ar₁ is a divalent aromatic moiety or combination of divalent aromatic moieties bearing amide or hydroxymethyl groups; each Ar₂ is the same or different than Ar and is individually a divalent aromatic moiety, substituted aromatic moiety or heteroaromatic moiety or a combination of different divalent aromatic moieties, substituted aromatic moieties or heteroaromatic moieties; R₁ is individually a predominantly hydrocarbylene moiety, such as a divalent aromatic moiety, substituted divalent aromatic moiety, divalent heteroaromatic moiety, divalent alkylene moiety, divalent substituted alkylene moiety or divalent heteroalkylene moiety or a combination of such moieties; R₂ is individually a monovalent hydrocarbyl moiety; A is an amine moiety or a combination of different amine moieties; X is an amine, an arylenedioxy, an arylenedisulfonamido or an arylenedicarboxy moiety or combination of such moieties; and Ar₃ is a “cardo” moiety represented by any one of the Formulae:

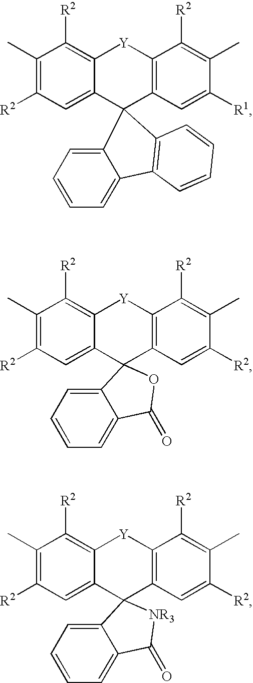

wherein Y is nil, a covalent bond, or a linking group, wherein suitable linking groups include, for example, an oxygen atom, a sulfur atom, a carbonyl atom, a sulfonyl group, or a methylene group or similar linkage; n is an integer from about 10 to about 1000; x is 0.01 to 1.0; and y is 0 to 0.5.

The term “predominantly hydrocarbylene” means a divalent radical that is predominantly hydrocarbon, but which optionally contains a small quantity of a heteroatomic moiety such as oxygen, sulfur, imino, sulfonyl, sulfoxyl, and the like.

The hydroxy-functional poly(amide ethers) represented by Formula I are preferably prepared by contacting an N,N′-bis(hydroxyphenylamido)alkane or arene with a diglycidyl ether as described in U.S. Pat. Nos. 5,089,588 and 5,143,998.

The poly(hydroxy amide ethers) represented by Formula II are prepared by contacting a bis(hydroxyphenylamido)alkane or arene, or a combination of 2 or more of these compounds, such as N,N′-bis(3-hydroxyphenyl)adipamide or N,N′-bis(3-hydroxyphenyl)glutaramide, with an epihalohydrin as described in U.S. Pat. No. 5,134,218.

The amide- and hydroxymethyl-functionalized polyethers represented by Formula III can be prepared, for example, by reacting the diglycidyl ethers, such as the diglycidyl ether of bisphenol A, with a dihydric phenol having pendant amido, N-substituted amido and/or hydroxyalkyl moieties, such as 2,2-bis(4-hydroxyphenyl)acetamide and 3,5-dihydroxybenzamide. These polyethers and their preparation are described in U.S. Pat. Nos. 5,115,075 and 5,218,075.

The hydroxy-functional polyethers represented by Formula IV can be prepared, for example, by allowing a diglycidyl ether or combination of diglycidyl ethers to react with a dihydric phenol or a combination of dihydric phenols using the process described in U.S. Pat. No. 5,164,472. Alternatively, the hydroxy-functional polyethers are obtained by allowing a dihydric phenol or combination of dihydric phenols to react with an epihalohydrin by the process described by Reinking, Barnabeo and Hale in the Journal of Applied Polymer Science, Vol. 7, p. 2135 (1963).

The hydroxy-functional poly(ether sulfonamides) represented by Formula V are prepared, for example, by polymerizing an N,N′-dialkyl or N,N′-diaryldisulfonamide with a diglycidyl ether as described in U.S. Pat. No. 5,149,768.

The poly(hydroxy ester ethers) represented by Formula VI are prepared by reacting diglycidyl ethers of aliphatic or aromatic diacids, such as diglycidyl terephthalate, or diglycidyl ethers of dihydric phenols with, aliphatic or aromatic diacids such as adipic acid or isophthalic acid. These polyesters are described in U.S. Pat. No. 5,171,820.

The hydroxy-phenoxyether polymers represented by Formula VII are prepared, for example, by contacting at least one dinucleophilic monomer with at least one diglycidyl ether of a cardo bisphenol, such as 9,9-bis(4-hydroxyphenyl)fluorene, phenolphthalein, or phenolphthalimidine or a substituted cardo bisphenol, such as a substituted bis(hydroxyphenyl)fluorene, a substituted phenolphthalein or a substituted phenolphthalimidine under conditions sufficient to cause the nucleophilic moieties of the dinucleophilic monomer to react with epoxy moieties to form a polymer backbone containing pendant hydroxy moieties and ether, imino, amino, sulfonamido or ester linkages. These hydroxy-phenoxyether polymers are described in U.S. Pat. No. 5,184,373.

The poly(hydroxyamino ethers) (“PHAE” or polyetheramines) represented by Formula VIII are prepared by contacting one or more of the diglycidyl ethers of a dihydric phenol with an amine having two amine hydrogens under conditions sufficient to cause the amine moieties to react with epoxy moieties to form a polymer backbone having amine linkages, ether linkages and pendant hydroxyl moieties. These compounds are described in U.S. Pat. No. 5,275,853. For example, polyhydroxyaminoether copolymers can be made from resorcinol diglycidyl ether, hydroquinone diglycidyl ether, bisphenol A diglycidyl ether, or mixtures thereof.

The hydroxy-phenoxyether polymers are the condensation reaction products of a dihydric polynuclear phenol, such as bisphenol A, and an epihalohydrin and have the repeating units represented by Formula IV wherein Ar is an isopropylidene diphenylene moiety. The process for preparing these is described in U.S. Pat. No. 3,305,528, incorporated herein by reference in its entirety. One preferred non-limiting hydroxy-phenoxyether polymer, PAPHEN 25068-38-6, is commercially available from Phenoxy Associates, Inc. Other preferred phenoxy resins are available from InChem® (Rock Hill, S.C.), these materials include, but are not limited to, the INCHEMREZ™ PKHH and PKHW product lines.

Generally, preferred phenoxy-type materials form stable aqueous based solutions or dispersions. Preferably, the properties of the solutions/dispersions are not adversely affected by contact with water. Preferred materials range from about 10% solids to about 50% solids, including about 15%, 20%, 25%, 30%, 35%, 40% and 45%, and ranges encompassing such percentages. Preferably, the material used dissolves or disperses in polar solvents. These polar solvents include, but are not limited to, water, alcohols, and glycol ethers. See, for example, U.S. Pat. Nos. 6,455,116, 6,180,715, and 5,834,078 which describe some preferred phenoxy-type solutions and/or dispersions.

One preferred phenoxy-type material is a polyhydroxyaminoether copolymer (PHAE), represented by Formula VIII, dispersion or solution. The dispersion or solution, when applied to a container or preform, greatly reduces the permeation rate of a variety of gases through the container walls in a predictable and well known manner. One dispersion or latex made thereof comprises 10-30 percent solids. A PHAE solution/dispersion may be prepared by stirring or otherwise agitating the PHAE in a solution of water with an organic acid, preferably acetic or phosphoric acid, but also including lactic, malic, citric, or glycolic acid and/or mixtures thereof. These PHAE solution/dispersions also include organic acid salts produced by the reaction of the polyhydroxyaminoethers with these acids.

In other preferred embodiments, phenoxy-type thermoplastics are mixed or blended with other materials using methods known to those of skill in the art. In some embodiments a compatibilizer may be added to the blend. When compatibilizers are used, preferably one or more properties of the blends are improved, such properties including, but not limited to, color, haze, and adhesion between a layer comprising a blend and other layers. One preferred blend comprises one or more phenoxy-type thermoplastics and one or more polyolefins. A preferred polyolefin comprises polypropylene. In one embodiment polypropylene or other polyolefins may be grafted or modified with a polar molecule or monomer, including, but not limited to, maleic anhydride, glycidyl methacrylate, acryl methacrylate and/or similar compounds to increase compatibility.

The following PHAE solutions or dispersions are examples of suitable phenoxy-type solutions or dispersions which may be used if one or more layers of resin are applied as a liquid such as by dip, flow, or spray coating, such as described in WO 04/004929 and U.S. Pat. No. 6,676,883. One suitable material is BLOX® experimental barrier resin, for example XU-19061.00 made with phosphoric acid manufactured by Dow Chemical Corporation. This particular PHAE dispersion is said to have the following typical characteristics: 30% percent solids, a specific gravity of 1.30, a pH of 4, a viscosity of 24 centipoise (Brookfield, 60 rpm, LVI, 22° C.), and a particle size of between 1,400 and 1,800 angstroms. Other suitable materials include BLOX® 588-29 resins based on resorcinol have also provided superior results as a barrier material. This particular dispersion is said to have the following typical characteristics: 30% percent solids, a specific gravity of 1.2, a pH of 4.0, a viscosity of 20 centipoise (Brookfield, 60 rpm, LVI, 22° C.), and a particle size of between 1500 and 2000 angstroms. Other variations of the polyhydroxyaminoether chemistry may prove useful such as crystalline versions based on hydroquinone diglycidylethers. Other suitable materials include polyhydroxyaminoether solutions/dispersions by Imperial Chemical Industries (“ICI,” Ohio, USA) available under the name OXYBLOK. In one embodiment, PHAE solutions or dispersions can be crosslinked partially (semi-cross linked), fully, or to the exact desired degree as appropriate for the application by adding an appropriate cross linker material. The benefits of cross linking include, but are not limited to, one or more of the following: improved chemical resistance, improved abrasion resistance, low blushing, low surface tension. Examples of cross linker materials include, but are not limited to, formaldehyde, acetaldehyde or other members of the aldehyde family of materials. Suitable cross linkers can also enable changes to the T_{g} of the material, which can facilitate formation of specific containers. Other suitable materials include BLOX® 5000 resin dispersion intermediate, BLOX® XUR 588-29, BLOX® 0000 and 4000 series resins. The solvents used to dissolve these materials include, but are not limited to, polar solvents such as alcohols, water, glycol ethers or blends thereof. Other suitable materials include, but are not limited to, BLOX® R1.

In one embodiment, preferred phenoxy-type thermoplastics are soluble in aqueous acid. A polymer solution/dispersion may be prepared by stirring or otherwise agitating the thermoplastic epoxy in a solution of water with an organic acid, preferably acetic or phosphoric acid, but also including lactic, malic, citric, or glycolic acid and/or mixtures thereof. In a preferred embodiment, the acid concentration in the polymer solution is preferably in the range of about 5%-20%, including about 5%-10% by weight based on total weight. In other preferred embodiments, the acid concentration may be below about 5% or above about 20%; and may vary depending on factors such as the type of polymer and its molecular weight. In other preferred embodiments, the acid concentration ranges from about 2.5 to about 5% by weight. The amount of dissolved polymer in a preferred embodiment ranges from about 0.1% to about 40%. A uniform and free flowing polymer solution is preferred. In one embodiment a 10% polymer solution is prepared by dissolving the polymer in a 10% acetic acid solution at 90° C. Then while still hot the solution is diluted with 20% distilled water to give an 8% polymer solution. At higher concentrations of polymer, the polymer solution tends to be more viscous.

Examples of preferred copolyester materials and a process for their preparation is described in U.S. Pat. No. 4,578,295 to Jabarin. They are generally prepared by heating a mixture of at least one reactant selected from isophthalic acid, terephthalic acid and their C₁ to C₄ alkyl esters with 1,3 bis(2-hydroxyethoxy)benzene and ethylene glycol. Optionally, the mixture may further comprise one or more ester-forming dihydroxy hydrocarbon and/or bis(4-β-hydroxyethoxyphenyl)sulfone. Especially preferred copolyester materials are available from Mitsui Petrochemical Ind. Ltd. (Japan) as B-010, B-030 and others of this family.

Examples of preferred polyamide materials include MXD-6 from Mitsubishi Gas Chemical (Japan). Other preferred polyamide materials include Nylon 6, and Nylon 66. Other preferred polyamide materials are blends of polyamide and polyester, including those comprising about 1-20% polyester by weight, more preferably about 1-10% polyester by weight, where the polyester is preferably PET or a modified PET. In another embodiment, preferred polyamide materials are blends of polyamide and polyester, including those comprising about 1-20% polyamide by weight, more preferably about 1-10% polyamide by weight, where the polyester is preferably PET or a modified PET. The blends may be ordinary blends or they may be compatibilized with an antioxidant or other material. Examples of such materials include those described in U.S. patent Publication No. 2004/0013833, filed Mar. 21, 2003, which is hereby incorporated by reference in its entirety. Other preferred polyesters include, but are not limited to, PEN and PET/PEN copolymers.

3. Preferred Foam Materials

As used herein, the term “foam material” is a broad term and is used in accordance with its ordinary meaning and may include, without limitation, a foaming agent, a mixture of foaming agent and a binder or carrier material, an expandable cellular material, and/or a material having voids. The terms “foam material” and “expandable material” are used interchangeably herein. Preferred foam materials may exhibit one or more physical characteristics that improve the thermal and/or structural characteristics of articles (e.g., containers) and may enable the preferred embodiments to be able to withstand processing and physical stresses typically experienced by containers. In one embodiment, the foam material provides structural support to the container. In another embodiment, the foam material forms a protective layer that can reduce damage to the container during processing. For example, the foam material can provide abrasion resistance which can reduce damage to the container during transport. In one embodiment, a protective layer of foam may increase the shock or impact resistance of the container and thus prevent or reduce breakage of the container. Furthermore, in another embodiment foam can provide a comfortable gripping surface and/or enhance the aesthetics or appeal of the container.

In one embodiment, foam material comprises a foaming or blowing agent and a carrier material. In one preferred embodiment, the foaming agent comprises expandable structures (e.g., microspheres) that can be expanded and cooperate with the carrier material to produce foam. For example, the foaming agent can be thermoplastic microspheres, such as EXPANCEL® microspheres sold by Akzo Nobel. In one embodiment, microspheres can be thermoplastic hollow spheres comprising thermoplastic shells that encapsulate gas. Preferably, when the microspheres are heated, the thermoplastic shell softens and the gas increases its pressure causing the expansion of the microspheres from an initial position to an expanded position. The expanded microspheres and at least a portion of the carrier material can form the foam portion of the articles described herein. The foam material can form a layer that comprises a single material (e.g., a generally homogenous mixture of the foaming agent and the carrier material), a mix or blend of materials, a matrix formed of two or more materials, two or more layers, or a plurality of microlayers (lamellae) preferably including at least two different materials. Alternatively, the microspheres can be any other suitable controllably expandable material. For example, the microspheres can be structures comprising materials that can produce gas within or from the structures. In one embodiment, the microspheres are hollow structures containing chemicals which produce or contain gas wherein an increase in gas pressure causes the structures to expand and/or burst. In another embodiment, the microspheres are structures made from and/or containing one or more materials which decompose or react to produce gas thereby expanding and/or bursting the microspheres. Optionally, the microsphere may be generally solid structures. Optionally, the microspheres can be shells filled with solids, liquids, and/or gases. The microspheres can have any configuration and shape suitable for forming foam. For example, the microspheres can be generally spherical. Optionally, the microspheres can be elongated or oblique spheroids. Optionally, the microspheres can comprise any gas or blends of gases suitable for expanding the microspheres. In one embodiment, the gas can comprise an inert gas, such as nitrogen. In one embodiment, the gas is generally non-flammable. However, in certain embodiments non-inert gas and/or flammable gas can fill the shells of the microspheres. In some embodiments, the foam material may comprise foaming or blowing agents as are known in the art. Additionally, the foam material may be mostly or entirely foaming agent.

Although some preferred embodiments contain microspheres that generally do not break or burst, other embodiments comprise microspheres that may break, burst, fracture, and/or the like. Optionally, a portion of the microspheres may break while the remaining portion of the microspheres does not break. In some embodiments up to about 0.5%, 1%, 2%, 3%, 4%, 5%, 10%, 20%, 30%, 40%, 50%, 60% 70%, 80%, 90% by weight of microspheres, and ranges encompassing these amounts, break. In one embodiment, for example, a substantial portion of the microspheres may burst and/or fracture when they are expanded. Additionally, various blends and mixtures of microspheres can be used to form foam material.

The microspheres can be formed of any material suitable for causing expansion. In one embodiment, the microspheres can have a shell comprising a polymer, resin, thermoplastic, thermoset, or the like as described herein. The microsphere shell may comprise a single material or a blend of two or more different materials. For example, the microspheres can have an outer shell comprising ethylene vinyl acetate (“EVA”), polyethylene terephthalate (“PET”), polyamides (e.g. Nylon 6 and Nylon 66) polyethylene terephthalate glycol (PETG), PEN, PET copolymers, and combinations thereof. In one embodiment a PET copolymer comprises CHDM comonomer at a level between what is commonly called PETG and PET. In another embodiment, comonomers such as DEG and IPA are added to PET to form miscrosphere shells. The appropriate combination of material type, size, and inner gas can be selected to achieve the desired expansion of the microspheres. In one embodiment, the microspheres comprise shells formed of a high temperature material (e.g., PETG or similar material) that is capable of expanding when subject to high temperatures, preferably without causing the microspheres to burst. If the microspheres have a shell made of low temperature material (e.g., as EVA), the microspheres may break when subjected to high temperatures that are suitable for processing certain carrier materials (e.g., PET or polypropylene having a high melt point). In some circumstances, for example, EXPANCEL® microspheres may be break when processed at relatively high temperatures. Advantageously, mid or high temperature microspheres can be used with a carrier material having a relatively high melt point to produce controllably, expandable foam material without breaking the microspheres. For example, microspheres can comprise a mid temperature material (e.g., PETG) or a high temperature material (e.g., acrylonitrile) and may be suitable for relatively high temperature applications. Thus, a blowing agent for foaming polymers can be selected based on the processing temperatures employed.

The foam material can be a matrix comprising a carrier material, preferably a material that can be mixed with a blowing agent (e.g., microspheres) to form an expandable material. The carrier material can be a thermoplastic, thermoset, or polymeric material, such as ethylene acrylic acid (“EAA”), ethylene vinyl acetate (“EVA”), linear low density polyethylene (“LLDPE”), polyethylene terephthalate glycol (PETG), poly(hydroxyamino ethers) (“PHAE”), PET, polyethylene, polypropylene, polystyrene (“PS”), pulp (e.g., wood or paper pulp of fibers, or pulp mixed with one or more polymers), mixtures thereof, and the like. However, other materials suitable for carrying the foaming agent can be used to achieve one or more of the desired thermal, structural, optical, and/or other characteristics of the foam. In some embodiments, the carrier material has properties (e.g., a high melt index) for easier and rapid expansion of the microspheres, thus reducing cycle time thereby resulting in increased production.

In preferred embodiments, the formable material may comprise two or more components including a plurality of components each having different processing windows and/or physical properties. The components can be combined such that the formable material has one or more desired characteristics. The proportion of components can be varied to produce a desired processing window and/or physical properties. For example, the first material may have a processing window that is similar to or different than the processing window of the second material. The processing window may be based on, for example, pressure, temperature, viscosity, or the like. Thus, components of the formable material can be mixed to achieve a desired, for example, pressure or temperature range for shaping the material.

In one embodiment, the combination of a first material and a second material may result in a material having a processing window that is more desirable than the processing window of the second material. For example, the first material may be suitable for processing over a wide range of temperatures, and the second material may be suitable for processing over a narrow range of temperatures. A material having a portion formed of the first material and another portion formed of the second material may be suitable for processing over a range of temperatures that is wider than the narrow range of processing temperatures of the second material. In one embodiment, the processing window of a multi-component material is similar to the processing window of the first material. In one embodiment, the formable material comprises a multilayer sheet or tube comprising a layer comprising PET and a layer comprising polypropylene. The material formed from both PET and polypropylene can be processed (e.g., extruded) within a wide temperature range similar to the processing temperature range suitable for PET. The processing window may be for one or more parameters, such as pressure, temperature, viscosity, and/or the like.

Optionally, the amount of each component of the material can be varied to achieve the desired processing window. Optionally, the materials can be combined to produce a formable material suitable for processing over a desired range of pressure, temperature, viscosity, and/or the like. For example, the proportion of the material having a more desirable processing window can be increased and the proportion of material having a less undesirable processing window can be decreased to result in a material having a processing window that is very similar to or is substantially the same as the processing window of the first material. Of course, if the more desired processing window is between a first processing window of a first material and the second processing window of a second material, the proportion of the first and the second material can be chosen to achieve a desired processing window of the formable material.

Optionally, a plurality of materials each having similar or different processing windows can be combined to obtain a desired processing window for the resultant material.

In one embodiment, the rheological characteristics of a formable material can be altered by varying one or more of its components having different rheological characteristics. For example, a substrate (e.g., PP) may have a high melt strength and is amenable to extrusion. PP can be combined with another material, such as PET which has a low melt strength making it difficult to extrude, to form a material suitable for extrusion processes. For example, a layer of PP or other strong material may support a layer of PET during co-extrusion (e.g., horizontal or vertical co-extrusion). Thus, formable material formed of PET and polypropylene can be processed, e.g., extruded, in a temperature range generally suitable for PP and not generally suitable for PET.

In some embodiments, the composition of the formable material may be selected to affect one or more properties of the articles. For example, the thermal properties, structural properties, barrier properties, optical properties, rheology properties, favorable flavor properties, and/or other properties or characteristics disclosed herein can be obtained by using formable materials described herein.

4. Additives to Enhance Materials

An advantage of preferred methods disclosed herein are their flexibility allowing for the use of multiple functional additives. Additives known by those of ordinary skill in the art for their ability to provide enhanced CO₂ barriers, O₂ barriers, UV protection, scuff resistance, blush resistance, impact resistance and/or chemical resistance may be used.

Preferred additives may be prepared by methods known to those of skill in the art. For example, the additives may be mixed directly with a particular material, they may be dissolved/dispersed separately and then added to a particular material, or they may be combined with a particular material to addition of the solvent that forms the material solution/dispersion. In addition, in some embodiments, preferred additives may be used alone as a single layer.

In preferred embodiments, the barrier properties of a layer may be enhanced by the addition of different additives. Additives are preferably present in an amount up to about 40% of the material, also including up to about 30%, 20%, 10%, 5%, 2% and 1% by weight of the material. In other embodiments, additives are preferably present in an amount less than or equal to 1% by weight, preferred ranges of materials include, but are not limited to, about 0.01% to about 1%, about 0.01% to about 0.1%, and about 0.1% to about 1% by weight. Further, in some embodiments additives are preferably stable in aqueous conditions. For example, derivatives of resorcinol (m-dihydroxybenzene) may be used in conjunction with various preferred materials as blends or as additives or monomers in the formation of the material. The higher the resorcinol content the greater the barrier properties of the material. For example, resorcinol diglycidyl ether can be used in PHAE and hydroxyethyl ether resorcinol can be used in PET and other polyesters and Copolyester Barrier Materials.

Another additive that may be used are “nanoparticles” or “nanoparticulate material.” For convenience the term nanoparticles will be used herein to refer to both nanoparticles and nanoparticulate material. These nanoparticles are tiny, micron or sub-micron size (diameter), particles of materials which enhance the barrier properties of a material by creating a more tortuous path for migrating gas molecules, e.g. oxygen or carbon dioxide, to take as they permeate a material. In preferred embodiments nanoparticulate material is present in amounts ranging from 0.05 to 1% by weight, including 0.1%, 0.5% by weight and ranges encompassing these amounts.

One preferred type of nanoparticulate material is a microparticular clay based product available from Southern Clay Products. One preferred line of products available from Southern Clay products is Cloisite® nanoparticles. In one embodiment preferred nanoparticles comprise monmorillonite modified with a quaternary ammonium salt. In other embodiments nanoparticles comprise monmorillonite modified with a ternary ammonium salt. In other embodiments nanoparticles comprise natural monmorillonite. In further embodiments, nanoparticles comprise organoclays as described in U.S. Pat. No. 5,780,376, the entire disclosure of which is hereby incorporated by reference and forms part of the disclosure of this application. Other suitable organic and inorganic microparticular clay based products may also be used. Both man-made and natural products are also suitable.

Another type of preferred nanoparticulate material comprises a composite material of a metal. For example, one suitable composite is a water based dispersion of aluminum oxide in nanoparticulate form available from BYK Chemie (Germany). It is believed that this type of nanoparticular material may provide one or more of the following advantages: increased abrasion resistance, increased scratch resistance, increased T_{g}, and thermal stability.

Another type of preferred nanoparticulate material comprises a polymer-silicate composite. In preferred embodiments the silicate comprises montmorillonite. Suitable polymer-silicate nanoparticulate material are available from Nanocor and RTP Company.

In preferred embodiments, the UV protection properties of the material may be enhanced by the addition of different additives. In a preferred embodiment, the UV protection material used provides UV protection up to about 350 nm or less, preferably about 370 nm or less, more preferably about 400 nm or less. The UV protection material may be used as an additive with layers providing additional functionality or applied separately as a single layer. Preferably additives providing enhanced UV protection are present in the material from about 0.05 to 20% by weight, but also including about 0.1%, 0.5%, 1%, 2%, 3%, 5%, 10%, and 15% by weight, and ranges encompassing these amounts. Preferably the UV protection material is added in a form that is compatible with the other materials. For example, a preferred UV protection material is Milliken UV390A ClearShield®. UV390A is an oily liquid for which mixing is aided by first blending the liquid with water, preferably in roughly equal parts by volume. This blend is then added to the material solution, for example, BLOX® 599-29, and agitated. The resulting solution contains about 10% UV390A and provides UV protection up to 390 nm when applied to a PET preform. As previously described, in another embodiment the UV390A solution is applied as a single layer. In other embodiments, a preferred UV protection material comprises a polymer grafted or modified with a UV absorber that is added as a concentrate. Other preferred UV protection materials include, but are not limited to, benzotriazoles, phenothiazines, and azaphenothiazines. UV protection materials may be added during the melt phase process prior to use, e.g. prior to injection molding or extrusion, or added directly to a coating material that is in the form of a solution or dispersion. Suitable UV protection materials are available from Milliken, Ciba and Clariant.

In preferred embodiments, CO₂ scavenging properties can be added to the materials. In one preferred embodiment such properties are achieved by including an active amine which will react with CO₂ forming a high gas barrier salt. This salt will then act as a passive CO₂ barrier. The active amine may be an additive or it may be one or more moieties in the thermoplastic resin material of one or more layers.

In preferred embodiments, O₂ scavenging properties can be added to preferred materials by including O₂ scavengers such as anthroquinone and others known in the art. In another embodiment, one suitable O₂ scavenger is AMOSORB® O₂ scavenger available from BP Amoco Corporation and ColorMatrix Corporation which is disclosed in U.S. Pat. No. 6,083,585 to Cahill et al., the disclosure of which is hereby incorporated in its entirety. In one embodiment, O₂ scavenging properties are added to preferred phenoxy-type materials, or other materials, by including O₂ scavengers in the phenoxy-type material, with different activating mechanisms. Preferred O₂ scavengers can act either spontaneously, gradually or with delayed action until initiated by a specific trigger. In some embodiments the O₂ scavengers are activated via exposure to either UV or water (e.g., present in the contents of the container), or a combination of both. The O₂ scavenger is preferably present in an amount of from about 0.1 to about 20 percent by weight, more preferably in an amount of from about 0.5 to about 10 percent by weight, and, most preferably, in an amount of from about 1 to about 5 percent by weight, based on the total weight of the coating layer.

In another preferred embodiment, a top coat or layer is applied to provide chemical resistance to harsher chemicals than what is provided by the outer layer. In certain embodiments, preferably these top coats or layers are aqueous based or non-aqueous based polyesters or acrylics which are optionally partially or fully cross linked. A preferred aqueous based polyester is polyethylene terephthalate, however other polyesters may also be used. In certain embodiments, the process of applying the top coat or layer is that disclosed in U.S. patent Pub. No. 2004/0071885, entitled Dip, Spray, And Flow Coating Process For Forming Coated Articles, the entire disclosure of which is hereby incorporated by reference in its entirety.

A preferred aqueous based polyester resin is described in U.S. Pat. No. 4,977,191 (Salsman), incorporated herein by reference. More specifically, U.S. Pat. No. 4,977,191 describes an aqueous based polyester resin, comprising a reaction product of 20-50% by weight of waste terephthalate polymer, 10-40% by weight of at least one glycol an 5-25% by weight of at least one oxyalkylated polyol.

Another preferred aqueous based polymer is a sulfonated aqueous based polyester resin composition as described in U.S. Pat. No. 5,281,630 (Salsman), herein incorporated by reference. Specifically, U.S. Pat. No. 5,281,630 describes an aqueous suspension of a sulfonated water-soluble or water dispersible polyester resin comprising a reaction product of 20-50% by weight terephthalate polymer, 10-40% by weight at least one glycol and 5-25% by weight of at least one oxyalkylated polyol to produce a prepolymer resin having hydroxyalkyl functionality where the prepolymer resin is further reacted with about 0.10 mole to about 0.50 mole of alpha, beta-ethylenically unsaturated dicarboxylic acid per 100 g of prepolymer resin and a thus produced resin, terminated by a residue of an alpha, beta-ethylenically unsaturated dicarboxylic acid, is reacted with about 0.5 mole to about 1.5 mole of a sulfite per mole of alpha, beta-ethylenically unsaturated dicarboxylic acid residue to produce a sulfonated-terminated resin.

Yet another preferred aqueous based polymer is the coating described in U.S. Pat. No. 5,726,277 (Salsman), incorporated herein by reference. Specifically, U.S. Pat. No. 5,726,277 describes coating compositions comprising a reaction product of at least 50% by weight of waste terephthalate polymer and a mixture of glycols including an oxyalkylated polyol in the presence of a glycolysis catalyst wherein the reaction product is further reacted with a difunctional, organic acid and wherein the weight ratio of acid to glycols in is the range of 6:1 to 1:2.

While the above examples are provided as preferred aqueous based polymer coating compositions, other aqueous based polymers are suitable for use in the products and methods describe herein. By way of example only, and not meant to be limiting, further suitable aqueous based compositions are described in U.S. Pat. No. 4,104,222 (Date, et al.), incorporated herein by reference. U.S. Pat. No. 4,104,222 describes a dispersion of a linear polyester resin obtained by mixing a linear polyester resin with a higher alcohol/ethylene oxide addition type surface-active agent, melting the mixture and dispersing the resulting melt by pouring it into an aqueous solution of an alkali under stirring Specifically, this dispersion is obtained by mixing a linear polyester resin with a surface-active agent of the higher alcohol/ethylene oxide addition type, melting the mixture, and dispersing the resulting melt by pouring it into an aqueous solution of an alkanolamine under stirring at a temperature of 70-95° C., said alkanolamine being selected from the group consisting of monoethanolamine, diethanolamine, triethanolamine, monomethylethanolamine, monoethylethanolamine, diethylethanolamine, propanolamine, butanolamine, pentanolamine, N-phenylethanolamine, and an alkanolamine of glycerin, said alkanolamine being present in the aqueous solution in an amount of 0.2 to 5 weight percent, said surface-active agent of the higher alcohol/ethylene oxide addition type being an ethylene oxide addition product of a higher alcohol having an alkyl group of at least 8 carbon atoms, an alkyl-substituted phenol or a sorbitan monoacylate and wherein said surface-active agent has an HLB value of at least 12.

Likewise, by example, U.S. Pat. No. 4,528,321 (Allen) discloses a dispersion in a water immiscible liquid of water soluble or water swellable polymer particles and which has been made by reverse phase polymerization in the water immiscible liquid and which includes a non-ionic compound selected from C₄₋₁₂ alkylene glycol monoethers, their C₁₋₄ alkanoates, C₆₋₁₂ polyakylene glycol monoethers and their C₁₋₄ alkanoates.

The materials of certain embodiments may be cross-linked to enhance thermal stability for various applications, for example hot fill applications. In one embodiment, inner layers may comprise low-cross linking materials while outer layers may comprise high crosslinking materials or other suitable combinations. For example, an inner coating on a PET surface may utilize non or low cross-linked material, such as the BLOX® 588-29, and the outer coat may utilize another material, such as EXP 12468-4B from ICI, capable of cross linking to ensure maximum adhesion to the PET. Suitable additives capable of cross linking may be added to one or more layers. Suitable cross linkers can be chosen depending upon the chemistry and functionality of the resin or material to which they are added. For example, amine cross linkers may be useful for crosslinking resins comprising epoxide groups. Preferably cross linking additives, if present, are present in an amount of about 1% to 10% by weight of the coating solution/dispersion, preferably about 1% to 5%, more preferably about 0.01% to 0.1% by weight, also including 2%, 3%, 4%, 6%, 7%, 8%, and 9% by weight. Optionally, a thermoplastic epoxy (TPE) can be used with one or more crosslinking agents. In some embodiments, agents (e.g. carbon black) may also be coated onto or incorporated into the TPE material. The TPE material can form part of the articles disclosed herein. It is contemplated that carbon black or similar additives can be employed in other polymers to enhance material properties.

The materials of certain embodiments may optionally comprise a curing enhancer. As used herein, the term “curing enhancer” is a broad term and is used in its ordinary meaning and includes, without limitation, chemical cross-linking catalyst, thermal enhancer, and the like. As used herein, the term “thermal enhancer” is a broad term and is used in its ordinary meaning and includes, without limitation, transition metals, transition metal compounds, radiation absorbing additives (e.g., carbon black). Suitable transition metals include, but are not limited to, cobalt, rhodium, and copper. Suitable transition metal compounds include, but are not limited to, metal carboxylates. Preferred carboxylates include, but are not limited to, neodecanoate, octoate, and acetate. Thermal enhancers may be used alone or in combination with one or more other thermal enhancers.

The thermal enhancer can be added to a material and may significantly increase the temperature of the material during a curing process, as compared to the material without the thermal enhancer. For example, in some embodiments, the thermal enhancer (e.g., carbon black) can be added to a polymer so that the temperature of the polymer subjected to a curing process (e.g., IR radiation) is significantly greater than the polymer without the thermal enhancer subject to the same or similar curing process. The increased temperature of the polymer caused by the thermal enhancer can increase the rate of curing and therefore increase production rates. In some embodiments, the thermal enhancer generally has a higher temperature than at least one of the layers of an article when the thermal enhancer and the article are heated with a heating device (e.g., infrared heating device).

In some embodiments, the thermal enhancer is present in an amount of about 5 to 800 ppm, preferably about 20 to about 150 ppm, preferably about 50 to 125 ppm, preferably about 75 to 100 ppm, also including about 10, 20, 30, 40, 50, 75, 100, 125, 150, 175, 200, 300, 400, 500, 600, and 700 ppm and ranges encompassing these amounts. The amount of thermal enhancer may be calculated based on the weight of layer which comprises the thermal enhancer or the total weight of all layers comprising the article.

In some embodiments, a preferred thermal enhancer comprises carbon black. In one embodiment, carbon black can be applied as a component of a coating material in order to enhance the curing of the coating material. When used as a component of a coating material, carbon black is added to one or more of the coating materials before, during, and/or after the coating material is applied (e.g., impregnated, coated, etc.) to the article. Preferably carbon black is added to the coating material and agitated to ensure thorough mixing. The thermal enhancer may comprise additional materials to achieve the desire material properties of the article.

In another embodiment wherein carbon black is used in an injection molding process, the carbon black may be added to the polymer blend in the melt phase process.

In some embodiments, the polymer comprises about 5 to 800 ppm, preferably about 20 to about 150 ppm, preferably about 50 to 125 ppm, preferably about 75 to 100 ppm, also including about 10, 20, 30, 40, 50, 75, 100, 125, 150, 175, 200, 300, 400, 500, 600, and 700 ppm thermal enhancer and ranges encompassing these amounts. In a further embodiment, the coating material is cured using radiation, such as infrared (IR) heating. In preferred embodiments, the IR heating provides a more effective coating than curing using other methods. Other thermal and curing enhancers and methods of using same are disclosed in U.S. patent application Ser. No. 10/983,150, filed Nov. 5, 2004, entitled “Catalyzed Process for Forming Coated Articles,” the disclosure of which is hereby incorporated by reference it its entirety.

In some embodiments the addition of anti-foam/bubble agents is desirable. In some embodiments utilizing solutions or dispersion the solutions or dispersions form foam and/or bubbles which can interfere with preferred processes. One way to avoid this interference, is to add anti-foam/bubble agents to the solution/dispersion. Suitable anti-foam agents include, but are not limited to, nonionic surfactants, alkylene oxide based materials, siloxane based materials, and ionic surfactants. Preferably anti-foam agents, if present, are present in an amount of about 0.01% to about 0.3% of the solution/dispersion, preferably about 0.01% to about 0.2%, but also including about 0.02%, 0.03%, 0.04%, 0.05%, 0.06%, 0.07%, 0.08%, 0.09%, 0.1%, 0.25%, and ranges encompassing these amounts.

In another embodiment foaming agents may be added to the coating materials in order to foam the coating layer. In a further embodiment a reaction product of a foaming agent is used. Useful foaming agents include, but are not limited to azobisformamide, azobisisobutyronitrile, diazoaminobenzene, N,N-dimethyl-N,N-dinitroso terephthalamide, N,N-dinitrosopentamethylene-tetramine, benzenesulfonyl-hydrazide, benzene-1,3-disulfonyl hydrazide, diphenylsulfon-3-3, disulfonyl hydrazide, 4,4′-oxybis benzene sulfonyl hydrazide, p-toluene sulfonyl semicarbizide, barium azodicarboxylate, butylamine nitrile, nitroureas, trihydrazino triazine, phenyl-methyl-urethane, p-sulfonhydrazide, peroxides, ammonium bicarbonate, and sodium bicarbonate. As presently contemplated, commercially available foaming agents include, but are not limited to, EXPANCEL®, CELOGEN®, HYDROCEROL®, MIKROFINE®, CEL-SPAN®, and PLASTRON® FOAM.

The foaming agent is preferably present in the coating material in an amount from about 1 up to about 20 percent by weight, more preferably from about 1 to about 10 percent by weight, and, most preferably, from about 1 to about 5 percent by weight, based on the weight of the coating layer. Newer foaming technologies known to those of skill in the art using compressed gas could also be used as an alternate means to generate foam in place of conventional blowing agents listed above.

The tie-layer is preferably a polymer having functional groups, such as anhydrides and epoxies that react with the carboxyl and/or hydroxyl groups on the PET polymer chains. Useful tie-layer materials include, but are not limited to, DuPont BYNEL®, Mitsui ADMER®, Eastman's EPOLINE, Arkema's LOTADER and ExxonMobil's EVELOY®.

D. Methods and Systems for Making Lamellar Material

A multi component layer or article can also be made from a lamellar meltstream that preferably comprises at least two components. A lamellar meltstream, as that term is used herein, includes without limitation, a meltstream comprising at least two layers in which the layers in the meltstream are generally parallel. Although a lamellar meltstream may have as few as two layers, a lamellar meltstream may comprise, and preferably comprises, a plurality of thin layers. Where the lamellar meltstream is made from two materials, the meltstream is preferably comprised of generally alternating thin layers of the two materials. The materials used to form the lamellar meltstream are preferably polymers, such as thermoplastics, including polyester, polyolefin, phenoxy-type materials and other materials as described herein. The layer materials may also include blends of two or more materials. The layer materials may also incorporate additives such as nanoparticles, oxygen scavengers, UV absorbers, compatibilizers, and the like. In one embodiment, the lamellar meltstream comprises recycled polyester such as recycled PET and a barrier material.

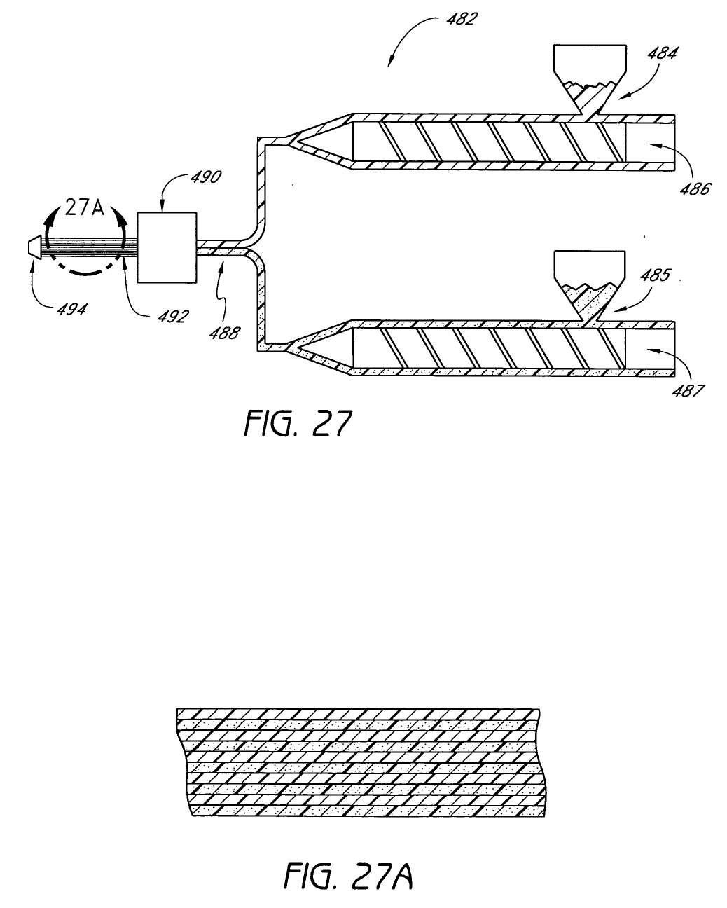

One method of forming a lamellar meltstream uses a system similar to that disclosed in several patents to Schrenk, U.S. Pat. Nos. 5,202,074, 5,540,878, and 5,628,950, the disclosures of which are hereby incorporated in their entireties by reference, although the use of that method as well as other methods for obtaining lamellar meltstreams are presently contemplated. Referring to FIG. 27, a schematic of an embodiment of a lamellar meltstream generation system 482 is shown. The system in FIG. 27 illustrates one embodiment of a two material system, but it will be understood that a system for three or more materials will operate in a similar fashion. The two materials which are to form the layers are placed in separate hoppers or inlets 484 and 485, which feed two separate extruders, 486 and 487 respectively. In a preferred embodiment, the extruders 486 and 487 are screw-type extruders that can apply a combination of heat and pressure to turn raw materials into a melt. The materials are extruded at rates and thicknesses to provide the desired relative amounts of each material and the meltstreams of the extruders combined to form a two layer meltstream 488 comprised of a layer from each cylinder preferably arranged so that one layer lies on top of the other layer

The two layer meltstream 488 output from combined cylinders is then preferably applied to a layer multiplication system 490. In the illustrated layer multiplication system 490, the two layer meltstream 488 is multiplied into a multi-layer meltstream 492, which has 10 layers in the illustrated embodiment as shown in FIG. 27A. The illustration in FIG. 27A is schematic and somewhat idealistic in that although the layers of the lamellar material on average are preferably generally parallel to each other, the lamellar material may include layers that are not parallel to each other and/or layers may be generally parallel at some points and not parallel at others.

Layer multiplication may be done by any of a number of ways. In one embodiment, one first divides a section of meltstream into two pieces perpendicular to the interface of the two layers. Then the two pieces are flattened so that each of the two pieces is about as long as the original section before it was halved in the first step, but only half as thick as the original section. Then the two pieces are recombined into one piece having similar dimensions as the original section, but having four layers, by stacking one piece on top of the other piece so that the sublayers of the two materials are parallel to each other (i.e. stacking in a direction perpendicular to the layers of the meltstream). These steps of dividing, flattening, and recombining the meltstream may be done several times to create more thinner layers. The meltstream may be multiplied by performing the dividing, flattening and recombining a number of times to produce a single melt stream consisting of a plurality of sublayers of the component materials. In this two material embodiment, the composition of the layers will alternate between the two materials. Other methods of layer generation include performing steps similar to those outlined above, but flattening the meltstream prior to dividing or following recombination. Alternatively, in any of these embodiments one may fold the meltstream back onto itself rather than dividing it into sections. Combinations of dividing and folding may also be used, but it is noted that folding and dividing will achieve slightly different results because folding will cause one layer to be doubled back upon itself. The output from the layer multiplication system passes out an opening 494 such as a nozzle or valve, and is used to form an article or a multi-component layer in an article, such as by injecting or placing the lamellar meltstream into a mold.

In the illustrated two-material embodiment, the composition of the layers generally alternates between the two materials. However, in other embodiments any suitable number of materials can be combined into a component meltstream and then fed to layer multiplication system 490 which can produce a lamellar meltstream with any desired number and/or size of repeating blocks or stacks of materials. For example, in one embodiment, the system 482 comprises three extruders that simultaneously deliver material to the layer multiplication system 490. The layer multiplication system 490 can form a stack of layers formed of the three materials.

When a lamellar meltstream includes one or more materials which provide gas barrier properties, it is preferred that the lamellar meltstream be used in a manner which orients it such that the layers of the meltstream are generally parallel to one or more broad surfaces of the article. For example, in a preform or container, the layers are preferably generally parallel to the length of the wall section or body portion. Although parallel is preferred, other orientations may be used and are within the scope of this disclosure. For example, one or more portions of the wall of a container can have layers that are parallel to each other and the surface of the wall while one or more other portions have layers that are not parallel to each other. The desired tortuous path through the wall of a container is determined by the orientation and configuration of the layers of which form the container. For example, layers that are generally parallel to each other and the wall section can increase substantially the length of the path through the wall to be traversed by a gas molecule. Alternatively, layers that are generally parallel to each other and transverse to the wall result in a shorter or reduced tortuous fluid path through the wall and would thus have lower barrier properties than the same meltstream oriented in a parallel fashion.

The articles, such as containers and preforms disclosed herein can be formed using a lamellar meltstream output from a system such as the one illustrated. In some embodiments, the lamellar melt comprises materials that have generally similar melt temperatures, Tₘ, for convenient processing and molding. However, the lamellar melt may comprise materials that have substantially different Tₘs. For example, the lamellar material can comprise materials which have Tₘs within a range of about 500° F. The materials of the lamellar material can be selected based on the material's thermal properties, structural properties, barrier properties, rheology properties, processing properties, and/or other properties. The lamellar melt can be formed and cooled, preferably before one or more of its components substantially degrade. A skilled artisan can select materials to form the lamellar material to achieve the desired material stability suitable for the processing characteristics and chosen end use.

E. Methods and Apparatuses for Making Preferred Articles

Monolayer and multilayer articles (including packaging such as closures, preforms, containers, bottles) can be formed by a molding process (e.g., compression, injection molding, etc.). One method of producing multi-layered articles is referred to herein generally as overmolding. The name refers to a procedure which uses compression injection molding to mold one or more layers of material over an existing layer, which preferably was itself made by a molding process, such as compression molding. The terms “overinjecting” and “overmolding” are used herein to describe the coating process whereby a layer of material is molded over an existing layer or substrate. The overmolding process can be used to make preforms, containers, closures, and the like.

One overmolding method for making articles involves using a melt source in conjunction with a mold comprising one or more cores (e.g., mandrels) and one or more cavity sections. The melt source delivers a first amount of moldable material (e.g., a molten polymer (i.e., polymer melt)) to the cavity section. A first portion of an article is molded between the core and the cavity section. The first portion (e.g., a substrate layer) remains in the cavity section when the core is pulled out of the cavity section. A second amount of material is then deposited onto the interior of the first portion of the article. A second core is used to mold the second amount of material into a second portion of the article, thus forming a multi-layer article. This process may be referred to as “compress-over-compress.”

In one embodiment of compress-over-compress a melt source deposits a first moldable material into a cavity section. A first portion (e.g., a substrate layer) of articles is molded between a core and the first cavity section. The first layer remains on the core when the core is pulled out of the first cavity section. A second moldable material is then deposited into a second cavity section in order to make an exterior portion of the article. The core and the corresponding first portion are then inserted into the second cavity section. As the core and the first layer are moved into the second cavity section, the second material is molded into a second portion of the article. The core and the accompanying article are then removed from the second cavity section and the article is removed from the core.

Thus, the overmolding method and apparatus can be used to mold inner layers and/or outer layers of articles as desired. The multilayer articles can be containers, preforms, closures, and the like. Additionally, one or more compression systems can be employed to form multilayer articles. Each compression system can be a compression mold having cavity sections and cores that are used to mold a portion of an article. A transport system can transport articles between each pair compression molding systems. Thus, a plurality of compression molding systems can be used for an overmolding process.

In an especially preferred embodiment, the compress-over-compress process is performed while the first portion, e.g. a substrate layer, has not yet fully cooled. The underlying layer may have retained inherent heat from a molding process that formed the underlying layer. In some embodiments, the underlying layer can be at room temperature or any other temperature suitable for overmolding. For example, articles at room temperature can be overmolded with one or more layers of material. These articles may have been stored for an extended period of time before being overmolded.

Molding may be used to place one or more layers of material(s) such as those comprising lamellar material, PP, foam material, PET (including recycled PET, virgin PET), barrier materials, phenoxy type thermoplastics, combinations thereof, and/or other materials described herein over a substrate (e.g., the underlying layer). In some non-limiting exemplary embodiments, the substrate is in the form of a preform, preferably having an interior surface for contacting foodstuff. In some embodiments, the substrate preform comprises PET (such as virgin PET), phenoxy type thermoplastic, combinations thereof, and the like. It is contemplated that other articles can be made by the overmolding process.

Articles made by compression molding may comprise one or more layers or portions having one or more of the following advantageous characteristics: an insulating layer, a barrier layer, a foodstuff contacting layer, a non-flavor scalping layer, a high strength layer, a compliant layer, a tie layer, a gas scavenging layer, a layer or portion suitable for hot fill applications, a layer having a melt strength suitable for extrusion. In one embodiment, the monolayer or multi-layer material comprises one or more of the following materials: PET (including recycled and/or virgin PET), PETG, foam, polypropylene, phenoxy type thermoplastics, polyolefins, phenoxy-polyolefin thermoplastic blends, and/or combinations thereof. For the sake of convenience, articles are described primarily with respect to preforms, containers, and closures.

In some embodiments, articles can comprise expandable materials, for example foam material. Foam material can be prepared by combining a foaming agent and a carrier material. In one embodiment, the carrier material and the foaming agent are co-extruded for a preferably generally homogenous mixture of foam material. The amount of carrier material and the foaming agent can be varied depending on the desired amount of one or more of the following: expansion properties, structural properties, thermal properties, feed pressure, and the like. In some non-limiting embodiments, the foam material comprises less than about 10% by weight, also including less than about 9%, 8%, 7%, 6%, 5%, 4%, 3%, 2%, or 1% by weight, of the foaming agent. In some non-limiting exemplary embodiments, the foam material comprises about 1-6% by weight of the foaming agent. In another non-limiting exemplary embodiment, the foam material comprises about 3-6% by weight of the foaming agent. In another non-limiting exemplary embodiment, the foam material comprises about 2-8% by weight of the foaming agent. It is contemplated that the foam material may comprise any suitable amount of foaming agent including those above and below the particular percentages recited above, depending on the desired properties of the foam material.

In some embodiments, carrier material (e.g., polypropylene pellets) and a foaming agent in the form of microspheres, preferably EXPANCEL® microspheres or a similar material, are fed into a hopper. The carrier material and the microspheres are heated to melt the carrier material for effective mixing of the materials. When the mixture is heated, the microspheres may expand or become enlarged. Preferably, the temperature of the mixture is in a temperature range to not cause full expansion or bursting of a substantial portion of the microspheres. For example, if the temperature of the mixture reaches a sufficiently high temperature, the gas within the microspheres may expand such that microspheres break or collapse. The melted foam material can be co-extruded and is preferably rapidly quenched to limit the amount of expansion of the microspheres.

When the foam material is heated for processing (e.g., extruding, injecting, molding, etc.), the microspheres according to one embodiment may partially expand from their initial generally unexpanded position. When such microspheres are partially expanded, they retain the ability to undergo further expansion to increase the size of the microspheres. Preferably, the pressure and temperature are such that the microspheres are not fully expanded during extrusion in order to allow further expansion of the microspheres during blow molding, for example. Additionally, the pressure of the foam material can be increased to reduce, or substantially prevent, the expansion of the microspheres. Thus, the pressure and the temperature of the foam material can be varied to obtain the desired amount of expansion of the microspheres. The partially expanded microspheres can undergo further expansion when they are reheated (e.g., during the blow molding cycle) as described herein.

It is contemplated that portions of compression molded articles described herein can be modified or prepared by any suitable method, including but not limited to (1) dip or flow coating, (2) spray coating, (3) flame spraying, (4) fluidized bed dipping, (5) electrostatic powder spray, (6) overmolding (e.g., inject-over-inject), (7) injection molding (including co-injection) and/or (8) compression molding. For example, preferred methods and apparatuses for performing the methods are disclosed in U.S. Pat. No. 6,352,426 which is incorporated by reference in its entirety and forms part of the disclosure of this application. It is also contemplated that these methods and apparatuses can be used to form other articles described herein. The preforms disclosed herein can be blow molded using methods and apparatus disclosed in the references (e.g., U.S. Pat. No. 6,352,426) incorporated by reference into the present application.

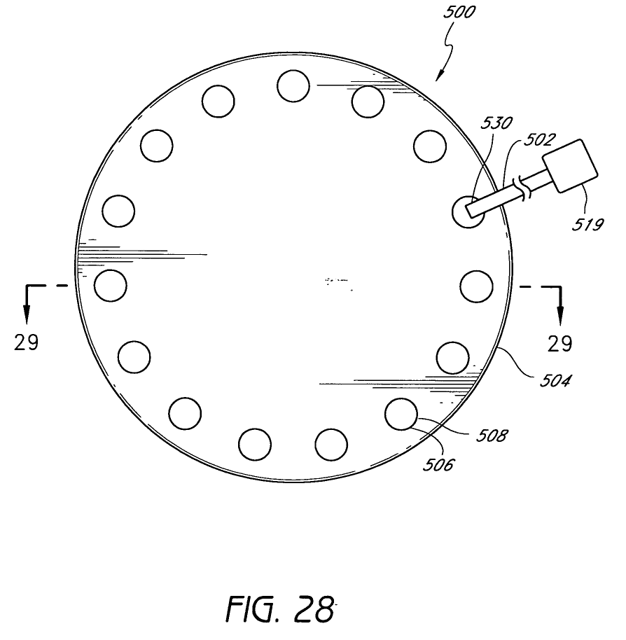

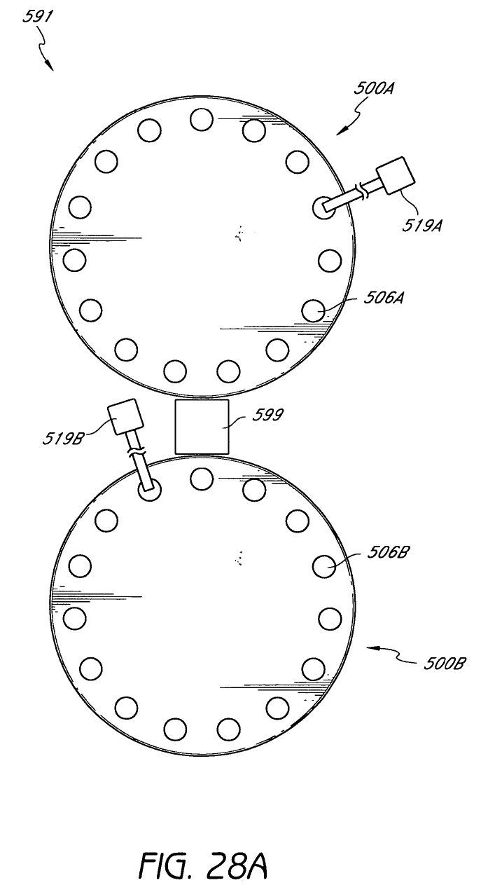

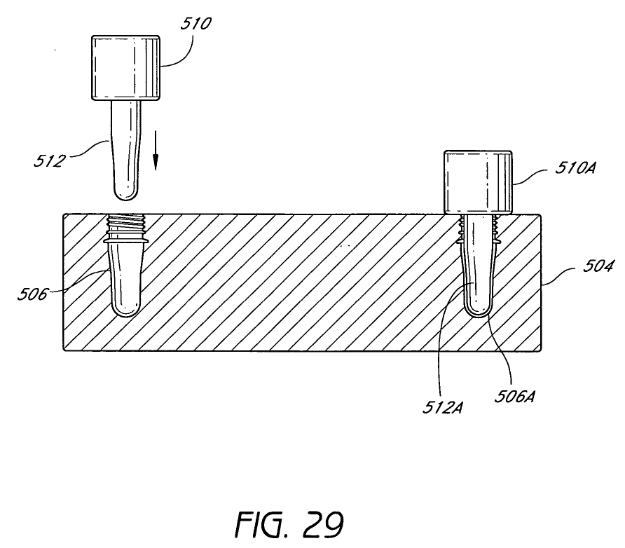

FIG. 28 is a schematic of a portion of one type of apparatus to make articles described herein. The apparatus is a molding system 500 designed to make preforms that comprise one or more layers. In the illustrated embodiment, the molding system 500 is a compression molding system and comprises a melt source 502 configured to deliver moldable material to a turntable 504 that has cavity portions 508 with one or more mold cavity sections 506 (FIG. 29).

The core section 510 may be configured to cooperate with a corresponding cavity section 506 to mold the moldable material. The illustrated core section 510 (FIG. 29) has a core 512 sized and adapted to be inserted into a corresponding cavity section 506. The core 512 can be moved between an open position and a closed position. The core section 512 A is in a closed position.

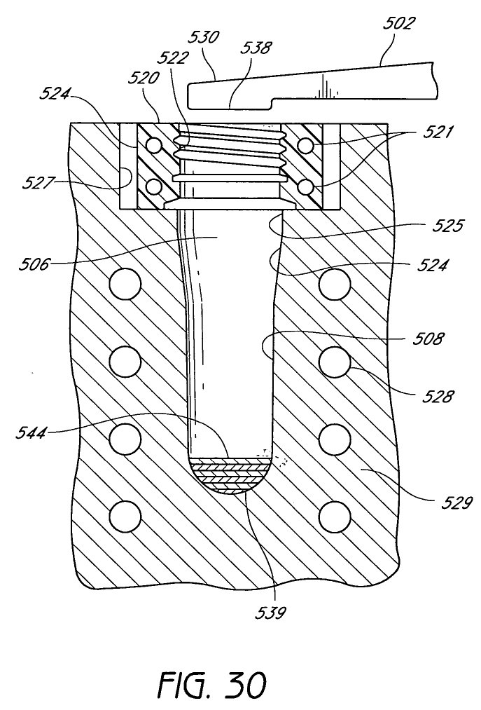

The source 502 can feed melt material into the mold cavity section 506 from above or through an injection point along the mold cavity section 506. The term “melt material” is a broad term and may comprise one or more of the materials disclosed herein. In some embodiments, melt material may be at a temperature (e.g., an elevated temperature) suitable for compression molding. As shown in FIG. 30, the source 502 can produce and/or deliver melt material to the mold cavity sections 506 of the turntable 504. The turntable 504 can rotate about a central axis to move the mold cavity sections 506 into position such that the source 502 can fill a portion of a mold cavity section 506 with melt for subsequent compression molding. The turntable 504 and the mold core section 510 can continuously or incrementally rotate about the center of the turntable 504. Preferably, the core section 510 and the turntable 504 move in unison for a portion of the molding process as discussed below.

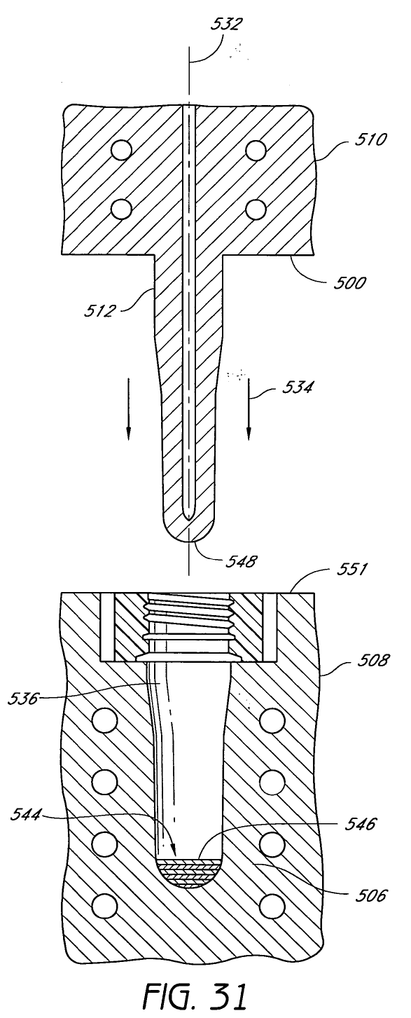

As shown in FIG. 29, the mold core 510 has a core 512 that is configured to cooperate with the turntable 504 to mold the melt material. The core 512 is configured and sized so that the core 512 can be advanced into and out of a corresponding mold cavity section 506. The core 512 is designed to form the interior of a preform. The illustrated core 512 is an elongated body that has a base end 528 (FIG. 31). The core 512 has a generally cylindrical body that tapers and forms rounded based end 528. The core section 510 can be connected to a turntable or other suitable structure for moving the core section 510.

The mold cavity sections 506 can be evenly or unevenly spaced along the turntable 504. The illustrated cavity sections 506 are designed to mold the exterior of a preform. The molding system 500 can have one or more circular arrangements of mold cavity sections 506 that are preferably disposed near the periphery of the turntable 504. In the illustrated embodiment of FIG. 28, the turntable 504 has one circular arrangement of mold cavity sections 506.

The source 502 is adapted to produce a lamellar melt stream suitable for molding. However, in other embodiments, the source 502 can output foam material, PET, PP, or other moldable material, as described in further detail below. In the illustrated embodiment, the melt from the source 502 can be deposited into one or more of the mold cavity sections 506 and then molded by compression molding.

With reference to FIGS. 28 and 30, the source 502 can comprise a source 519 that can deliver material to a layer generation system which, in turn, creates a melt stream that can be delivered out of an output 530, preferably when the core section is in the opened position. The source 502 can produce material comprising several layers of one or more materials. The layers can have any suitable thickness depending on the desired characteristics and properties of the preform, or the container made therefrom.

With continued reference to FIG. 30, the mold cavity section 506 can have a movable neck portion for molding the neck finish of a preform. In one embodiment, the mold cavity section 506 comprises a movable neck finish mold 520 that has a neck molding surface 522 configured to form the neck portion of a preform and a body molding surface 524 configured to form the body portion of the preform. The neck finish mold 520 is movable between one or more positions. In the illustrated embodiment, the neck finish mold 520 is located in a molding position so that the neck molding surface 522 cooperates with the body molding surface 524 of the molding body 529 to form a molding surface 525. The neck finish mold 520 can be moved outward to a second position, in which the outer surface 524 of the neck finish mold is proximate to or contacts the stop 527. When the neck finish mold 520 is in the second position, a preform formed within the mold cavity section 506 can be ejected therefrom. After the preform has been removed from the mold cavity section 506, the neck finish mold 520 can then be moved back to the illustrated first position so that another preform can be formed.

Optionally, the mold body 529 can have a cooling system 528 that is used to control the temperature of the melt within the mold cavity section 506. The cooling system 528 can comprise one or more cooling channels.

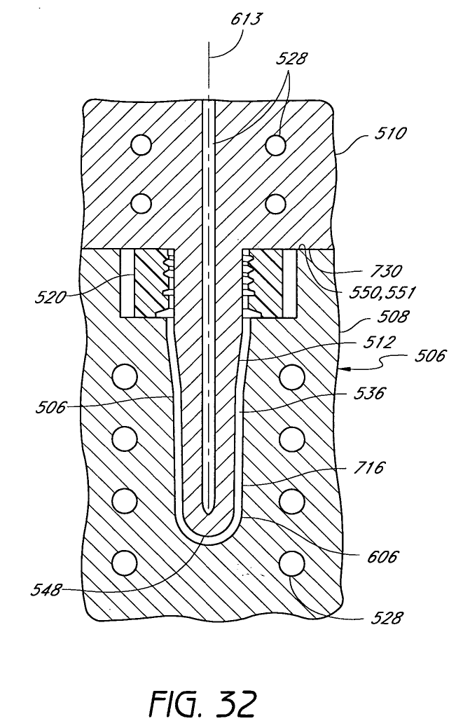

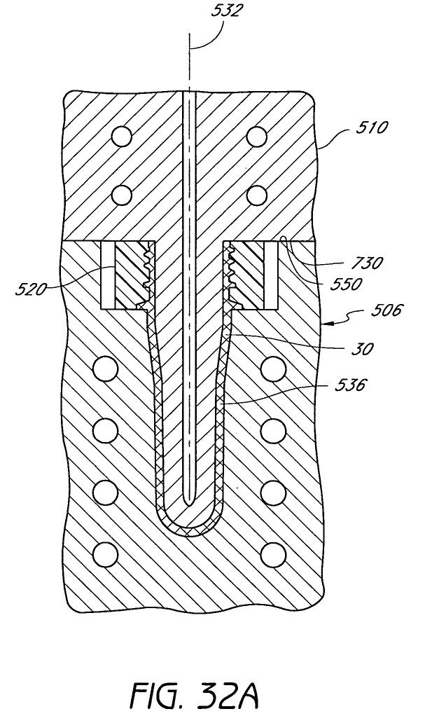

FIG. 31 illustrates the core section 510 positioned above a corresponding cavity section 508 defining the mold cavity section 506. The core section 510 can be moved along a line of action 532 in the direction indicated by the arrows 534 until the core section 510 mates with the cavity section 508. As shown in FIGS. 32 and 32 A, the core section 510 and the cavity section 508 cooperate to form a space or cavity 536 having the desired shape of a preform. After material has been deposited into the mold cavity section 506, the core section 510 can be moved from the open position of FIG. 31 to the closed position of FIG. 32 in order to compress the lamellar melt such that the melt substantially fills the space or cavity 536 (FIG. 32A).

In operation, the turntable 504 can be positioned so that one of the mold cavity sections 506 is located below the output 530 of the source 502 as shown in FIGS. 28 and 30. A plug or shot of melt is delivered out of the opening 538 of the output 530 such that the plug falls into the mold cavity section 506. Preferably, the plug drops to the end cap area 539 (FIG. 30) of the mold cavity section 506.

The plug 544 may comprise a plurality of layers. The plug 544 may comprise lamellar material in any desirable orientation for subsequent compression molding. For example, one or more of the layers of the plug 544 can be horizontally oriented, vertically oriented, or in any other orientation such that resulting preform made from the plug 544 has a desired microstructure. In the illustrated embodiment of FIGS. 30 and 31, many or most of the layers of the plug 544 are generally perpendicular to the line of action 532. In some embodiments, the plug 544 comprises material without any orientation. For example, the plug 544 may comprise a substantially isotropic material.

The plug 544 can be at any suitable temperature for molding. In some embodiments, the temperature of the plug 544 is generally above the glass transition temperature (T_{g}) of at least one of the materials forming the plug 544, especially if the plug 544 comprises lamellar material. Preferably, a substantial portion of the material forming the plug 544 is at a temperature that is generally above its glass transition temperature (T_{g}). In other embodiments, the temperature of the plug 544 is in the range of about the T_{g} to the melt temperature (Tₘ) of a substantial portion of the material forming the plug. In other embodiments, the temperature of the plug 544 is in the range of about T_{g} to about Tₘ of most of the material forming the plug. In some embodiments, the temperature of the plug 544 is generally above the Tₘ of at least one of the materials forming the plug 544. Preferably, the temperature of the plug 544 is generally above the Tₘ of a substantial portion of the materials forming the plug 544. A skilled artisan can determine the appropriate temperature of the plug 544 delivered from the source 502 for compression molding.

The turntable 504 can be rotated about its center such that the filled mold cavity sections 506 are moved about the center of the turntable 504 and the core section 510 can be moved downwardly along the line of action 532.

After the core section 510 has moved downward a certain distance, it will contact the upper surface 546 of the plug 544. As the base end 548 of the core 512 advances into the plug 544, the plug 544 spreads to generally fill the entire cavity section 536. The plug 544 preferably comprises sufficient material to generally fill the entire cavity section 536 as shown in FIG. 32A.

With reference to FIGS. 32 and 32A, the core section 510 is in the closed position so that the lower surface 550 of the core section 510 engages or contacts the upper surface 551 of the cavity section 506. The core section 510 and the cavity section 506 can have cooling systems 528 that can remove heat from the material forming the preform 30 disposed within the cavity section 536.

After the preform has been sufficiently cooled, the core section 510 can be moved upwardly along the line of action 532 to the open position so that the preform can be removed from the mold cavity section 506. Ejector pins or other suitable devices can be used to eject the preform from the mold cavity section 506. Preferably, before the preform is ejected from the mold cavity section 506, the neck finish mold 520 is moved radially away from the preform to the second position, such that the preform can be conveniently and easily moved vertically out of the mold cavity section 506.

The preform is formed within the cavity section 536 at some point after the source 502 deposits material into the mold cavity section 506 and before the mold cavity section 506 is rotated around and located once again beneath the output 530 of the source 502. Of course, the core section 510 and turntable 504 preferably rotate in unison about the center of the turntable 504 during the compression molding process. The core section 510 can be attached to a complementary turntable similar to the turntable 504. The two turntables can rotate together during the molding process.

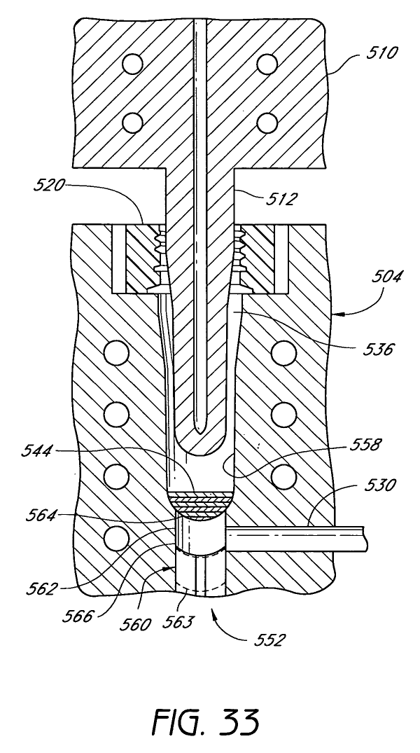

Moldable material can also be disposed by other suitable means. FIG. 33 illustrates a moldable material that can be delivered directly by an injection molding process into a modified cavity section 558. The components of the illustrated embodiment are identified with the same reference numerals as those used to identify the corresponding components of the cavity section 510 and turntable 504 discussed above.

The turntable 504 comprises a feed system 552 configured to deliver moldable material (e.g., foam, lamellar material, PP, PET, etc.) directly into the cavity section 558. The feed system 552 delivers moldable material (e.g., melt) at any point along the cavity section 558 and preferably comprises the output 530 of a source and a means for pushing material from the output 530 into the cavity section 558.

In one embodiment, the feed system 552 comprises a push assembly 560 (e.g., a piston assembly) that is configured to push melt into the cavity section 558. The push assembly 560 can reciprocate between a first position and a second position and has a plunger or piston 562 illustrated in a first position so that the upper surface 564 of the plunger 562 forms a portion of the cavity section 558. Preferably, the upper surface 564 forms the lower portion or end cap region of the cavity section 558. The plunger 562 can be moved from the illustrated first position to a second position 563 (shown in phantom) for receiving material from the output 530. When the plunger 562 is in the second position, the output 530 feeds melt into a cylindrical chamber defined by the tube 566 and the upper surface 564 of the plunger 562. The plunger 562 can be moved from the second position to the first position, thereby moving the material to the illustrated position. In this manner, material can be repeatedly outputted from the output 530 and into the chamber defined by the tube 566 and then advanced into the cavity section 558 for compression molding.

After the plug 544 is positioned in the cavity section 558, the core 512 can be advanced into the cavity section 558 to compress and spread the material of the plug 544 through the cavity 536 in the manner described above. Preferably, the plug 544 is molten plastic (e.g., lamellar, PET, PP, foam, phenoxy type thermoplastic) that can be spread easily throughout the cavity 536.

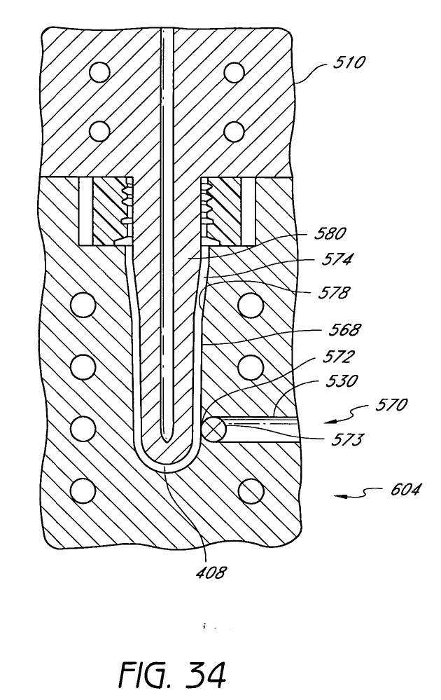

With reference to FIG. 34, the turntable 504 can have a mold cavity section 568 that is generally similar to the mold cavities section discussed above. However, in the illustrated embodiment, the turntable 504 can have an injection system 570 for injecting material into the cavity section 568. The injection system 570 can be configured to inject material at a desired location and/or with a desired orientation. In some embodiments, the injection system 570 can be adjusted to inject material at desired locations and/or with desired orientations.

In the illustrated embodiment, the turntable 504 has an injection system 570 that is configured to inject a lamellar melt stream into the cavity section 568 at a suitable points along the cavity section surface. One or more injection systems 570 can be used to inject a lamellar melt stream at one or more locations along the mold cavity section 568. The injection system 570 can inject a lamellar melt stream into a lower portion or end cap region of the mold cavity section 568. Alternatively, the injection system 570 can inject a lamellar melt into the upper portion of the mold cavity section 568.

The injection system 570 can comprise a gate 572 at the downstream end of the output of the lamellar machine. The gate 572 may selectively control the flow of the lamellar melt stream from the output 530 into a space or cavity section 574 defined by the core 580 and the cavity section surface 578 of the cavity section. The gate 572 may comprise a valve system 573 that selectively inhibits or permits the melt stream into the cavity section 568. In one embodiment, the injection system 570 injects material to form a plug (illustrated as a lamellar plug) at the bottom of the cavity section 568, similar to the plug shown in FIG. 33. The plug can then be compressed by the core 580 to form a preform within the cavity 574.

One method of lamellar molding is carried out using modular systems similar to those disclosed in U.S. Pat. No. 6,352,426 B1 and U.S. application Ser. No. 10/705,748 filed on Nov. 10, 2003, the disclosures of which are hereby incorporated by reference in their entireties and form part of this disclosure. In view of the present disclosure, a skilled artisan can modify the methods and apparatus of the incorporated disclosures for compression molding. For example, the injection-over-injection (“IOI”) systems of the U.S. Pat. No. 6,352,426 B1 can be modified for compression molding. For example, the melt of those systems can be injected into a mold cavity section and then the core can be used to compress the melt to form a preform. Those systems can be modified into compress-over-compress systems used to make multilayer preforms formed by compression molding. Additionally, one or more components, subassemblies, or systems, of these apparatuses can be employed in the mold described herein. For example, the cavity sections and/or core sections of the molds disclosed herein may comprise high heat transfer material for enhancing thermal transfer with heating/cooling systems.

The compression molding system 500 can be used to produce preforms that comprise non-lamellar materials (e.g., foam material, PET, PP, barrier material, combinations thereof, and other materials disclosed herein). Compression molding systems for making preforms comprising lamellar material, and preforms comprising foam, can be similar to each other, except as further detailed below. That is, in some embodiments a foam melt can be molded in a similar manner as the lamellar material described herein.

With reference again to FIG. 28, the compression molding system 500 can have a source 502 that produces a melt stream of foam material. The source 519 may comprise one or more extruders. The source 519 delivers foam melt out of the output 530 and into the cavity sections 506. The foam material can have mostly unexpanded, partially expanded, or fully expanded microspheres. The core 512 is advanced into the corresponding cavity section 506 to compress and spread the foam material through the cavity section 536 (FIGS. 32 and 32A). Preferably, the core 512 and cavity section 506 compress the foam material without substantially degrading the foam material. Substantial degradation may occur when most of the microspheres of a foam material are broken due to the pressure applied by the core 512 and the cavity sections 506. A skilled artisan can select the amount of foam material that is delivered to the cavity section 506 in order to produce a preform having a desired microstructure.

After the preform comprising foam is formed in the cavity section 536, the core 512 can be moved upwardly and out of the cavity section 506. The preform is then removed from the cavity section 506 and may be subsequently blow molded. The foam material can undergo further expansion during and/or after the reheat process for blow molding. In some embodiments, the interior of the foam preform can be coated with one or more layers. The interior layers may comprise PET, lamellar material, PP, phenoxy type thermoplastics, and/or other material(s) suitable for contacting foam material.

FIG. 28A illustrates a system 591 comprising a plurality of subsystems and is arranged to produce multilayer articles. Generally, the system 591 includes one or more systems (e.g., compression systems, closure lining systems, etc.) and is configured to produce multilayer articles, such as preforms, closures, trays, and other articles described herein. In some embodiments, the system 591 comprises a first system 500A connected to a second system 500B. The first system 500A can be a compression molding system that molds a first portion of an article, and the second system 500B can be configured to form a second portion of the article. The illustrated systems 500A, 500B have turntables that rotate in the counter-clockwise direction during a production process. A transport system 599 can transport a substrate article from the first molding system 500A to the second system 500B. Of course, additional subsystem(s) can be added to the system 591. For example, the one or more compression molding system similar to the compression molding system 500 can be connected to the system 591. Thus, systems (similar to or different than the systems 500, 500A, 500B, etc.) can be added to the system 591 to produce articles having more than two layers, to place liners in multilayer closures, and the like.

The illustrated system 591 comprises a first molding system 500A that can be similar to or different than the molding systems described herein, such as the molding system 500 of FIG. 28. The first molding system 500A can have a plurality of cavity sections 506A configured to mold substrate articles. The cavity sections 506A, 506B are arranged in a substantially circular pattern. The first molding system 500A can deliver the substrate articles to the transport system 599.

The illustrated transport system 599 can carry substrates produced by the first compression molding system 500A to the second system 500B. The transport system 599 carries and delivers the substrates to the second system 500B, which can be a compression molding system. The transport system 599 can comprise one or more of the following: handoff mechanisms, conveyor systems, starwheel systems, turrets, and the like. The illustrated transport system 599 is positioned between the systems 500A, 500B.

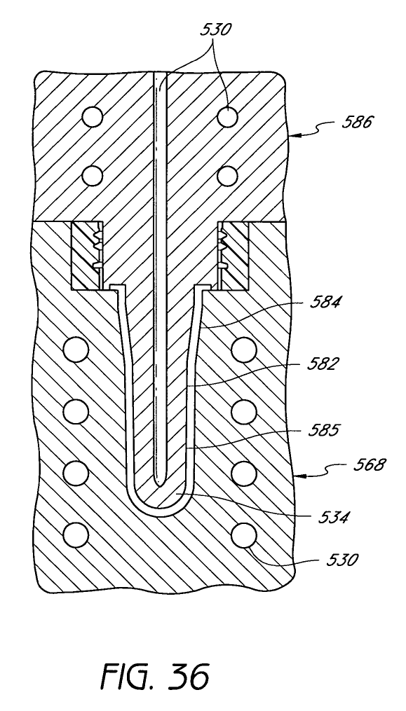

The second system 500B in some embodiments can form an outer layer over the substrate delivered by the transport system 599. For example, the transport system 599 can deliver substrate preforms to a core (not shown) of the molding system 500B. The source 519B can deposit melt into the cavity section 506B, and the core holding the substrate can be advanced into the cavity section 506B to mold the melt therein. The cores and the cavity sections 506B can rotate continuously during the production process. The cavities of the cavity section 506B can be larger than the cavities of the cavity sections 506A in order to form an outer layer on the article. For example, the system 591 can be configured to mold the preform 50 of FIG. 5. The first system 500A can form the inner layer 54 of the preform 50. The transport system 599 can remove the inner layer 54 and deliver the inner layer 54 to the second system 500B. The second system 500B can have a holder (e.g., a core) that holds the inner layer 54. The cavity sections 506B can be rotated and moved under the source 519B to receive melt. After melt has be delivered into a cavity section 506B, the core and the inner layer 54 can be advanced into the cavity section 506B, which can be similar to the cavity sections 568 of FIG. 36, to form the outer layer 52 of the preform 50. The outer surface of the layer 54 and the cavity section 506B cooperate to mold the melt. Of course, the system 591 can be modified to form the other preforms described herein.

In some embodiments, the transport system 599 can place the substrate preform in the cavity section 506B. Melt can be deposited by the source 519B into the interior of the substrate preform. A core (not shown) of the second system 500B can be advanced into substrate located within the cavity section 506B to mold the melt. Thus, the second system 500B can mold a layer over the substrate produced by the first molding system 500A. The system 591 can therefore be a compress-over-compress system for producing multilayer articles.

The system 591 can be configured to produce other articles such as multilayer closures. The first system 500A can mold at least a portion of a closure (e.g., a closure comprising lamellar material, foam, and/or other materials described herein). The transport system 599 can receive the at least a portion of a closure and deliver the at least a portion of the closure to the second system 599. The second system 599 can be a spraying system that sprays material onto the closure, lining system (e.g., a spray lining system, a spin lining system, insertion system, etc.), compression molding system, and the like. For example, the second molding system 500B can comprise systems or employ techniques similar to those disclosed in U.S. Pat. No. 5,259,745 to Murayama and U.S. Pat. No. 5,542,557 to Koyama et al., which are incorporated by reference in their entireties. For example, the source 519B can be in the form of a spin lining system that forms a liner (e.g., an annular liner) in a closure. The components identified by the reference numeral 506B of the second system 500B can be in the form of chucks for holding closures (e.g., the closures 350 of FIG. 21B). The closures can be spun in corresponding chucks so that a liner (e.g., heated polymeric material) can be deposited by the source 519B into the closure. The liner can comprise ethylene homopolymers and/or copolymers, for example ethylene vinyl acetate copolymer and one or more resins (e.g., rosin ester type), and/or other materials described herein. The polymeric material can be cooled to form a liner, such as an annular liner or layer 358 of the closure 350 of FIG. 21B.

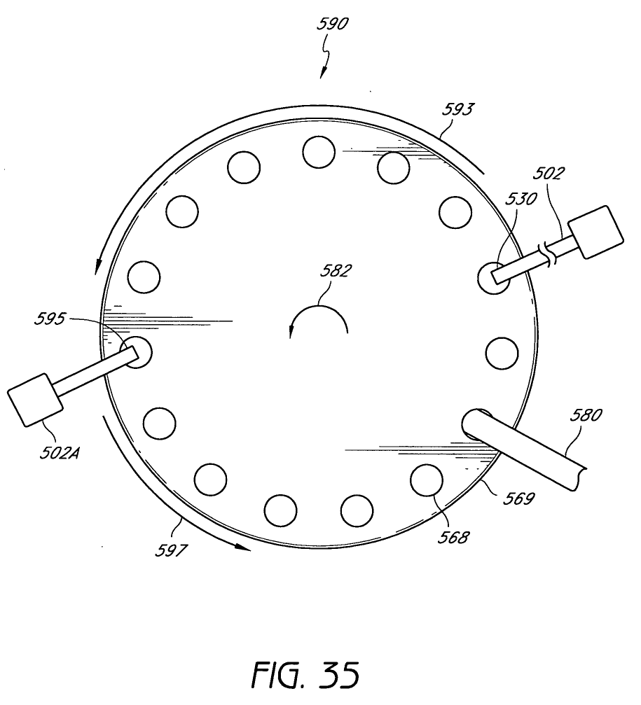

FIG. 35 shows a compression molding system 590 configured to mold multi-layer articles in the form of preforms. The compression molding system 590 can be a compress-over-compress processing machine. Generally, the system 590 can comprise one or more material sources configured to deliver material to the mold cavity sections 508 of the turntable 569. In the illustrated embodiment, the molding system 590 comprises a pair of material sources configured to output melt streams into the mold cavity sections 506. For example, in the illustrated embodiment, the system 590 can comprise a pair of melt machines that can be similar or different from each other. The molding system 590 can also comprise one or more ejector systems 580 configured to remove the completely formed preforms from the turntable 569.

As shown in FIG. 36, the core section 586 has a core 582 that is configured to be disposed within a corresponding mold cavity section 568 and can have various sizes depending on the desired article formed through the compression molding process. For example, a plurality of compression molding steps can be performed, wherein each step forms a different layer of a preform. As the turntable 569 rotates about its center, various cores can be inserted into the turntable 569 at different times to form various portions of the preforms as described below.

With reference to FIG. 36, the core section 586 and the cavity section 568 are in the closed position. The core 582 and mold cavity section 568 are configured to form a portion of a preform. The core 582 and mold cavity section 568 cooperate to define a cavity 585 in the shape of the outer layer 52 of the preform 50 of FIG. 5. Melt material can be placed in the mold cavity 585 when the core section 586 is in the open position. The core 582 and mold cavity section 568 can cooperate to compress the melt material to fill the cavity 585 to form the outer layer 52 in the manner described above. A skilled artisan can determine the appropriate amount of material to deposit into the mold cavity section 568 to fill the cavity 585 defined by the core section 586 and the mold cavity section 568.

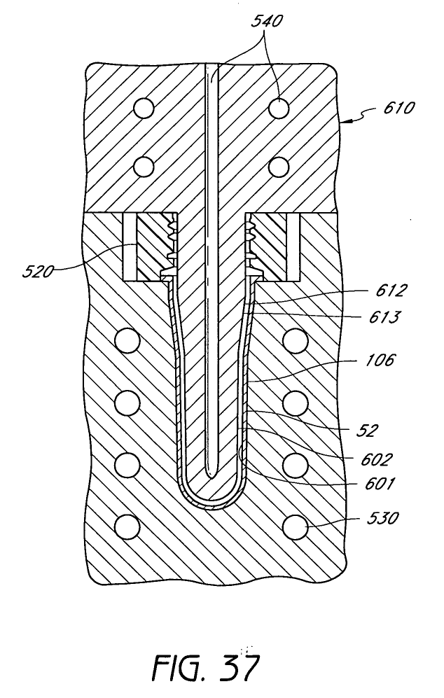

After the outer layer 52 is formed, the core 582 can be removed from the cavity 584 while the layer 52 is retained in the cavity 584. Another core can be used to mold another layer of material, which is preferably molded over the layer 52. As shown in FIG. 37, another core (i.e., core 612 ) can be used to mold melt over the layer 52.

The cavity section 602 can be formed between the outer surface 601 of the layer 52 and the outer surface 213 of the core 613. The core 612 may have a shape that is generally similar to the shape of the core 582. Preferably, however, the core 612 is smaller than the core 582 so that the surface 613 of the core 612 is spaced from the layer 52 when the core section 610 is in the illustrated closed position. The size and configuration of the core 512 can be determined by one of ordinary skill in the art to achieve the desired size and shape of the cavity 602 which is to be filled with material to form a portion of the preform.

In operation, the system 590 can have a source 502 that outputs melt and drops it into the mold cavity section 568 disposed beneath the output 530. After the mold cavity section 506 with the plug rotates in the direction indicated by the arrow 593, the core 582 can be advanced downwardly and into the mold cavity section 568. As the base end 534 of the core 512 compresses the plug, the material spreads and proceeds upwardly along the cavity 587 until the material substantially fills the entire cavity 587. Optionally, a cooling fluid can be run through a temperature system 530 within the core section 568 and the turntable 569 to rapidly cool the material forming the outer layer 52. After the material has sufficiently cooled, the core section 586 is moved upwardly so that the core 582 moves out of the mold cavity section 568.

With continued reference to FIG. 35, after the core section 586 has been moved to the open position, the turntable 569 can be rotated in the direction indicated by the arrow 593 until the mold cavity section 506 is located under the second material source 502A. The source 502A can output a melt stream from the output 595 onto the interior surface 601 (FIG. 37) of the outer layer 52. The turntable 509 can then rotate in the direction indicated by the arrow 597 and the core section 610 can be inserted into the turntable 509 to compresses and spread the melt throughout the cavity 602. In this manner, this second compression process can form the inner layer 53 of the preform 50. Once again, the temperature control system 530 can be used to rapidly and efficiently cool the preform 50 for subsequent ejection. After the core section 610 has moved to the open position and the neck finish mold 520 is moved apart, the preform 50 can be conveniently lifted vertically out of the turntable 509 by the ejector system 580. The process can then be repeated to produce additional multilayer preforms.

It is contemplated that any number of core sections, cavity sections, and sources of materials can be used in various combinations to form preforms of different configurations and sizes. The preforms may have more than two layers of material. Although not illustrated, there can be additional cores that are used to form additional layers through compression molding. Additionally, the above compression process can be used to produce coatings or layers on conventional preforms.

Those of ordinary skill in the art will recognize that the mold cavity sections can be located in any structure suitable for molding. For example, the mold cavity sections 506 can be located in a stationary table. One or more extruders or melt sources and the cores can be movable with respect to the mold cavity sections. Thus, an extruder can move to each mold cavity sections and deposit melt within the cavity section. The core section can then move into the corresponding core to mold the preform.

The molding system 590 can be configured to make multi-layer preforms by the compress-over-compress process. In some embodiments, the molding system 590 can have a core 582 that is configured to mate with the mold cavity 568 to form an inner portion of a preform, such as the inner layer 54 of the preform 50 of FIG. 5. In other words, the cavity 585 can be in the shape of the inner layer 54 of the preform 50. Melt can be deposited into the cavity section 568 and can then be compressed between the core 582 and the cavity section 568 to form the inner layer 54. After the inner layer 54 has been formed, the core section 586 can be moved upwardly out of the cavity section 568. When the cavity section 586 is moved out of the cavity section 568, the outer layer 54 is preferably retained on the core 582. The outer layer 54 and the core 582 can then be inserted into a second cavity, preferably configured to mate with the outer surface of the outer layer 54 to define a cavity in the shape of the outer layer 52 of the preform 50. Melt can be deposited into the second cavity section and then compressed as the core section 586 and layer 54 are moved into the second cavity. Thus, the second material can be compressed into the shape of the outer layer 52 of the preform 50. After the preform 50 has been formed, the cavity section 586 can be moved upwardly out of the second cavity so that the preform 50 can be removed. Thus, one or more layers of a preform can be positioned on a core and used to mold multiple layers of a preform in one or more cavities section. In view of the present disclosure, a skilled artisan can select and modify the molds disclosed herein to make various preforms and other articles disclosed herein.

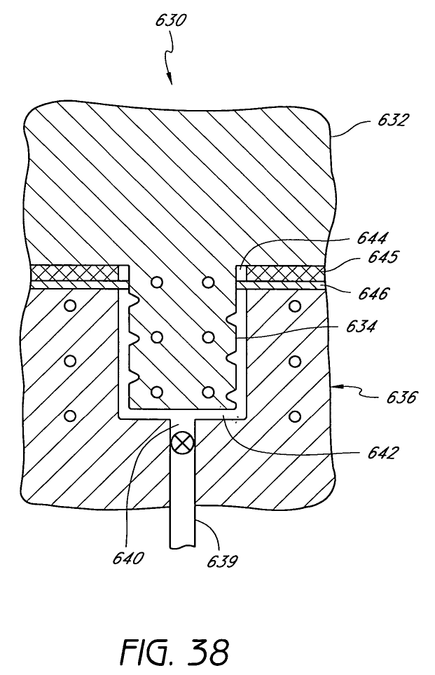

It is contemplated that articles of other shapes and configurations can be molded through similar compression molding process. For example, FIG. 38 illustrates a molding system 630 that is configured to mold a mono or multilayer closures. The molding system 630 is defined by a core half 632 having a core 634 and a mold cavity section 636. In one embodiment, material is passed through the line 639 and through the gate 640 and into the cavity 642 defined between the core 634 and the cavity section 636. The core half 632 can be in the open position when the material is passed through the gate 640. The core half 632 can then be moved to the closed position to mold the melt into the desired shape of the closure. In the illustrated embodiment, the cavity 642 also optionally includes a portion 644 for forming a band and connectors between the body and the band of the closure. The mold 630 can optionally include neck finish molds 644, 646 (e.g., split rings) that can be moved apart allowing the core half 632 to move out of the cavity section 636.

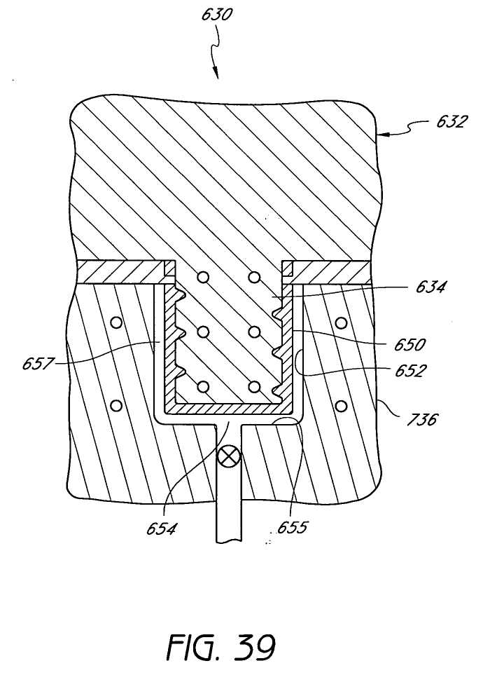

Additional layers can be added to the closure by additional compression molding processes. For example, the substrate 650 (FIG. 39) formed in the cavity 642 can be retained on the core 634 and inserted into a second cavity section 652. The delivery system of the second cavity section 652 can deposit material out of a gate 654 and into the cavity section 652, preferably when the core section 632 and cavity section 652 are in the open position. The core half 632 can be moved from the open position to a closed position, while the substrate 650 is positioned on the core 634, the outer surface of the substrate 650 acts as a molding surface to compress the melt between the substrate 650 and the surface 655 of the cavity section 652. The melt can be spread throughout the space 657 defined between the substrate 650 and the surface 655. After the closure has sufficiently cooled, the core half 632 can be removed from the cavity section 652. Optionally, additional layers of material can be molded onto the closure by a similar compress-over-compress process. In view of the present disclosure, a skilled artisan can design the desired shape of the systems and molds disclosed herein to make various types of articles and packaging described herein. Multiple layer closures can also be formed by the compress-over-compress processes as described above. For example, the inner layer of the closure can be molded within the outer layer.

The system 591 of FIG. 28A can be configured to produce multilayer closures. The first system 500A of FIG. 28A of the system 591 can mold a first layer of the closures in a similar manner as described with respect to FIG. 38. The second system 500B of FIG. 28A can mold an outer layer of the closure in a similar manner as described with respect to FIG. 39.

Other types of molding systems can be employed to form mono and multi-layer articles. As described below, there are various systems that can be employed to deliver material to a compression molding system. Although the exemplary embodiments are disclosed primarily with respect to stationary mold cavities section, these systems can be used in rotary systems, such as the turntable system described above. The molding system described below are discussed primarily with respect to delivering foam material to mold cavities section. However, it is contemplated that the molding systems can also be used to deliver other materials such as lamellar materials, PET, polypropylene, phenoxy type thermoplastic, or other materials suitable for forming part of an article.

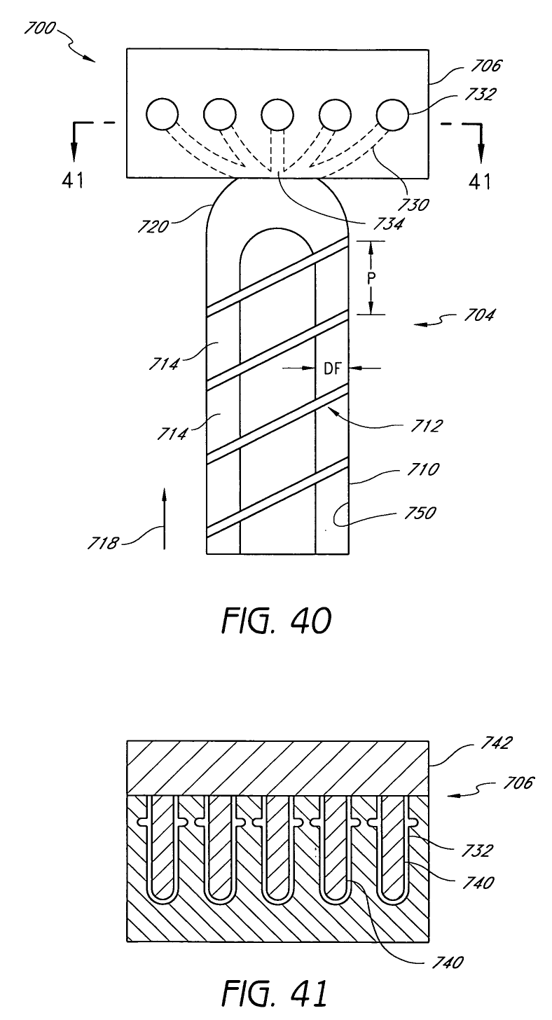

FIG. 40 illustrates a molding system 700 configured to produce preforms described herein. The molding system 700 is preferably a compression molding system that comprises a melt source 704 in the form of an extruder configured to deliver moldable material to a compression mold system 706. The melt sources disclosed below (e.g., extruders) can be used in combination with the stationary molding system, movable molding system (e.g., the rotary systems described above), and the like. The molding system 700 is generally similar to the mold systems described above, except as described in further detail below.

The extruder 704 is configured to deliver a melt stream suitable for molding to the mold system 706. A hopper or feed system can deliver raw material to the extruder 704, which can then heat and compress the material to produce the melt stream that is delivered into the mold system 706. In the illustrated embodiment, the extruder 704 comprises a housing 710 that surrounds an extruder screw 712 extending at least partially therethrough. The housing 710 and the extruder screw 712 are toleranced to inhibit or limit backflow, e.g., between the extruder screw 712 and the housing 710. The tolerance between the extruder screw 712 and housing 710 can be varied depending upon the pressure and the material within the extruder 704. For example, the extruder screw 712 can engage the walls of the housing 710 to achieve high pressures within the extruder 704, preferably with minimal backflow because of the fit between the helical threads of the extruder screw 712 and the housing 710. Thus, material is contained within a flight 714 even at very high pressures. If material is extruded at low pressures, there can be play between the extruder screw 712 and the housing 710. For example, if the extruder 704 extrudes material (e.g., foam material) at low pressures, the extruder screw 712 may not be precisely toleranced with the housing 710. Because of the low pressure, the material generally is not forced to flow between flights. Thus, different types of extruders can be employed to extrude materials at different pressures, temperatures, and output rates.

A plurality of flights 714 is defined by the helical screw 712 and the housing 710. During the operation of the extruder 704, material (e.g., unmelted or raw polymers) can be continuously or batch fed into one of the flights 714 located at the rearward end of the extruder 704. As the material is moved in the direction indicated by arrow 718, heat and pressure can be applied to the material to melt material as it moves towards the front of the extruder 704. A skilled artisan can select the pitch P and the depth DF of each of the flights 714. For example, pitch P and/or depth DF of the flights 714 can be constant, or vary along the length of the extruder 704.

As material is melted within the extruder 704, gases may be entrapped within the extruder 704. In some embodiments, the gases are expelled out through a vent or through the hopper of the extruder 704.

The extruder 704 can have a curved or partially rounded tip 720 that directs melt into the mold system 706. The tip 720 may or may not have a valve for metering the melt stream into the mold system 706. The tip 720 may have a gate or check valve for regulating the flow of melt. The curved tip 720 causes gradual changes in the flow velocity and therefore permits the extrusion of materials at very low pressures. In some embodiments, the tip 720 can also permit the extrusion of materials at higher pressure ranges.

A skilled artisan can select the type and configuration of the extruder which is used to output melt to the mold system 706. For example, the extruder 704 can be a single stage or multi-stage screw design.

The mold system 706 preferably comprises one or more runner systems 730 for channeling the molten material from the extruder 704 to one or more cavity sections 732. The runner system 730 can extend between a junction 734 and a corresponding cavity section 732. Although not illustrated, the runner system 730 can include one or more valves for selectively controlling the flow of melt into the cavities section 732. The melt can be simultaneously or individually delivered to the mold cavities sections 732.

FIG. 41 is a cross sectional view of the mold system 706 comprising a core section 742 comprising mold cores 740, which are disposed within corresponding cavities sections 732. The mold cores 740 and cavity sections 732 cooperate to define voids having a shape of a preform. The core section 742 can be moved between an open position and the illustrated closed position. The runners 730 can deliver melt into the void, preferably when the core section 742 and the cavity section 732 are in the closed position.

In operation, material is fed into a flight at the rearward portion of the extruder 704. The extruder screw 712 can rotate thereby causing movement of the material towards the tip 720 of the extruder 704. As the extruder screw 712 rotates, the material passes in the direction indicated by the arrow 718 through the extruder 704. The material is melted within the extruder 704 and then delivered out of the tip 720 and into the mold system 706, preferably when the core section 742 and the cavity section 732 are in the partially or fully opened position.

In one exemplary non-limiting embodiment, the material fed into the extruder 704 is expandable material (e.g., foam material). The extruder 704 applies a low pressure to the foam material resulting in the foam material (e.g., microspheres) undergoing at least partial expansion. Advantageously, because the foam material is under a low pressure, the foam material can be contained within a flight even though there is not a tight fit between the extruder screw 712 and the housing 710. A skilled artisan can select an extruder design to achieve an appropriate pressure within the extruder 704 to result in the desired expansion of the foam material. In some embodiments, the foam material can gradually expand as it proceeds through the extruder 704. In other embodiments, the foam material can rapidly expand at certain point(s) in the extrusion process. However, in some embodiments the extruder 704 can apply pressure to the foam material to generally controllably limit expansion of the foam material. For example, the extruder 704 can apply a higher pressure to the foam material to inhibit or minimize expansion of the foam material.

The mold system 706 can have a runner system 730 that comprises outputs similar to the outputs 114 described above. Thus, the foam material can be dropped, injected, or pushed into the mold cavities section 732. The illustrated runner system 730 is disposed within the mold system 706. The extruder 704 can deliver foam material through the runner system 730 into the cavity sections 732. The core section 742 (FIG. 41) can be in an open position (not illustrated) above the cavities section 732. After foam material has been metered into the cavity sections 732, the core section 742 can be moved downwardly to the closed position to compress the foam material into a desired shape.

The amount of foam material delivered to cavity sections 732 can be increased or decreased to increase or decrease, respectively, the pressure applied to the microspheres of the foam when the core section 742 is in the closed position. Preferably, the foam material completely occupies the space defined between the cores 740 and the corresponding cavities section 732. After the foam material has cooled, preferably resulting in dimensional stability, the core section 742 can be moved upwardly to expose the preforms. The preforms are then vertically moved out of their respective cavities.

The extruder 704 of FIG. 40 can extrude other materials, such as lamellar material. Lamellar material can be delivered to and passed through the extruder 704. Preferably, the inner walls of the housing 710 are configured to reduce the frictional interaction with the lamellar material. For example, the inner surface of the wall 750 can be highly polished or have a surface treatment (e.g., a smooth coating) to reduce the coefficient of friction of the wall 750. The reduced frictional engagement between the lamellar material and the inner wall 750 can reduce the shear stresses within the lamellar material, thus resulting in a generally uniform flow profile of the lamellar material, and may prevent material migration between the lamella of the laminar material. In some embodiments, the extruder screw 712 is similarly configured to reduce the coefficient of friction of its helical threads. However, in other embodiments, the extruder 704 may have interior surfaces with high coefficients of friction to promote heating of the lamellar material and/or movement of molecules between the lamella. For example, the interior surfaces of the extruder 704 may be roughened or textured to increase frictional forces.

In other embodiments, other materials described herein can be extruded by the extruder 704 and delivered to the mold system 706 for compression molding. For example, PP, PET (including virgin and recycled PET), barrier materials, materials disclosed herein (including materials disclosed in incorporated disclosures), and combinations thereof can be molded by the molding system 700.

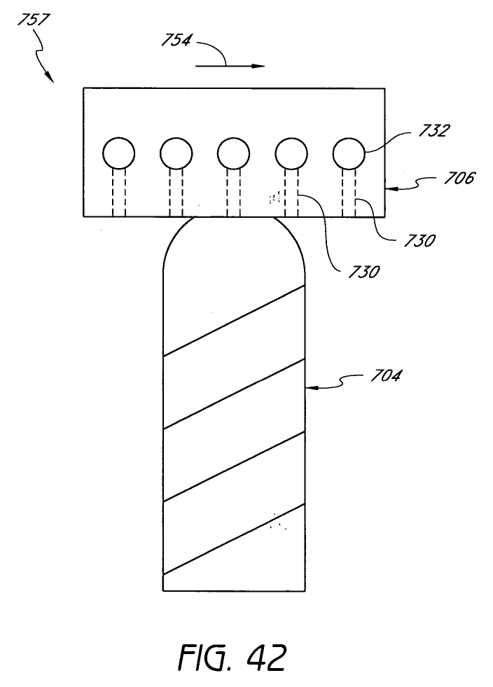

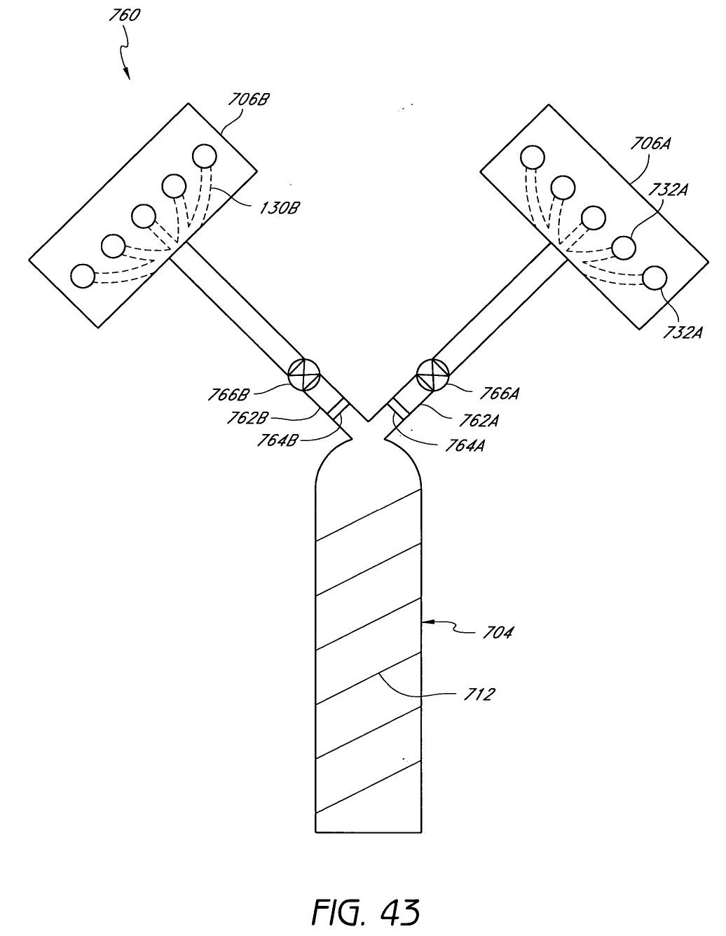

FIG. 42 is a schematic illustration of another embodiment of a molding system 757. The molding system 757 is similar to the molding system 700, except as further detailed below.

The molding system 757 comprises a mold 706 that has one or more runners 730 for channeling material from the extruder 704 to corresponding cavity section 732. In the illustrated embodiment, the molding system 757 is configured to deliver a single shot of material into a cavity section 732. The mold system 706 can be advanced in the direction indicated by the arrow 754 and the extruder 704 delivers melt to one of the runners 730 in order to fill a cavity section 732. After a desired amount of material has been metered into the cavity section 732, a core can be inserted and advanced into the cavity section 732 to mold the material into a preform. Each of the cavities section 732 is sequentially delivered material, which is then molded into a preform. Although not illustrated, the runners 730 can be configured to delivery shots of melt simultaneously to a plurality of mold cavities section.

FIG. 43 illustrates a molding system 760 for molding preforms. The molding system 760 can be used to deliver material to one or more sets of molds. The mold system 760 has an extruder 704 in fluid communication with one or more mold systems. The extruder 704 can continuously extrude material for compression molding.

In some embodiments, including the illustrated embodiment, the extruder 704 produces and delivers melt streams to lines 762A, 762B, which are connected to the mold systems 706A, 706B, respectively. The line 762A extends between the extruder 704 and the mold system 706A and includes one or more valve systems, such as a valve system 764A and a valve system 766A. The valve system 764A can be a check valve that allows fluid flow (e.g., melt flow) towards the mold system 706A but blocks flow towards the extruder 704. The valve system 766A is downstream of the check valve 764A and is operated to inhibit or permit the flow of the melt stream to the line 762 and into the mold system 706A. The valve system 766A can be a globe valve, gate valve, or other type of valve for regulating a flow of fluid. The valves systems 764A and 766A can be located at any point along the line 762A. Alternatively, one or more of the valve systems 764A, 766A can be located within the mold system 706. The line 762B and the mold system 706B can be generally similar or different than the line 762A and the mold system 706A. For example, the line 762B can have valve systems 764B, 766B that are generally similar to the valves 764A, 766A.

In operation, the extruder 704 can continuously or sequentially deliver melt streams to the mold systems 706A, 706B. The extruder screw 712 of the extruder 704 can continuously rotate, preferably at a generally constant rotational speed, to deliver the melt stream to one of the lines 762A, 762B. For example, the extruder 704 can deliver a melt stream to the line 762A while the valve 766B along the line 762B is in a closed position. The melt stream can be passed along through the line 762A and into the mold system 706. After a desired amount of material is within the cavities section 732A, the valve 766A is operated to stop the flow through the line 762A. The valve 766B along the line 762B is operated to allow or permit flow therethrough so that the melt stream from extruder 704 is delivered through the line 762B and into the cavities section 732B. In this manner, the extruder 704 delivers melt material for forming preforms to one mold system at a time.

Alternatively, the extruder 704 can deliver melt material simultaneously to and through the lines 762A, 762B which, in turn, concurrently deliver the melt to the mold systems 706A and 706B. The valve system 766A can be operated to achieve the desired flow rate and pressure of the melt within the lines 762A, 762B. For example, if the melt stream comprises foam material, the valve 766A can be operated to control the pressure within the line 762A to reduce or inhibit the expansion of the foam material during the molding process. Additionally, the valve 766A can be closed after a desired amount of material has been delivered into cavities section 732 so that the cores can be inserted into the cavities section 732 to form preforms. Additionally, the mold system 760 can be used to produce mono and multilayer articles disclosed herein.

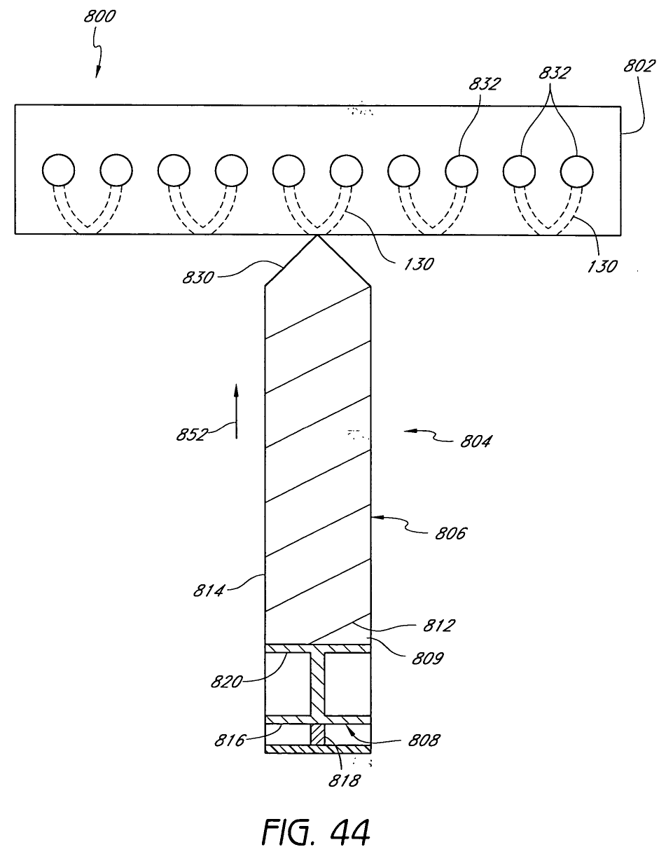

FIG. 44 illustrates one type of apparatus to make preforms described herein. The apparatus is an intrusion system 800 designed to make preforms that comprise one or more layers. In the illustrated embodiment, the intrusion system 800 is a compression molding system and comprises a mold system 802 and an intrusion melt source 804 configured to deliver a melt stream to the mold system 802.

The melt source 804 can operate as an extruder and/or injection system. The melt source 804 preferably comprises an extruder 806 that is generally similar to the extruder 704, except as described in further detail below. The extruder 806 comprises an extruder screw 812 that is rotatable and axially moveable relative to a housing 814. Preferably, the extruder screw 812 and housing 814 are configured to cooperate so that the extruder screw 812 can be moved relative to the housing 814 while limiting back flow at the interface of the screw 812 and the inner surface of the housing 814. The melt source 804 also comprises an injector 808 that is preferably connected to the rearward end 809 of the extruder 806.

The injector 808 comprises a plunger 816 and an actuator 818 for driving the plunger 816. The plunger 816 can be a piston that has a front wall 820, which preferably forms a seal with the housing 814 so that material generally does not flow between the plunger 816 and the housing 814. The actuator 818 can be a hydraulic or pneumatic linear actuator that moves both the injector 808 and the extruder screw 812. A skilled artisan can select a proper actuator design suitable for displacing the extruder screw 820 when melt is within the melt source 804. The distance that the actuator 818 moves the screw 812 is determined by the desired amount of material that is delivered from the extruder 806.

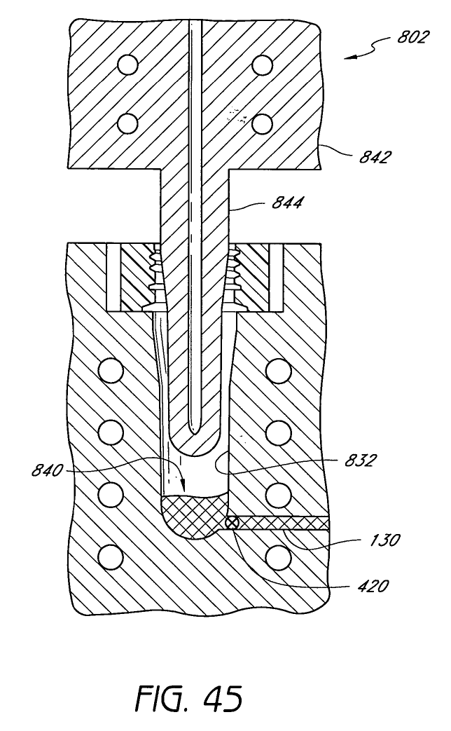

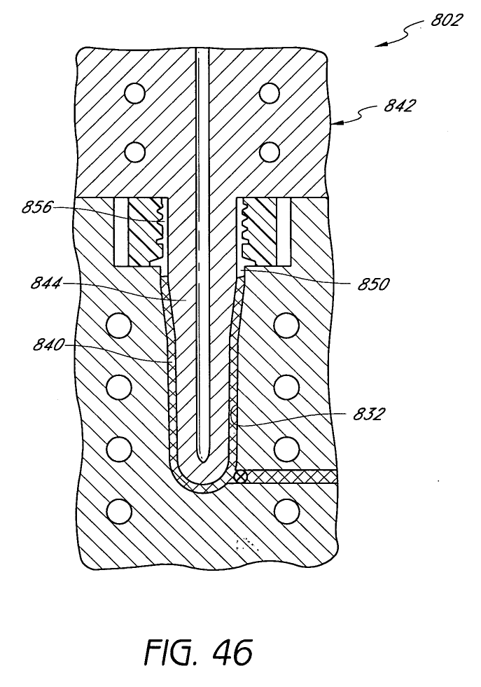

In operation, material can be fed into a hopper or other feed device and into the extruder 806. The extruder 806 can apply heat and pressure to the material as the extruder screw 812 rotates. The rotary motion of the extruder screw 812 drives the material through the extruder 806, out of the tip 830, and into the mold system 802. The mold system 802 can have runners 130 that receive the melt stream and deliver the melt stream into a cavity section 832. While the extruder screw 812 rotates, the injector 808 and the extruder screw 812 can be in a first position. The extruder screw 812 can rotate until a predetermined amount of material 840 is disposed within the cavity section 850, as shown in FIG. 45. The mold core section 842 is then advanced into the cavity section 832 until the mold core section 842 is in the closed position as shown in FIG. 46.

As illustrated in FIG. 46, the material 840 preferably at least partially fills a cavity section 850 defined between the cavity section 832 and the core 844. In some embodiments, the material 840 can fill a substantial portion of the cavity section 850. In the other embodiments, the material 840 can generally fill the entire cavity section 850. In some non-limiting exemplary embodiments, the material 840 fills about 20%, 30%, 40%, 50%, 60%, 70%, 80%, 90%, and ranges encompassing such percentages of the cavity section 850. The amount of material 840 in the cavity section 850 may be selected by the volume and geometry of the cavity section 850, the configuration of the melt source 804, and/or the design of the preform.

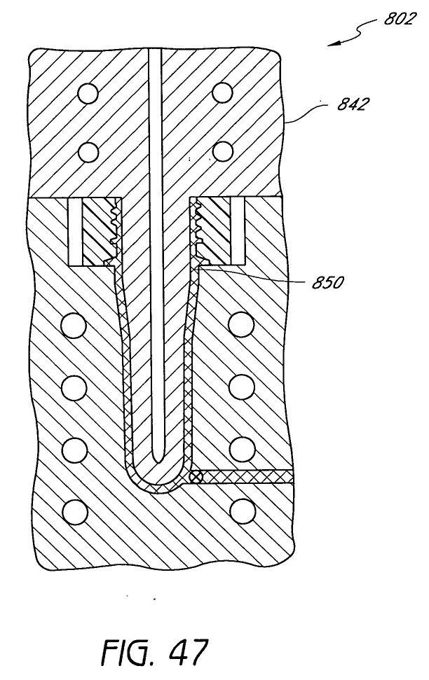

After the mold core section 842 is in the illustrated closed position, the injector 808 is moved by the actuator 818 so that the plunger 816 and extruder screw 812 move forward as indicated by the arrow 852 of FIG. 44. Thus, the extruder screw 812 and injector 808 cooperate to ram additional material into the cavity section 850, preferably a sufficient amount of material to generally completely fill the cavity section 850, as shown in FIG. 47. The displacement of the extruder screw 812 and injector 808 is related to the amount of material that is delivered to the cavity section 850. Preferably, the extruder screw 812 and the injector 808 are displaced a distance such that the melt stream delivered to the mold 802 generally completely fills the cavity section 850.

In some embodiments, the mold core section 842 is moved towards the cavity section 832 when the material 840 fills a substantial portion of the cavity section 832. The material 840 can be positioned in the cavity section 832 when the mold core section 842 is in an opened position (including partially opened position). The mold core section 842 can be advanced towards the cavity section 832 with a clamping force, preferably a large clamping force, to thereby compress the material 840 into a desired shape.

FIG. 47 illustrates the mold cavity section 850 that is generally completely filled with material 840. Advantageously, the melt source 804 can operate as an injector to inject a melt stream at wide range of pressures. For example, the material 840 can be under a high pressure. In some embodiments, the material 840 comprises foam material so that when the melt source 804 operates as an injector, the microspheres of the foam material are exposed to relatively high pressures, preferably without breaking a substantial portion of microspheres. In other embodiments, the material 840 can be laminar material or any other material described herein. After the preform has cooled within the cavity section 850, the mold core section 842 can move to an open position and the preform 850 can be removed.

The apparatuses and methods can be used to make other articles. The mold system, such as the molding systems (including molding systems 500, 590, 630, 706, 757, 760, 802, and the like) can be designed to make mono and multilayer articles. The mono and multilayer articles can have similar materials and structures and the preforms and containers described above. For example, articles may have walls that are similar to the walls of one of the articles described herein.

The compression molding systems can form the container 460. For example, the container 460 can be formed from molded foam sheets, preferably adapted so that they can be folded in a manner known to those of ordinary skill in the art to form a box or container (e.g., a pizza box, cup, clam shell, portions for drinkware, and the like). In some embodiments, the sheets can be used to form a laminate that is used to produce containers. For example, the foodstuffs container can be formed from a laminate comprising a first layer and a second layer. The first layer can form the outer surfaces of the container and may comprise wood pulp. The second layer can define the inner surface of the container and can be formed of the foam material. In some embodiments, a layer of the container can comprise BLOX® resins (or other polymer, preferably a phenoxy- type thermoplastic). In some embodiments, a layer of the container can comprise a phenoxy type material or a phenoxy-polyolefin blend material. As discussed above, at least a portion of the foam structure can be coated with another material that may be suitable for contacting food, providing structural strength, and the like. The sheets can be formed by compressing melt into sheets, or by an extrusion process. The sheets can then be molded into a desired shape.

Further, the sheets comprising foam material can be used to insulate typical containers. The sheets can be cut and attached to a portion of a container. For example, a piece of the sheet can be coupled to a typical paper based food container to form a thermally insulated container. It is contemplated that portions of the sheets having foam material can be used to insulate various types of containers or packaging.

In another embodiment, a paper based composite material can comprise foam material. The foam material can form any suitable portion of the paper based material. The foam material can be placed into paper based composite materials either with or without the presence of a polyhydroxyaminoether copolymer (PHAE), such as BLOX® resins available from Dow Chemical Corporation and Imperial Chemical Industries. In one embodiment, the foam material can be mixed with pulp to form a generally homogeneous mixture. The mixture can be formed into the desired shape through, for example, molding or a rolling process. The mixture can be heated before, during, or after the mixture is shaped, preferably by compression molding, to cause expansion of the foam material component (e.g., the expandable microspheres) of the mixture. Thus, the foam material can be used to form a composite structure or container comprising expanded microspheres and pulp. In one arrangement, the structure or container can have PHAEs, such as BLOX®. Thus, the structures comprising the foam material can have any treatment, coating, or other means for providing the desired characteristics. In another embodiment, the foam material can form a coating on a paper or wood pulp based container. The coating can be heated to form an expanded coating (e.g., a coating in which a substantial portion of the coating comprises expanded microspheres).

In some embodiments, sheets comprising foam materials can be applied to an article and later processed to provide for further expansion of the foam material. For example, a foam label can be partially expanded. The partially expanded foam label can be coupled to a container. Then the container and foam label can be heated to allow for further expansion of the foam label. Optionally, compression molding techniques can be employed to emboss the labels.

FIG. 26B illustrates another article comprising foam material that can be formed by compression process. In some embodiments, the article 426 is in the form of a tray configured to hold foodstuff. The tray 426 can be formed from a sheet (e.g., sheet 389 or sheet 390) through thermoforming. Optionally, the tray 426 can be adapted to fit within a container or box. In some embodiments, the tray 426 can be suitable for contacting foodstuff, such as meat, produce, and the like. For example, the tray 426 can have a food contacting surface made from phenoxy type thermoplastics, polyester, and the like. The tray 426 may comprise a barrier layer to prevent the passage of gases through the tray. Thus, the tray 426 can be made of similar materials as the articles, preforms and containers described above.

The tray 462 can be configured for thermal processing, such as for heating and reheating. The compression molds can form a desired microstructure of the tray 462. For example, the tray 462 may comprise crystalline material (e.g., crystalline PET) to enhance thermal stability of the tray 462. During the thermoforming process one or more layers of the tray can be heated above a predetermined temperature to cause crystallization of at least one of the layers. For example, the mandrel or core of the compression mold can be used to cause crystallization. Thus, at least a portion of the tray 462 can be crystallized during the manufacturing process. Additionally, the compression mold can be heated to cause expansion of foam material. The compression molds can have temperature control system comprising cooling or heating channels as described above. Thus, a compression mold can be used to form foam material and/or crystalline material. In some embodiments, the tray 462 can comprise a mono or multilayer sheet. The tray 462 can have a first layer of thermoplastic material and a second layer (e.g., foam). The first layer can comprise PET (e.g., amorphous, partially crystallized, or fully crystallized). The first and second layer can be formed by selectively controlling the temperature of the compression molds.

The foam material can be applied to the surface of an article for providing thermal insulation. The foam material can be used to coat at least a portion of the article. The foam material can be applied to the article by using various non-compression coating techniques. For example, the article can be a profile or bottle that is coated using the apparatus and methods disclosed in U.S. Pat. Nos. 6,391,408; 6,676,883; and U.S. patent application Ser. No. 10/705,748. Further, multiple layers of foam material can be applied to increase the thermal insulation of the article. For example, a bottle having a single foam layer can be coated with one or more additional foam layers resulting in a bottle having multiple foam layers.

1. Method and Apparatus of Making Crystalline Material

Compression molds can be used to produce preforms having a crystalline material. While a non-crystalline preform is preferred for blow-molding, a bottle having greater crystalline character is preferred for its dimensional stability during a hot-fill process. Accordingly, a preform constructed according to preferred embodiments has a generally non-crystalline body portion and a generally crystalline neck portion. To create generally crystalline and generally non-crystalline portions in the same preform, one needs to achieve different levels of heating and/or cooling in the mold in the regions from which crystalline portions will be formed as compared to those in which generally non-crystalline portions will be formed. The different levels of heating and/or cooling are preferably maintained by thermal isolation of the regions having different temperatures. In some embodiments, this thermal isolation between the thread split, core and/or cavity interface can be accomplished utilizing a combination of low and high thermal conduct materials as inserts or separate components at the mating surfaces of these portions.

The cooling of the mold in regions which form preform surfaces for which it is preferred that the material be generally amorphous or semi-crystalline, can be accomplished by chilled fluid circulating through the mold cavity and core. In preferred embodiments, a mold set-up similar to conventional injection molding applications is used, except that there is an independent fluid circuit or electric heating system for the portions of the mold from which crystalline portions of the preform will be formed.

The molding systems of FIGS. 28-47 can be configured to produce preforms having crystalline material. In the illustrated the cavity section 508 includes the body mold 529 comprising several channels 528 through which a fluid, preferably chilled water, is circulated. The neck finish mold 520 has one or more channels 521 in which a fluid circulates. The fluid and circulation of 528 and channels 521 are preferably separate and independent.

The thermal isolation of the body mold 529, neck finish mold 520 and core section is achieved by use of inserts or having low thermal conductivity. Examples of preferred low thermal conductivity materials include heat-treated tool steel (e.g. P-20, H-13, Stainless etc.), polymeric inserts of filled polyamides, nomex, air gaps and minimum contact shut-off surfaces.

In this independent fluid circuit through channels 521, the fluid preferably is warmer than that used in the portions of the mold used to form non-crystalline portions of the preform. Preferred fluids include water, silicones, and oils. In another embodiment, the portions of the mold which forms the crystalline portions of the preform, (corresponding to neck finish mold 520) contain a heating apparatus placed in the neck, neck finish, and/or neck cylinder portions of the mold so as to maintain the higher temperature (slower cooling) to promote crystallinity of the material during cooling. Such a heating apparatus can include, but is not limited to, heating coils, heating probes, and electric heaters. Additional features, systems, devices, materials, methods and techniques are described in patent application Ser. No. 09/844,820 (U.S. Publication No. 2003-0031814) which is incorporated by reference in its entirety and made a part of this specification. Additionally, the channels 521 can be used to heat the molds and cause expansion of foam material.

F. Preferred Articles

Generally, preferred articles described herein include articles comprising one or more materials. The material(s) may form one or more layers of the articles. The layers of the articles may preferably provide some functionality and may be applied as multiple layers, each layer having one or more functional characteristics, or as a single layer containing one or more functional components. The articles may be in the form of packaging, such as preforms, closures, containers, etc. The materials, methods, ranges, and embodiments disclosed herein are given by way of example only and are not intended to limit the scope of the disclosure in any way. The articles disclosed herein can be formed with any suitable material disclosed herein. Nevertheless, some articles and materials are discussed below. In view of the present disclosure, embodiments and materials can be modified by a skilled artisan to produce other alternative embodiments and/or uses and obvious modifications and equivalents thereof

1. General Description of Preferred Materials Forming Articles

a. Non-limiting Articles Comprising Foam Material

Articles may comprise foam material. In some non-limiting embodiments, foam material can form a portion of an article, such as the body or neck finish of a preform. In some non-limiting embodiments, foam material comprises less than about 90% by weight, also including less than about 10%, 20%, 30%, 40%, 50%, 60%, 70%, 80% by weight, of the article (such as a preform, closures, container, sheet, etc.). In some non-limiting embodiments, the foam material comprises about 5-30% by weight of the article. In some non-limiting embodiments, the foam material comprises about 20%-60% by weight of the article. In some non-limiting embodiments, the foam material comprises about 10%-30% by weight of the article. In some embodiments, the foam material comprises more than about 90% by weight of the article. The foam material can form most or all of the article. The foam material may result in reduced weight articles as compared to conventional articles and therefore may desirably reduce the transportation cost of the articles. Additionally, foam material can reduce the amount of material that is used to form the articles, since the foam material may have a substantial number of voids.

The foam material can be made from expandable material. For example, at least a portion of an article can comprise expandable that has a first density that is reduced when the expandable material is expanded. In some non-limiting embodiments, a first material, preferably expandable material, has a first density and the second material, preferably foam material, made from the first material has a second density. The second density is less than about 95%, 90%, 80%, 70%, 50%, 30%, 20%, 10%, 5%, 2%, 1%, and ranges encompassing such percentages of the first density. In some non-limiting embodiments, the second density is in the range of about 30% to 60% of the first density. Thus, foam material with a low density relative to an expandable material can be made.

It is contemplated that articles may comprise any suitable amount of foaming agent including those above and below the particular percentages recited above, depending on the desired use of the articles.

b. Non-limiting Articles Comprising Phenoxy Type Thermoplastic Material

Articles may comprise phenoxy type thermoplastics, such as phenoxy and blends (e.g., polyolefin-phenoxy blend), PET-phenoxy, and combinations thereof). In some non-limiting embodiments, the phenoxy type thermoplastic can form a portion of the article, such as at least a portion of the interior surface of the preform, closure, container, etc. In some non-limiting embodiments, the phenoxy type thermoplastic comprises less than about 30% by weight, also including less than about 1%, 2%, 5%, 7.5%, 10%, 12%, 15%, 20%, 25%, 50% by weight, of the article. In another non-limiting embodiment, the phenoxy type thermoplastic comprises about 1-4% by weight of the article. In another non-limiting embodiment, the phenoxy type thermoplastic comprises about 1-15% by weight of the article. In another non-limiting embodiment, the phenoxy type thermoplastic comprises about 7-25% by weight of the article. In another non-limiting embodiment, the phenoxy type thermoplastic material comprises about 5-30% by weight of the article. In some embodiments, the phenoxy type thermoplastic forms a discrete layer or a layer blended with another material. In some embodiments, a discrete layer comprises phenoxy type thermoplastic that forms about 0.1% to 1% by weight of the article. In some embodiments, a discrete layer comprise phenoxy type thermoplastic that forms about 0.1% to 1% by weight of the article. In some embodiments, the phenoxy type thermoplastic is blended with a polymer material (e.g., PET, polyolefin, combinations thereof) and can comprise more than about 0.5%, 1%, 2%, 5%, 7.5%, 10%, 12%, 15%, 20%, 25%, 50%, 70% by weight of the article. It is contemplated that these percentages can be by volume in certain embodiments. The phenoxy type thermoplastic may result in articles having one or more of the following properties: desirable flavor scalping, color scalping, oxygen barrier, recyclable, and/or other properties especially well suited for food contact. These percentages may result in effective desirable characteristics while minimizing the amount of phenoxy type thermoplastic used, thus providing a cost effective article.

Various combinations of phenoxy type thermoplastic with polyethylene, polypropylene, foam material, and the like can be used to produce preforms, containers, and other packaging of relatively larger sizes and having desirable characteristics, especially when the phenoxy type thermoplastic forms the surface of the packaging that contacts foodstuffs. Phenoxy type thermoplastics can provide desirable adhesive between a layer comprising PET and a layer comprising PP.

It is contemplated that articles may comprise any suitable amount of phenoxy type thermoplastics including those above and below the particular percentages recited above, depending on the desired use of the articles.

2. Articles In the Form of Preforms/Containers

Foam material may form one or more portions of layers of the articles (such as packaging including preforms and containers). The preform 30 of FIG. 1 can comprise a foam material. In some embodiments, the preform 30 comprises mostly foam material. In some embodiments, the preform 30 can comprise a phenoxy type thermoplastic formed through a molding process. For example, the preform 30 may comprise mostly a phenoxy type thermoplastic. In some embodiments, the preform 30 may be formed by a co-injection process, wherein the interior portion and exterior portions of the preform 30 comprise different materials. The co-injected material can be compressed into a desired shape. For example, the preform 30 may have an interior portion that comprises one or more of the following: phenoxy type thermoplastic, PET, PETG, expandable/foam materials or the like. The outer portion of the preform 30 can comprise one or more of the following: polyethylene, polypropylene (including clarified polypropylene), PET, combinations thereof, and the like. Optionally, a portion of the preform 30 may comprise foam material.

In some embodiments, the preform 30 can be coated with a layer to enhance its barrier characteristics. For example, the preform 30 can be coated with a barrier material. For example, U.S. application Ser. No. 10/614,731 (Publication No. 2004-0071885), which is incorporated in its entirety and describes systems and methods of coating preforms. This system and other systems disclosed or incorporated herein can be employed to form a barrier layers described herein. The coated preform can then be overmolded with another material to form an outer layer.

With respect to FIG. 5, the preform 50 can comprises an uncoated preform 39 coated with a foam layer 52. Preferably, the uncoated preform 39 comprises a polymer material, such as polypropylene, polyester, PET, PETG, phenoxy type thermoplastics, and/or other thermoplastic materials. In one embodiment, for example, the uncoated preform 39 substantially comprises polypropylene. In another embodiment, the uncoated preform 39 substantially comprises polyester.

The foam layer 52 may comprise either a single material or several materials (such as several microlayers of at least two materials). In some non-limiting embodiments, the foam layer 52 can comprise about 2%, 5%, 10%, 20%, 30%, 40%, 50%, 60%, 70%, 80%, 90%, and ranges encompassing such percentages of the preform. In some embodiments, the foam layer 52 comprises about 2% to about 90% of the preform. In some non-limiting embodiments, the foam layer 52 can comprise about 5% to about 50% of the preform. In some embodiments, the foam layer 52 comprises about 10% to about 30% of the preform. In some non-limiting embodiments, the foam layer 52 can comprise about 5% to about 25% of the preform. In some non-limiting embodiments, the foam layer 52 can comprise less than about 20% of the preform. It is contemplated that these percentages can be by weight or by volume in different embodiments. The foam layer 52 may comprise foam material that is not expanded. The outer layer 52 of the preform 50 may have a thickness, preferably the average wall thickness, of about 0.2 mm (0.008 inches) to about 0.5 mm (0.02 inches). In another non-limiting embodiment, the outer layer 52 has a thickness of about 0.3 mm (0.012 inches). In some embodiments, the average wall thickness is taken only along the body portion of the preform 50. In some non-limiting embodiments, the outer layer 52 comprises less than about 90% of the average thickness of a wall of the preform 50, also including less than about 80%, 70%, 60%, 50%, 40%, 30%, 20%, 10%, 9%, 8%, 7%, 6%, 5% of the average thickness of a wall of the preform 50.

The foam layer 52 may comprise microspheres that are either not expanded or partially expanded, for example. Further, the foam layer 52 can be generally homogenous or generally heterogeneous. Although not illustrated, the foam layer 52 can form other portions of the preform 50. For example, the foam layer 52 can form at least a portion of the inner surface of the preform 50 or a portion of the neck portion 32.

In some embodiments, the inner layer 54 can comprise one or more of the following: polyethylene, PET, polypropylene (e.g., foamed polypropylene, non foamed polypropylene, clarified polypropylene), combinations thereof, and the like. For example, the preform 50 can comprise an outer layer 52 of polypropylene (preferably foamed) and an inner layer 54 comprising PET. Optionally, a tie layer can be interposed between the layers 52, 54 and may comprise a phenoxy type thermoplastic.

In some embodiments, a barrier layer can be interposed between the layers 52, 54. The barrier layer can inhibit or prevent egress and/or ingress of one or more gases, UV rays, and the like through the walls of a container made from the preform 50.

In some embodiments, second layer 54 comprises polypropylene. The polypropylene may be grafted or modified with maleic anhydride, glycidyl methacrylate, acryl methacrylate and/or similar compounds to improve adhesion. In one embodiment, the polypropylene further comprises nanoparticles. In a further embodiment, the polypropylene comprises nanoparticles and is grafted or modified with maleic anhydride, glycidyl methacrylate, acryl methacrylate and/or similar compounds.

With reference to FIG. 6, the container 83 can be used as a carbonated beverage container, the thickness 44, preferably the average wall thickness, of the outer layer 52 of the container 83 that is about 0.76 mm (0.030 inch), 1.52 mm (0.060 inch), 2.54 mm (0.10 inch), 3.81 mm (0.15 inch), 5.08 mm (0.2 inch), 6.35 mm (0.25 inch), and ranges encompassing such thicknesses. In some embodiments, the outer layer is preferably less than about 7.62 mm (0.3 inch), more preferably about 1.27mm (0.05 inch) to 5.08 mm (0.2 inch). The outer layer 52 may comprise foam material having a thickness more than about 3.81 mm (0.15 inch). In some non-limiting embodiments, the outer layer 52 has a thickness in the range of about 0.127 mm (0.005 inch) to about 0.635 mm (0.025 inch).

In some non-limiting embodiments, the thickness 46 of the inner layer 54, preferably the average thickness, of the inner layer 54 is preferably about 0.127 mm (0.005 inch), 0.635 mm (0.025 inch), 1.07 mm (0.040 inch), 1.52 mm (0.060 inch), 2.03 mm (0.080 inch), 2.54 mm (0.100 inch), 3.05 mm (0.120 inch), 3.56 mm (0.140 inch), 4.07 mm (0.160 inch), and ranges encompassing such thicknesses. In some embodiments, the inner layer 54 of the container 83 has a thickness of less than about 2.54 mm (0.1 inch) to provide a cost effective food barrier. In some non-limiting embodiments, the inner layer 54 has a thickness in the range of about 0.127 mm (0.005 inch) to about 0.635 mm (0.025 inch). The overall thickness 48 of the wall of the container can be selected to achieve the desired properties of the container 83.

To enhance barrier characteristics of the container 83, the container 83 can have a barrier layer. On or more barrier layers can be formed on the interior surface of the inner layer 54, between the layers 52, 54, on the exterior of the outer layer 52, and the like. For example, the outer layer 52 of the container (or the preform that makes the container 83 ) can be coated with barrier material by using methods disclosed herein. For example, the barrier layer can be formed by using apparatuses, methods, and systems disclosed in U.S. application Ser. No. 10/614,731 (Publication No. 2004-0071885), which is incorporated in its entirety. Additionally, in some embodiments, the container 82 comprises substantially closed cell foam that may inhibit the migration of fluid through the foam. For example, the foam can be a barrier that inhibits, preferably prevents, migration of CO₂ gas through the wall 84 of the container 83 formed from the preform.

The preform 60 of FIG. 11 has an inner layer 164 that comprises a first material and the outer layer 162 preferably comprises another material. In some non-limiting embodiments, the layer 162 can comprise about 2%, 5%, 10%, 20%, 30%, 40%, 50%, 60%, 70%, 80%, 90%, and ranges encompassing such percentages of the preform. In some embodiments, the foam layer 162 comprises less than about 97% of the preform. In some embodiments, the layer 162 comprises about 5% to about 99% of the preform. In some non-limiting embodiments, the layer 162 can comprise less than about 90% of the preform. In some non-limiting embodiments, the layer 162 can comprise about 40% to 80% of the preform. In some non-limiting embodiments, the layer 162 can comprise about 60% to 90% of the preform. In some non-limiting embodiments, the layer 162 can comprise more than about 60% of the preform. It is contemplated that these percentages can be by weight or by volume in different embodiments. In some embodiments, the outer layer 162 can comprise foam material and the inner layer 164 can comprise a polymer material, such as PET (e.g., virgin or post-consumer/recycled PET). The foam layer 162 may comprise foam material that is not expanded. For example, the foam layer 162 may comprise microspheres that are either not expanded or partially expanded, for example. The foam layer 162 may provide a desirable insulating layer when the preform 160 is molded into a container.

Preferably, a substantial portion of the outer layer 162 comprises foam material and a substantial portion of the inner layer 164 comprises PET or other material for contacting foodstuffs. In one non-limiting embodiment, the foam material comprises PP and expandable microspheres. In yet another embodiment, the outer layer 162 comprises PP and the inner layer 164 can comprise PET. Preferably, a substantial portion of the outer layer 162 comprises PP and a substantial portion of the inner layer 164 comprises PET. In one non-limiting embodiment, the outer layer 162 comprises generally entirely PP. In yet another embodiment, substantial portions of the inner layer 164 and outer layer 162 can comprise foam material. The preforms 76, 132 may similarly comprise foam material and material suitable for contacting foodstuffs.

In some embodiments, the inner layer 164 may comprise one or more of the following: PET, phenoxy type thermoplastic (including blends), foam material (e.g., foamed PET), and/or other coating/layer suitable for contacting foodstuff. The outer layer 162 may comprise one or more of the following: foam material (including foamed PP, foamed PET, etc.), non foamed material (e.g., phenoxy type-thermoplastics, PET, PP), or other material suitable for forming the outer portion of a preform. In some embodiments, the preform 160 comprises a phenoxy type thermoplastic. In some non-limiting embodiments, the phenoxy type thermoplastic can comprise less than about 1%, 2.5%, 5%, 10%, 20%, 30%, 50%, 60%, 70%, 80%, 90%, and ranges encompassing such percentages of the preform. In some embodiments, the phenoxy type thermoplastic material comprises about 10% to 30% by weight of the preform. In some embodiments, the phenoxy type thermoplastic material comprises most of or all of the preform. The weight is for phenoxy type thermoplastic in a discrete or blend form. It is contemplated that these percentages can be by weight or by volume in different embodiments. For example, in some embodiments the layer 164 comprises phenoxy type thermoplastic that forms less than 10% of the preform. The layer 164 can have a thickness suitable for forming a food contacting layer. The thickness 174 of the inner layer 164 is preferably less than about 3.81 mm (0.150 inch) to form a cost effective food contacting layer. The thickness 174 of the inner layer 164 may be less than about 0.01 mm (0.0004 inch), 0.02 mm (0.0007 inch), 0.05 mm (0.002 inch), 0.10 mm (0.004 inch), 0.15 mm (0.006 inch), 0.20 mm (0.008 inch), 0.30 mm (0.01 inch), 0.5 mm (0.019 inch), and ranges encompassing such thicknesses. In some non-limiting embodiments, the inner layer 174 comprising phenoxy type thermoplastic having a thickness in the range of about 0.01 mm (0.0004 inches) to about 0.05 mm (0.002 inches). In some embodiments, the preform 160 may be formed by an molding process, wherein the interior portion and exterior portions of the preform comprise different materials.

In some embodiments, the outer layer 162 comprises a first material and the inner layer 164 preferably comprises another material. For example, the outer layer 162 can comprise polypropylene and the inner layer 64 can comprise PETG. In another embodiment, the polypropylene may be grafted or modified with maleic anhydride, glycidyl methacrylate, acryl methacrylate and/or similar compounds to improve adhesion. In one embodiment, the polypropylene further comprises nanoparticles. In a further embodiment, the polypropylene comprises nanoparticles and is grafted or modified with maleic anhydride, glycidyl methacrylate, acryl methacrylate and/or similar compounds.

The preform 180 (FIG. 12) may have the inner layer 184 that is similar or identical to the inner layer 164 and the outer layer 182 that is similar or identical to the outer layer 162. The preform 190 (FIG. 13) may have the inner layer 194 that is similar or identical to the inner layer 164 and the outer layer 199 that is similar or identical to the outer layer 162. The materials forming the inner layer 194 and the outer layer 199 can be selected to provide desirable interaction with the locking structure 197. The preform 202 (FIG. 14) may have layers formed of similar or identical materials as the preform 160.

The preforms and resulting containers may be particularly well suited for thermal applications, such as hot-fill processes. The container 211 of FIG. 14A can generally maintain its shape during hot-fill processes. After blow molding or hot-filling, the final dimensions of the neck portion 132 of the container 211 are substantially identical to the initial dimensions of the preform. Additionally, this results in reduced dimension variations of the threads on the neck finish. For example, the inner layer 283 can be formed of a material for contacting foodstuffs, such as PET. The outer layer 203 can comprise moldable materials (e.g., mostly or entirely of PP, PP and a foaming agent, crystalline PET, lamellar material, homopolymers, copolymers, and other materials described herein) suitable for hot-filling. The outer layer 203 provides dimensional stability to the neck finish 132 even during and after hot-filling. The width of the outer layer 203 can be increased or decreased to increase or decrease, respectively, the dimensional stability of the neck finish 132. Preferably, one of the layers forming the neck finish 132 comprises a material having high thermal stability; however, the neck finish 132 can also be made of materials having low temperature stability, especially for non hot-fill applications.

Additionally, the dimensional stability of the outer layer 203 ensures that the closure 213 remains attached to the container 211 of FIG. 14A. For example, the outer layer 203 of PP can maintain its shape thereby preventing the closure 213 from unintentionally decoupling from the container 211.

The preforms described above can be modified by adding one or more layers to achieve desired properties. For example, a barrier layer can be formed on the body portions of the preforms.

3. Articles In the Form of Closures

Closures may comprise foam material. In some non-limiting embodiments, the foam material comprises less than about 95% by weight, also including less than about 5%, 15%, 25%, 35%, 45%, 55%, 65%, 75%, 85%, and ranges encompassing such percentages of the closure. It is contemplated that these percentages can be by weight or by volume in different embodiments. In some embodiments, foam material comprising ranges encompassing these percentages by weight of the closure. In one non-limiting embodiment, the foam material comprises about 45-60% by weight of the closure. In another non-limiting embodiment, the foam material comprises about 15-70% by weight of the closure. In some embodiments, the closure comprises mostly or entirely of foam material. For example, the closure can be a monolayer closure that is made from foam material.

With reference to FIG. 19, at least a portion of the closure 302 comprises a foam material. The layer 314 and/or the outer portion 311 may comprise foam material (e.g., foamed PET, foamed PP, etc.). In one embodiment, the outer portion 311 comprises foam material and the layer 314 comprises non-foamed material (such as PP, PET, etc.).

Additionally, the inner portion of the closures may comprise foam material. In some embodiments, the outer portions of closures may or may not comprise foam material. The closures of FIGS. 21A to 21E may have similar or different inner and outer layers (or outer portions).

FIG. 21C illustrates the closure 360 that may have an intermediate layer 364 formed of materials that have desired structural, thermal, optical, barrier and/or characteristics. For example, the layer 364 can be formed of PET, PP, PET, PETG, and/or the like.

In one embodiment, a further advantage is provided where the outer portion of the closure is formed of foam material to provide a comfortable gripping surface so that a user can comfortably remove the closure from a container. The outer portion 311 of FIG. 19 can be foam to increase the space occupied by the outer portion 311 and can provide the user with greater leverage for easy opening and closing of the closure device.

The closures can have an internally threaded surface that is configured to threadably mate with an externally threaded surface of the container. The enlarged outer portion 311 of FIG. 19 can provide increased leverage such that the user can easily rotate the closure 302 onto and off of the container. Advantageously, the similar, or same, amount of material that forms a conventional cap can be used to form the enlarged diameter closure device. Thus, the cost of materials for producing the closure 302 can be reduced.

Closures may comprise phenoxy type thermoplastic materials. In some non-limiting embodiments, the phenoxy type thermoplastic material comprises less than about 25% by weight, also including less than about 1%, 2%, 4%, 5%, 10%, 15%, 20% by weight, of the closure. In some embodiments, phenoxy type thermoplastic material comprising ranges encompassing these percentages by weight of the closure. The weight is for phenoxy type thermoplastic in discrete or blend form. In one non-limiting embodiment, the phenoxy type thermoplastic material comprises about 0.5 to 5% by weight of the closure. In another non-limiting embodiment, the phenoxy type thermoplastic material comprises about 1 to 6% by weight of the closure.

The phenoxy type thermoplastic can form at least a portion of the interior surface of the closure. For example, a phenoxy type thermoplastic layer can be deposited on the interior surface 309 of the layer 314 (FIG. 19). Optionally, the layer 314 can be made of a phenoxy type thermoplastic. The phenoxy type thermoplastic can form at least a portion of the layer 344 of the closure 340 (FIG. 21A), the layer 356 of the closure 350 (FIG. 21B), the layer 366 and/or layer 364 of the closure 360 (FIG. 21C), the layer 374 of the closure 370 (FIG. 21D), the layer 383 of the closure 380 (FIG. 21E), for example. Of course, these layers may comprise material (e.g., lamellar material, PET, PP, and/or the like) that is coated with a phenoxy type thermoplastic, such a phenoxy or polyolefin-phenoxy blend.

The closures described above can have one or more barrier layers to enhance its barrier characteristics. For example, an inner layer, one or more intermediate layers, and/or exterior barrier layers can be formed by using systems and methods disclosed in U.S. application Ser. No. 10/614731 (Publication No. 2004-0071885), which is incorporated in its entirety and describes systems and methods of forming barrier layers. In some embodiments, the materials of the closures can be modified to enhance barrier characteristics. For example, foam material may have additives (e.g., microparticulates) that improve the barrier characteristics of the foam material. A skilled artisan can select the design of the closures to achieve the desired barrier properties.

4. Articles with Tie Layers

Exemplary articles can be multilayer articles. A tie layer can be disposed between one or more portions or layers of the articles. For example, articles can have a tie layer interposed between layers of materials. Articles can have a plurality of tie layers, preferably one of the tie layers is positioned between a pair of adjacent layers. In some embodiments, a plurality of pairs of adjacent layers each have interposed therebetween one of the tie layers.

The container 83 of FIG. 6 can have a tie layer 85 (FIG. 7) between the layer 52 and the layer 54. In some non-limiting embodiments, the layer 52 comprises one or more of the following: foam material (including foamed PP, foamed PET, etc.), non foamed material (e.g., phenoxy type-thermoplastics, PET, PP), combinations thereof, or other material suitable for forming the outer portion of a preform. The layer 54 comprises one or more of the following: PET, phenoxy, polyolefin-phenoxy blend, combinations thereof, or other suitable materials suitable for forming a portion of the wall of a container. In some embodiments, outer layer 52 comprises PP (foamed or unfoamed) and the inner layer 54 comprises PET. The tie layer 85 may comprise adhesives, phenoxy type thermoplastics, polyolefins, or combinations thereof (e.g., polyolefin-phenoxy blend). The tie layer 85 can advantageously adhere to both of the layers 52, 54. Phenoxy may provide desirable adhesion between an inner layer 54 comprising PET and an outer layer 52 comprising PP, for example.

The multilayer articles illustrated in FIGS. 8-14B and 18-21E can have one or more tie layers, preferably one tie layer, is between at least two of the layers of the articles. For example, a tie layer can be interposed between the layers 52, 54 of the preform 76 (FIG. 9). A tie layer can be interposed between the layers 134, 136 and/or the preform 30 and the layer 134 of FIG. 10. The preform 160 (FIG. 11) can have a tie layer interposed between the layer 164 and the layer 162. The preform 180 (FIG. 12) can have a tie layer interposed between the layer 184 and the layer 183. The preform 190 (FIG. 13) can have a tie layer interposed between the layer 194 and the layer 199. The preform 202 (FIG. 14) can have a tie layer interposed between the layer 203 and the layer 283.

With respect to FIG. 19, the closure 302 can have a tie layer between the layer 314 and the outer portion 311. In some non-limiting embodiments, the outer portion 311 comprises one or more of the following: foam material (including foamed PP, foamed PET, etc.), non-foamed material (e.g., phenoxy type-thermoplastics, PET, PP), combinations thereof, or other materials suitable for forming the outer portion of a closure. The layer 314 comprises one or more of the following: PET, phenoxy, polyolefin-phenoxy blend, combinations thereof, or other suitable materials suitable for forming a portion of the closure. The tie layer may comprise adhesives, phenoxy, polyolefin, combinations thereof (e.g., polyolefin-phenoxy blend). Similarly, the closures illustrated in FIGS. 21A-21E can likewise have one or more tie layers, preferably at least one tie layer is between a pair of adjacent layers.

A further advantage is provided wherein a tie layer comprising a phenoxy type thermoplastic, such as a phenoxy blend, which can help compatibilization of a somewhat pure phenoxy layer and another layer. Phenoxy can effectively compatibilize with polypropylene, polyethylene, and the like.

In view of the present disclosure, a skilled artisan can select various material(s) and tie layer(s) to achieve the desired properties of an article.

5. Articles Comprising Lamellar Material

Lamellar material may form one or more portions of layers of the articles (such as packaging including preforms, closures, and containers). Referring to FIG. 2, the preform 30 may comprise lamellar material. As FIG. 40 is an enlarged cross-sectional view of the wall section 43 of the preform 30. In the illustrated embodiment, the wall section 43 comprises lamellar material that includes one or more layers. Preferably, the lamellar material is made up of a plurality of microlayers. However, the layers of the lamellar material can have any suitable size based on the desired properties and characteristics of the preform, and the resulting container formed from the preform. The layers of wall section 43 can comprise generally similar or different materials to one another. One or more of the layers forming the wall section 43 can be made from materials disclosed herein, or other materials known in the art.

In the illustrated embodiment, the wall section 43 has an inner layer 47, an outer layer 45, and one or more intermediate layers 41 therebetween. In some embodiments, the inner layer 47 is suitable for contacting foodstuffs, such as virgin polyethylene terephtalate (“PET”), or other suitable material that can form the inner chamber of the bottle made from the preform 30.

Optionally, the wall section 43 can have at least one layer of a material with good gas barrier characteristics. In some embodiments, the wall section 43 of the preform 30 has a plurality of layers having good gas barrier characteristics. Advantageously, one or more layers of the wall section 43 that comprise a barrier material can inhibit or prevent ingress and/or egress of fluid through the wall of a container made from the preform 30. However, the wall section 43 can comprise a plurality of layers that do not have good barrier characteristics.

The wall section 43 of the preform 30 can have at least one layer formed from recycled or post-consumer PET (“RPET”). For example, in one embodiment, the wall section 43 can have the plurality of layers formed from RPET. In some embodiments, the inner layer 47 can be formed from virgin PET and other layers from the wall section 43 can be formed from virgin PET or RPET. Thus, the preform 30 can comprise alternating thin layers of PET, RPET, barrier material, and combinations thereof. Additionally, other materials can be used to obtain the desired characteristics and physical properties of the preform 30, or resulting container made from the preform 30.

Each of the layers of the wall section 43 can have generally the same thickness. Alternatively, the layers of the wall section 43 can have thicknesses that are generally different from each other. A skilled artisan can determine the desired number of layers, thickness of each layer, and composition of each layer of the wall section 43. In one non-limiting embodiment, the preform 30 can have a wall section 43 including more than two layers. In some preferred embodiments, the wall section 43 has more than three layers.

As shown in FIG. 40, the layers of the lamellar material forming the wall section 43 can be generally parallel to one of an inner surface 49 and an outer surface 51 of the preform 30. Portions of the lamellar material forming the body portion 34 can comprise layers that are generally parallel to the longitudinal axis of the preform 30.

The distance and/or orientation of the layers of the walls section 45 can vary or remain generally constant along the wall section 43. Additionally, the thicknesses of one or more layers of the wall section 43 also may vary, or they may be substantially constant along the preform 30. It is contemplated that one or more of the layers may have holes, openings, or diffuse into an adjacent layer.

Lamellar material can also form other monolayer and multilayer articles. Referring to FIG. 5, for example, the preform 50 can comprise an outer layer 52 and an inner layer 54 defining an interior surface of the preform 50. The outer layer 52 preferably does not extend to the neck portion 32, nor is it present on the interior surface of the preform 50 at least one of the outer layer 52 and the inner layer 54 can comprise lamellar material. In the illustrated embodiment, the outer layer 52 comprises lamellar material and the inner layer 54 comprises another material. Preferably, the inner layer 54 comprises PET, preferably virgin PET, so that the interior surface of the preform 50 is suitable for contacting foodstuffs. In another embodiment not illustrated, the inner layer 54 comprises lamellar material and the outer layer 52 comprises another material. Preferably, the inner layer 54 comprises PET that forms the interior surface. However, the inner layer 54 can comprise other materials described herein (e.g., foam material, PET including virgin PET and RPET, PP, etc.). Alternatively, both the inner layer 54 and the outer layer 52 can comprise lamellar material. Thus, various combinations of materials can be used to form the preforms disclosed herein.

The articles illustrated in FIGS. 6-17 may comprises multiple layers. One or more of the layers of these articles can comprise lamellar material. For example, the preform 60 illustrated in FIG. 8A comprises an outer layer 52 formed of lamellar material. The outer layer 52 covers the bottom surface of the support ring 38 and extends along the body portion 34.

Referring to FIG. 10, one or more of the layers 134 and 136 may comprise lamellar material. In one embodiment, for example, substantially the entire preform 132 is formed of different lamellar layers 134 and 136 that are adhered together. In some embodiments, at least one of the layers 134 and 136 comprises a lamellar material, foam material, phenoxy type thermoplastics, PET, PP (including foamed and non-foamed), and the like. Optionally, only one of the layers 134 and 136 may be formed of lamellar material.

Closures may also comprise lamellar material. The lamellar material can form a substantial portion of the closure or only a portion thereof. In some non-limiting embodiments, the lamellar material comprises less than about 95% by weight, also including less than about 5%, 15%, 25%, 35%, 45%, 55%, 65%, 75%, 85% by weight, of the closure. In some embodiments, lamellar material comprising ranges encompassing these percentages by weight of the closure.

As shown in FIG. 19, at least a portion of the closure 302 comprises a lamellar material. The layer 314 and/or the outer portion 311 may comprise lamellar material. In one embodiment, the outer portion 311 comprises lamellar material and the layer 314 comprises lamellar material (such as PP, PET, etc.). Additionally, the inner portion of the closures may comprise lamellar material. In some embodiments, the outer portions of closures may or may not comprise lamellar material. The closures of FIGS. 21A to 21E may have similar or different inner and outer layers (or outer portions).

FIG. 21C illustrates a closure 360 has the intermediate layer 364 that is formed of materials that have desired structural, thermal, optical, barrier and/or characteristics. For example, the layer 364 can be formed of lamellar material.

The lamellar material can form at least a portion of the layer 344 of the closure 340 (FIG. 21A), layer 356 of the closure 350 (FIG. 21B), layer 366 and/or layer 364 of the closure 360 (FIG. 21C), layer 374 of the closure 370 (FIG. 21D), layer 383 of the closure 380 (FIG. 21E), for example. The other portions of the closures can be formed of a similar material or different material. In some embodiments, the majority of or the entire closure comprises lamellar material.

6. Articles Comprising a Heat Resistance Layer

Articles described herein can comprise one or more heat resistant materials. As used herein the phrase “heat resistant materials” is a broad phrase and is used in its ordinary meaning and includes, without limitation, materials that may be suitable for hot-fill or warm-fill applications. For example, the heat resistant material may include high heat resistant material that has dimensional stability during a hot-fill process. The heat resistant material may include a mid heat resistant material that has dimensional stability during a warm-fill process. Heat resistant materials may include, but are not limited to, polypropylene, crystalline material, polyester, and the like. In some embodiments, heat resistant material has greater thermal dimensional stability then amorphous PET. Heat resistant material can form a portion of articles (e.g., one or more layers of a preform, container, closure, sheet, and other articles described herein.)

In some embodiments, a container comprises an inner layer, comprising a thermoplastic polyester, an outer layer, comprising a thermoplastic material (e.g., a polymer heat resistant material) having a heat resistance greater than that of the thermoplastic polyester of the inner layer, and an intermediate tie layer, providing adhesion between the inner layer and the outer layer, where the layers are co extruded prior to blow molding. Preferably, the thermoplastic polyester of the inner layer is PET, and may further comprise at least one of an oxygen scavenger and a passive barrier material blended with the thermoplastic polyester. Preferably, the passive barrier material is a polyamide, such as MXD 6.

In view of the present disclosure, a skilled artisan can select various types of lamellar or other material(s) described herein to achieve the desired properties of an article made therefrom. The articles disclosed herein may be formed through any suitable means. For example, the articles can be formed through injection molding, blow molding, injection blow molding, extrusion, co-extrusion, and injection stretch blow molding, and other methods disclosed herein. The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments disclosed herein. Similarly, the various features and steps discussed above, as well as other known equivalents for each such feature or step, can be mixed and matched by one of ordinary skill in this art to perform methods in accordance with principles described herein. Additionally, the methods which are described and illustrated herein are not limited to the exact sequence of acts described, nor a skilled artisan can select various types of lamellar material(s) to achieve the desired properties of an article made therefrom. The articles disclosed herein may be formed through any suitable means. For example, the articles can be formed through injection molding, blow molding, injection blow molding, extrusion, co-extrusion, and injection stretch blow molding, and other methods disclosed herein. The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein. Instead, Applicant intends that the scope of the invention be limited solely by reference to the attached claims, and that variations on the methods and materials disclosed herein which are apparent to those of skill in the art will fall within the scope of Applicant's invention.

1. A method of forming at least a portion of a preform or closure comprising:
producing lamellar material;
depositing said lamellar material in a mold cavity section; and
moving a core section having a core relative to the mold cavity section to compress the lamellar material between the core and the mold cavity section, the core section and the mold cavity section having an open and a closed position, the core and the mold cavity section cooperate to define a cavity in the shape of at least a portion of a preform or closure when in the closed position.

2. The method of claim 1, wherein the lamellar material is deposited into the mold cavity section by an extruder output positioned above the mold cavity section.

3. The method of claim 1, wherein the lamellar material is deposited into the mold cavity section by injecting lamellar material through an injection gate and into the mold cavity section.

4. The method of claim 1, wherein the core is moved relative to the mold cavity section to compress the lamellar material after the lamellar material is deposited into the mold cavity.

5. The method of claim 1, wherein the core section is moved along a line of action relative to the mold cavity section to compress the lamellar material, the lamellar material comprises a plurality of microlayers, and a substantial portion of layers of the plurality of microlayers is substantially perpendicular to the line of action when the lamellar material is deposited into the mold cavity section.

6. The method of claim 1, wherein the lamellar material comprises a plurality of microlayers that are generally parallel to one another after the lamellar material is compressed into the shape of a preform.

7. The method of claim 1, wherein the lamellar material comprises a barrier material.

8. The method of claim 1, wherein the core and the mold cavity section compress the lamellar material as the core is inserted and advanced into the mold cavity section to the closed position.

9. The method of claim 1, wherein the lamellar material is delivered simultaneously to a plurality of mold cavity sections.

10. The method of claim 1, wherein the lamellar material is delivered to a first set of cavity sections for a first time period and another set of cavity sections for another time period.

11. A compression molding system for producing multilayer articles, the system comprising:
a mandrel movable between an open position and a closed position;
a mold cavity configured to receive the mandrel, the mold cavity and the mandrel cooperate to define a cavity in a shape of a preform; and
a material source configured to drop lamellar material suitable for molding into the mold cavity.

12. A method of forming at least a portion of a preform, the method comprising:
producing foam material;
depositing said foam material in a mold cavity section, the foam material expanding in the mold cavity section;
providing a core and a mold cavity section having an open and closed position, the core and mold cavity section cooperate to define a cavity in the shape of at least a portion of a preform when in the closed position; and
after depositing the foam material into the mold cavity section, moving the core into the mold cavity section and compressing the foam material therebetween to form at least a portion of a preform.

13. The method of claim 12, wherein the foam material comprises expandable microspheres.

14. The method of claim 12, wherein the foam material in the cavity is cooled and forms a layer of a multilayer preform.

15. The method of claim 12, wherein the foam material is compressed between a substrate preform held by the core and a surface of the cavity section to form a layer of foam material on the substrate preform.

16. The method of claim 12, wherein the foam material is compressed between the core and an interior surface of a substrate preform positioned in the cavity section to form a layer of foam material on the substrate preform.

17. The method of claim 12, wherein the foam material is delivered simultaneously to a plurality of cavity sections.

18. The method of claim 12, wherein the foam material is delivered to a first set of cavity sections for a first time period and another set of cavity sections for another time period.

19. A method of forming a preform comprising:
providing a first core and a first mold cavity section that cooperate to define a first cavity in the shape of at least a portion of a preform when in a closed position;
producing a first melt;
depositing said first melt in the first mold cavity section;
moving the first core relative to the first mold cavity section to compress the first melt to form at least a portion of a preform;
moving the first core out of the first mold cavity section;
producing a second melt; and
compressing the second melt between the at least a portion of the preform and one of a second core and a second mold cavity section.

20. The method of claim 19, further comprising:
providing a first turntable comprising the first core and the first mold cavity section and a second turntable comprising the one of the second core and the second mold cavity section; and
transporting the at least a portion of the preform from the first turntable to the second turntable.

21. The method of claim 20, wherein the first turntable is rotatable about a first axis and comprises a plurality of first cores and a plurality of first mold cavity sections, each first core is moveable relative to a corresponding first mold cavity section between an open position and a closed position, and the plurality of first mold cavity sections are arranged in a circular pattern.

22. The method of claim 20, wherein the second turntable is rotatable about a second axis and comprises a plurality of second cores and a plurality of second mold cavity sections, each second core is moveable relative to a corresponding second mold cavity section between an open position and a closed position, and the plurality of second mold cavity sections are arranged in a circular pattern.

23. The method of claim 19, wherein the second melt is deposited into the at least a portion of a preform that is positioned in the first mold cavity section, and advancing the second core into the at least a portion of a preform to compress the second melt to form a layer over the at least a portion of the preform.

24. The method of claim 19, further comprising:
removing the at least a portion of the preform from the first cavity section;
depositing the second melt into the second cavity section; and
advancing the at least a portion of the preform into the second cavity portion to compress the second melt to form a layer over the at least a portion of the preform.

25. The method of claim 19, further comprising:
rotating a turntable that comprises a plurality of first cavity sections; and
rotating a plurality of first cores in unison with the plurality of first cavity sections as the first melt is compressed.

26. The method of claim 19, further comprising:
rotating a turntable that comprises a plurality of second cavity sections; and
rotating a plurality of second cores in unison with the plurality of second cavity sections as the first melt is compressed.

27. The method of claim 19, wherein the first melt is selected from a group consisting of foam material and lamellar material.

28. The method of claim 19, wherein the second melt is selected from a group consisting of foam material and lamellar material.

29. The method of claim 19, wherein at least one of the first melt and second melt is selected from a group consisting of foam material, lamellar material, and combinations thereof.

30. The method of claim 19, wherein the second melt is molded over the at least a portion of a preform formed of the first material, and the second melt comprises foam.

31. (canceled)

32. (canceled)

33. (canceled)

34. (canceled)

35. (canceled)

36. (canceled)

37. (canceled)

38. (canceled)

39. (canceled)

40. (canceled)

41. A system for molding multilayer articles, the system comprising:
a first molding system comprising a plurality of first cores, a plurality of first cavity sections, and a first source of first material comprising a first output positioned to deliver a first material to at least one of the first cavity sections, the first cores being movable between an open position and a closed position, the first cores are positioned within corresponding first cavity sections when the first cores are in a closed position after the first material is positioned in the corresponding first cavity sections;
a second molding system comprising a plurality of second cores, a plurality of second cavity sections, and a second source of second material comprising a second output positioned to deliver a second material to at least one of the second cavity sections, the second cores being movable between an open position and a closed position; and
a transport system configured to transport preforms from the first molding system to the second molding system.

42. The system of claim 41, wherein the first and second molding systems each comprise a turntable and the transport system is positioned between turntables, the transport system comprises at least one starwheel system.
